(19) United States
(12) Patent Application Publication
(10) Pub. No.: US 2009/0193039 A1
(43) Pub. Date: Jul. 30, 2009

(54) DATA DRIVEN SYSTEM FOR DATA ANALYSIS AND DATA MINING

(75) Inventors: Paul Bradley, Seattle, WA (US); Roman Basko, Issaquah, WA (US); Jeffrey Kaplan, Chicago, IL (US); Timothy Van Allen, Kirkland, WA (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Apollo Data Technologies, LLC, Chicago, IL (US)

(21) Appl. No.: 12/117,177

(22) Filed: May 8, 2008

Related U.S. Application Data
(60) Provisional application No. 61/023,987, filed on Jan. 28, 2008.

(51) Int. Cl. G06F 17/30

(52) U.S. Cl. 707/100; 707/E17.001

(57) ABSTRACT

A process for automating data mining operations by defining data objects including one or more database table objects and storing the data objects in a metadata store maintained in a computer storage. Data manipulation operations on the meta data objects are defined and descriptions of the data manipulation operations associated with the data objects as metadata stored in the metadata store. A data execution component accesses the data manipulation operations and sequentially performs data manipulations operations on data within the database tables corresponding to the database table objects.

### CROSS REFERENCE TO RELATED APPLICATIONS

The present application claims priority from U.S. Provisional application Ser. No. 61/023,987, filed Jan. 28, 2008 which is incorporated herein by reference.

### FIELD OF THE INVENTION

The present invention relates to a storage and execution model for use in mining data.

### BACKGROUND ART

Many common data analysis and data mining tasks involve the execution of a number of data operations for an analyst to reach a successful result. These operations are typically a subset of the following: data import, data aggregation, data preparation for data mining, evaluations of numerous statistical modeling methods to determine those that best represent the underlying correlation structure of the data, and building the resulting models are used to score, rank or prioritize data records. As database systems have become necessary pieces of IT infrastructures for companies and organizations, it becomes necessary to execute data analysis and data mining operations on a regular basis so that the most up-to-date analysis and data mining predictions are available to support optimal business decision-making and/or optimized business processes.

In the prior art, to perform these operations, analysts typically needed to use a myriad of tools for specific purposes (e.g. one tool for data import, a relational database for data aggregation, another set of tools to build statistical data mining models over the data, etc.). Additionally, it was difficult to automate the sequential execution of a number of these operations so that the process, or portions of the process, could be regularly repeated.

### SUMMARY

One benefit of the exemplary system is that it allows a data analyst user to use a single system to create sets of sequential data analysis and data mining operations that can be re-executed numerous times on a regular frequency or whenever needed. The system makes use of various tools for data import, utilizes commercial relational databases for data aggregation and data preparation for data mining modeling, and makes use of commercial and non-commercial statistical data mining algorithms or processes to model the data.

The exemplary system automates operations by interfacing with the components that make up the invention via code-level application interfaces (APIs) or by executing the components via command-line calls. The specific instructions and configurations to execute these components are defined as XML objects and the sequences of data analysis and data mining operations are also defined as XML objects. The invention consist of a storage scheme for these XML objects; an execution engine which processes sequences of data analysis and data mining operations; and a user-interface allowing the analyst to define XML objects to interface with specific components and to define the sequence of operations needed to solve specific data analysis and data mining projects.

The invention consists of three primary components used to automate general data analysis and modeling operations: i) a storage and access scheme for objects describing data sources, data manipulation operations and data mining modeling operations (metadata storage); ii) an execution engine that operates on the descriptions (i.e. operates on the metadata storage mechanism); and iii) a user interface for viewing and editing the descriptions.

The execution engine operates by processing pipelines that solve and automate various data execution operations. These operations include import of source data into relational databases, aggregating source data for analysis or reporting, computation of reports, and building and evaluating data mining models. A user interface allows an end-user of the system to configure specific data preparation and analysis steps for a particular application (e.g. predicting the likelihood that a product will sell, given historical transactional sales data). The execution process automates analysis operations and can be set to run repeatedly (e.g. whenever new source is available or on a scheduled basis).

These and other objects, advantages, and features of the invention will become better understood through review of the drawings in conjunction with a detailed description of an exemplary embodiment.

### BRIEF DESCRIPTION OF THE DRAWINGS

FIG. 1 is a schematic of a computer having a data store;

FIG. 2 is high-level system overview of data mining operations on one or more computers;

FIG. 3 is schematic showing pipelining of metadata;

FIG. 4 is a system metadata storage schema;

FIG. 5 is a metadata datastore installation process flowchart;

FIG. 6 is a flowchart of the process of creating a project;

FIG. 7 is a flowchart for dropping a project;

FIG. 8 is an export project flowchart;

FIG. 9 is an import project flowchart;

FIG. 10 is a flowchart for executing a pipeline;

FIG. 11 is an analyst user interface form architecture;

FIG. 12 is a screen shot depiction of a project manager form;

FIG. 13 is a metadata chooser form;

FIG. 14 is a form for working with existing metadata object;

FIG. 15 is a pipeline editor form;

FIG. 16 is an initial action editor form;

FIG. 17 is select action type form;

FIG. 18 is the action editor form for completing the information for a specific action (BuildPredictModel).

FIG. 19 is a form for choosing metadata object name as parameter

FIG. 20 is a form to choosing project property values as parameters

FIG. 21 is a parameter value editor;

FIG. 22 is an algorithm editor;

FIG. 23 is a Microsoft decision tree info display;

FIGS. 24-34 are screen depictions of an editor for adjusting metadata;

FIG. 35 is evaluation report viewer showing test details;

FIG. 36 is dataset information display;

FIG. 37 is a report viewer with metrics tab selected;

FIG. 38 is an information display for standard deviation overall accuracy;

FIG. 39 is a report viewer with a charts tab selected;

FIG. 40 is a chart viewer display;

FIG. 41 is a generic metadata editor;

FIG. 42 is project properties display;

FIG. 43 is new project property input form;

FIG. 44 is edit existing project property form;

FIG. 45 is execution manager display;

FIG. 46 is view execution details display; and

FIG. 47 is view logfile display.

### EXEMPLARY SYSTEM OF THE INVENTION

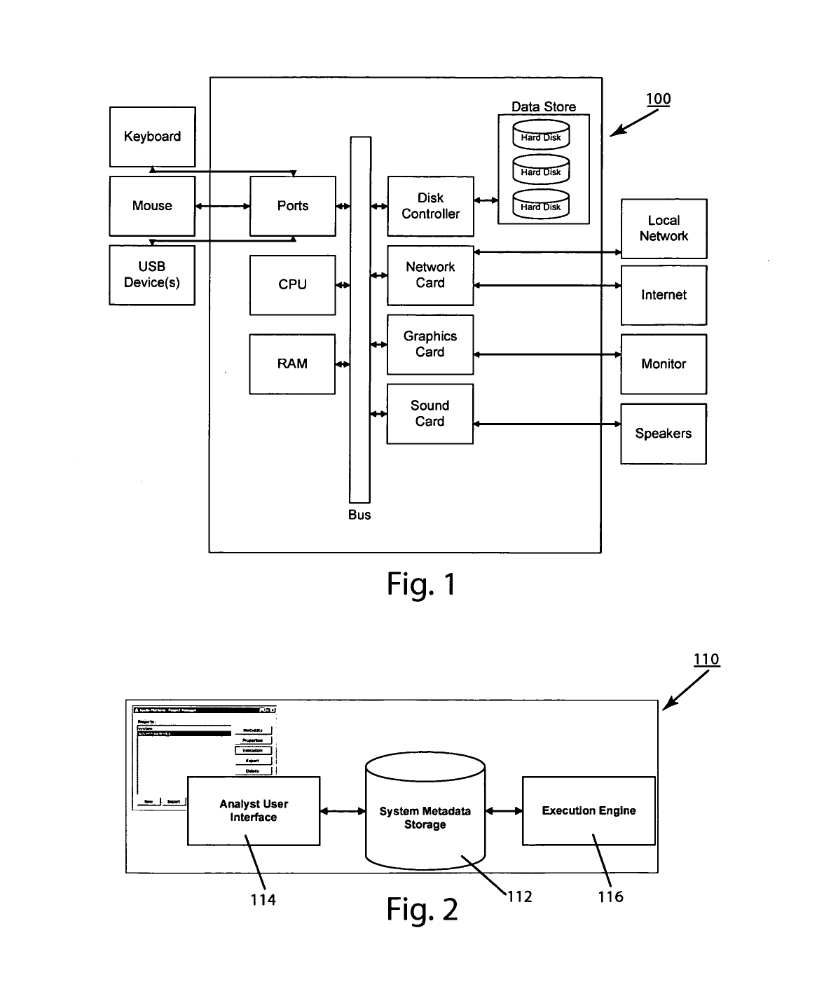

The system implements a metadata-driven system 110 for data analysis and data mining that is executed on a computer system 100(see FIG. 1)

### System Overview

FIG. 2 provides a graphical overview of the system 110 and its primary components 112, 114, 116. A System Metadata Storage component 112 stores information on various data objects. Specific steps needed to perform various analysis operations are stored via XML in the system metadata storage component 112. An analyst User Interface component 114 allows a user to control how an execution engine 116 manipulates data.

The system supports a notion of a ‘Project’. Typically, a project corresponds to a given analysis project, solution or task that needs to be developed and executed. Pragmatically, a project is an umbrella, under which metadata objects are associated. Note that metadata objects cannot have the same name within a given project, but can have the same name if they belong to different projects.

### Project Properties

The Project notion allows an analyst to associate certain properties with a project. Project properties are a convenient way to access common information or parameters used in a specific analysis solution. For example, one project may utilize data from a specific database. So, the name of the database server and the name of the database itself may be defined as a property of the project. Project properties are usually key-value pairs, so in this case, an analyst may define a property with Key=“Server Name” and Value=“My Server”; and then define another property with Key=“Database Name” and Value=“My Database”. Then, metadata objects which describe data or functionality associated with this server and database can make use of keys in their description (i.e. “Server Name” and “Database Name”). Then, if the values of these keys change at some future point in time, as long as the project properties are updated, the metadata objects and processing instructions will utilize the updated values.

### System Metadata Storage

The system 110 stores information about data sources and information on how to perform various data analysis operations and computations as metadata. Metadata objects are used to describe existing data items (e.g. data tables) or to describe operations that are to be applied to existing data items (e.g. pipelines). Metadata definitions for objects are stored as XML in a relational database made up of multiple tables 122-126 that has a schema 120 shown in FIG. 4. Note that the relational database tables used to store the XML representation of the metadata objects are designed so that these XML representations are indexed by project name (column ProjectName in table Defininitions), metadata definition type (column DefinitionType in table Definitions), and metadata definition name (column DefinitionName in table Definitions). Indexing in this way allows for fast retrieval of metadata objects associated with a given project by name and/or by type.

System Metadata Storage is implemented as a relational database in Microsoft SQL Server 2005 with the schema shown in FIG. 4. The columns have the following types:
Table [Projects]
   ProjectName varchar(100)
Table [ProjectProperties]
   ProjectName varchar(100), refers to values in [Projects].[ProjectName]
   Properties xml, XML specifying properties related to the corresponding project.
Table [Definitions]
   ProjectName varchar(100), refers to values in [Projects].[ProjectName]
   DefinitionType varchar(100), the type of the metadata definition
   DefinitionName varchar(100), the name for the metadata definition
   Definition value xml, XML specifying the values for metadata parameters
Table [PipelineInfo]
   ProjectName varchar(100), refers to values in [Projects].[ProjectName]
   PipelineName varchar(100), name of the given pipeline
   ExecutionKey varchar(100), unique key related to pipeline execution
   CreationTime datetime
   Status varchar(50), status of pipeline execution
Table [ExecutionLog]
   ProjectName varchar(100), refers to values in [Projects].[ProjectName]
   ExecutionKey varchar(100), refers to values in [PipelineInfo]. [ExecutionKey]
   ExecutionInfo xml, XML description of the corresponding pipeline execution
   LogFile text, text containing events that are logged during pipeline execution, failure messages, etc.

As the execution engine 116 (described below in more detail) processes pipelines, it interfaces with the following tables:
[Definitions] to obtain information on:
   Pipelines to be run
   Tasks within each pipeline
   Parameters for those tasks (which can be metadata objects)
[ProjectProperties] to replace, at run-time, specific values in metadata objects corresponding to key-value pairs that are specified in the project properties.
[PipelineInfo] to store and updated information related to the execution of a given pipeline.
[ExecutionLog] to log information about the execution of a given pipeline

### Metadata Objects

The execution engine component 116 has access to C# classes which describe the members and functionality associated with the particular metadata object. To instantiate a given metadata object, the execution engine performs the following steps:
Loads the XML description of the object from the metadata storage database, querying column Definition value for the given ProjectName, DefinitionType and DefinitionName of interest from the Definitions table in FIG. 4.
All metadata objects derive from a base class which supports the following functionality:
   Dump to XML: creates an XML Document with the specific values associated with the members of the instantiated C# object.
   Load: creates and instantiates a C# object of the corresponding DefinitionType and DefinitionName with member values that are derived from an XML document.

This generic approach allows the loading and saving of metadata values to the schema listed above in FIG. 4.

A metadata object equates to a C# class that stores the class member values and may also include functionality associated with operations on those values. Metadata objects developed to describe source data information and analytic computation are described in detail below.

Note also that all metadata objects can be saved in the table [Definitions] outlined in FIG. 4.

### Pipeline

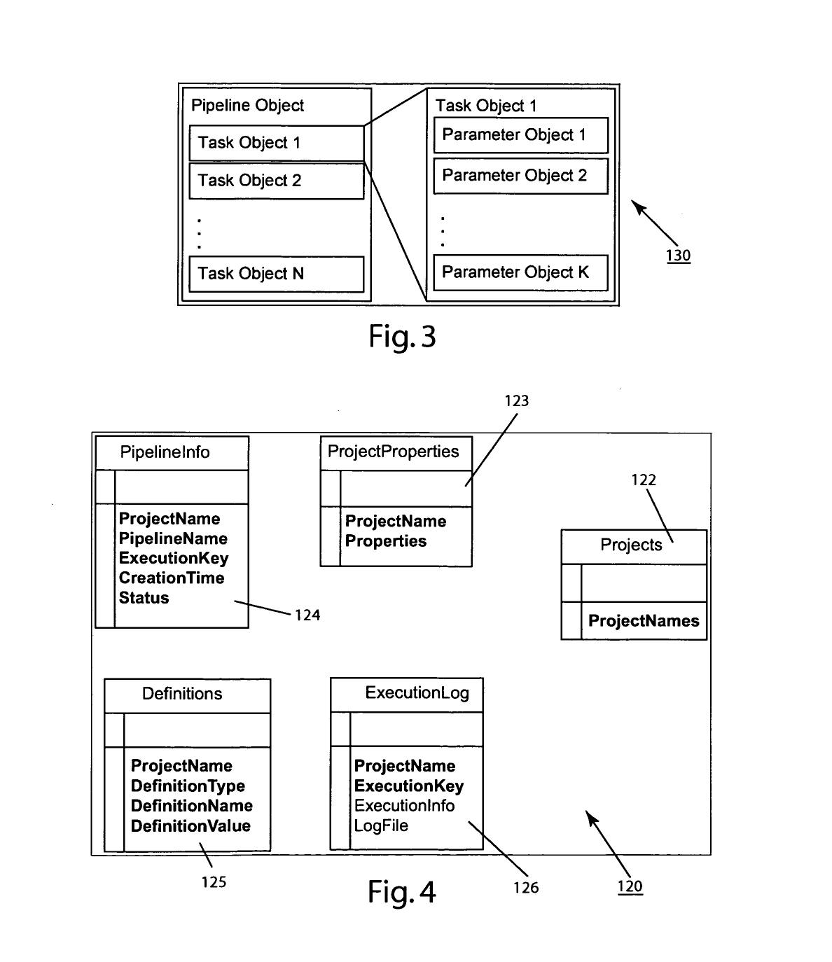

A Pipeline metadata object 130 describes a series of operations to be performed during a given execution run. FIG. 3 describes how a pipeline consists of a number of tasks and each task consists of various parameters.

### Class Representation

The Pipeline class consist of a single member: a list of Action classes.

### XML Representation

An example XML representation of the pipeline object is:

```
<item>
  <Type>Pipeline</Type>
  <Name>vTargetMail Import</Name>
  <Value type=“Pipeline”>
    <Actions>
      <item>
        <Description>Generate vTargetMail Data Format</Description>
        <Type>MakeDataFormatFromTable</Type>
        <Parameters>
          <item>
            <Name>DataFormatName</Name>
            <Value>vTargetMail DataFormat</Value>
          </item>
          <item>
            <Name>SourceServer</Name>
            <Value>V-PAULBR-N2</Value>
          </item>
          <item>
            <Name>SourceDatabase</Name>
            <Value>AdventureWorksDW</Value>
          </item>
          <item>
            <Name>SourceTable</Name>
            <Value>vTargetMail</Value>
          </item>
        </Parameters>
        <Disabled />
      </item>
      <item>
        <Description>vTargetMail Import</Description>
        <Type>ImportDataFromTable</Type>
        <Parameters>
          <item>
            <Name>SourceDataFormat</Name>
            <Value>vTargetMail DataFormat</Value>
          </item>
          <item>
            <Name>SourceServer</Name>
            <Value>V-PAULBR-N2</Value>
          </item>
          <item>
            <Name>SourceDatabase</Name>
            <Value>AdventureWorksDW</Value>
          </item>
          <item>
            <Name>SourceTable</Name>
            <Value>vTargetMail</Value>
          </item>
          <item>
            <Name>TargetServer</Name>
            <Value>{DatastoreServer}</Value>
          </item>
          <item>
            <Name>TargetDatabase</Name>
            <Value>{DatastoreDB}</Value>
          </item>
          <item>
            <Name>TargetTableName</Name>
            <Value>vTargetMail</Value>
          </item>
          <item>
            <Name>TempFolder</Name>
            <Value>{TempFolder}</Value>
          </item>
          <item>
            <Name>ImportMode</Name>
            <Value>Replace</Value>
          </item>
        </Parameters>
      </item>
    </Actions>
  </Value>
</item>
```

### Action

The Action metadata object specifies a single data analysis operation to be performed and also stores and manages the parameters that are required to perform the given operation.

### Class Representation

The Action class consist of the following members:
Description (string)
Type (string)
List of Parameter objects
Disabled flag (Boolean)

The Action class also exposes the following methods:
Ability to add a parameter to the class
Ability to get a parameter with the given name the list of Parameter objects
Ability to determine if the class has a parameter with a given name
Ability to get all of the parameters associated with the class

### XML

Example XML for an action is listed below

```
<item>
  <Description>Generate vTargetMail Data Format</Description>
  <Type>MakeDataFormatFromTable</Type>
  <Parameters>
    <item>
      <Name>DataFormatName</Name>
      <Value>vTargetMail DataFormat</Value>
    </item>
    <item>
      <Name>SourceServer</Name>
      <Value>V-PAULBR-N2</Value>
    </item>
    <item>
      <Name>SourceDatabase</Name>
      <Value>AdventureWorksDW</Value>
    </item>
    <item>
      <Name>SourceTable</Name>
      <Value>vTargetMail</Value>
    </item>
  </Parameters>
  <Disabled />
</item>
```

### Parameter

The Parameter object consists of (name, value) pair.

### Class Description

The Parameter object has the following members:
Name (string)
Value (string)

Additionally, there are methods for determining and managing the type of the value:
Ability to make the value NULL
Ability to tell if the value is a string
Ability to tell if the value is a Boolean
Ability to tell if the value is an integer
Ability to tell if the value is a real (floating-point number)
Ability to tell if the value is a time-value
Ability to convert value to a string, if applicable
Ability to convert value to an integer, if applicable
Ability to convert value to a real, if applicable
Ability to convert value to a Boolean, if applicable
Ability to convert value to time, if applicable

### XML

Example XML for a parameter object

```
<item>
  <Name>SourceServer</Name>
  <Value>V-PAULBR-N2</Value>
</item>
```

### DataTable

The DataTable metadata object describes a data table, typically materialized as a relational database table. The DataTable object stores the name of the table as well as the column names and the column types associated with the table.

### Class Description

The DataTable object consists of the following members:
Name (string)
A list of DataField objects corresponding to the columns of the table
Number of rows (integer)

The DataTable object exposes the following functionality:
Ability to determine of the data table has a field (column) with a given name
Ability to get the DataField object corresponding to a column with a given name

### XML

Example XML for a DataTable object:

```
<item>
  <Type>DataTable</Type>
  <Name>vTargetMail DataMiningTable</Name>
  <Value type=“DataTable”>
    <Name>vTargetMail DataMiningTable</Name>
    <Fields>
      <item>
        <Name>CustomerKey</Name>
        <StorageType type=“IntegerDataType” />
        <LogicalType>Key</LogicalType>
      </item>
      <item>
        <Name>MaritalStatus</Name>
        <StorageType type=“StringDataType”>
          <Unicode />
          <Width>1</Width>
        </StorageType>
        <LogicalType>Categorical</LogicalType>
      </item>
      <item>
        <Name>Gender</Name>
        <StorageType type=“StringDataType”>
          <Unicode />
          <Width>1</Width>
        </StorageType>
        <LogicalType>Categorical</LogicalType>
      </item>
      <item>
        <Name>YearlyIncome</Name>
        <StorageType type=“ArbitrarySQLDataType”>
          <SQLTypeName>money</SQLTypeName>
        </StorageType>
        <LogicalType>RawData</LogicalType>
      </item>
      <item>
        <Name>TotalChildren</Name>
        <StorageType type=“IntegerDataType” />
        <LogicalType>Numeric</LogicalType>
      </item>
      <item>
        <Name>NumberChildrenAtHome</Name>
        <StorageType type=“IntegerDataType” />
        <LogicalType>Numeric</LogicalType>
      </item>
      <item>
        <Name>EnglishEducation</Name>
        <StorageType type=“StringDataType”>
          <Unicode />
          <Width>40</Width>
        </StorageType>
        <LogicalType>Categorical</LogicalType>
      </item>
      <item>
        <Name>EnglishOccupation</Name>
        <StorageType type=“StringDataType”>
          <Unicode />
          <Width>100</Width>
        </StorageType>
        <LogicalType>Categorical</LogicalType>
      </item>
      <item>
        <Name>HouseOwnerFlag</Name>
        <StorageType type=“StringDataType”>
          <Unicode />
          <Width>1</Width>
        </StorageType>
        <LogicalType>Categorical</LogicalType>
      </item>
      <item>
        <Name>NumberCarsOwned</Name>
        <StorageType type=“IntegerDataType” />
        <LogicalType>Numeric</LogicalType>
      </item>
      <item>
        <Name>CommuteDistance</Name>
        <StorageType type=“StringDataType”>
          <Unicode />
          <Width>15</Width>
        </StorageType>
        <LogicalType>Categorical</LogicalType>
      </item>
      <item>
        <Name>Region</Name>
        <StorageType type=“StringDataType”>
          <Unicode />
          <Width>50</Width>
        </StorageType>
        <LogicalType>Categorical</LogicalType>
      </item>
      <item>
        <Name>Age</Name>
        <StorageType type=“IntegerDataType” />
        <LogicalType>Numeric</LogicalType>
      </item>
      <item>
        <Name>BikeBuyer</Name>
        <StorageType type=“IntegerDataType” />
        <LogicalType>Boolean</LogicalType>
      </item>
    </Fields>
    <NumRows>0</NumRows>
  </Value>
</item>
```

### DataField

The DataField object describes information about a column (field) typically associated with a DataTable object.

### Class Description

The DataField object has the following members:
Name (string)
StorageType (DataType)
LogicalType (LogicalType)

The DataField object also exposes the following functionality
Ability to get ‘extended information’ about the object. This is a text string that contains the values for LogicalType and StorageType.
Ability to create a copy of the DataField object with the same values for Name, StorageType and LogicalType.

### XML

Example XML for the DataField object:

```
<item>
  <Name>NumberChildrenAtHome</Name>
  <StorageType type=“IntegerDataType” />
  <LogicalType>Numeric</LogicalType>
</item>
```

### CaseDataTable

The CaseDataTable object is represents how a given table's columns relate to produce the concept of a case (entity of analysis) for modeling. E.g. if each row of the corresponding data table represents attributes of a case, it is typically specified as the ParentTable. If the underlying table has multiple columns that related to a given case (i.e. it is “dimensional” or a “nested table”), then the CaseDataTable object specifies how it joins to the ParentTable (case-table).

### Class Description

The CaseDataTable object has the following members:
Name (string)
DataTableName (string)
Key (string)
[Optional] ParentTableName (string): Name of the parent table, or table that defines the key indicating the item of analysis (the case-key).
[Optional] ParentJoinKey (string): Name of the column on which the data table joins to the parent table.
Dimensional (Boolean): Indicator whether or not the values in the table a ‘dimensional’- e.g. sparse format or having multiple rows per case.
[Optional] DimensionKey (string): If the table is dimensional, the name of the dimension key—the column that, when taken in consideration with the Key column specifies a unique row in the table.

### XML

Example XML for the CaseDataTable

```
<item>
  <Name>vTargetMail CaseDataTable</Name>
  <DataTableName>vTargetMail</DataTableName>
  <Key>CustomerKey</Key>
  <Dimensional/>
</item>
```

### CaseDataSet

The CaseDataSet object defines the logical relationship between source or derived data fields to bring together all data items related to a case for analysis and modeling. Note that a CaseDataSet has a ‘root’ table which is the root node in the general tree-like logical relationship that can be defined in a general star schema. Note that the key in the root table is referred to as the ‘case key’ for the CaseDataSet.

### Class Description

The CaseDataSet object consists of a single member:
List of CaseDataTable objects: Note that if there are multiple CaseDataTable objects, these specify the relationship among them.

The CaseDataSet object supports the following methods:
Ability to determine if the CaseDataSet has a table with a specific name
Ability to return the CaseDataTable object with the specific name
Ability to return the root CaseDataTable object
Ability to return the ‘case key’ for the CaseDataSet.

### XML

Example XML for a CaseDataSet is:

```
<Type>CaseDataSet</Type>
<Name>vTargetMail CaseDataSet</Name>
<Value type=“CaseDataSet”>
  <DataTables>
    <item>
      <Name>vTargetMail CaseDataTable</Name>
      <DataTableName>vTargetMail</DataTableName>
      <Key>CustomerKey</Key>
      <Dimensional/>
    </item>
  </DataTables>
</Value>
```

### CaseProperty

The CaseProperty object simply stores the column-name associated with a given table.

### Class Description

The CaseProperty object contains the following 3 members:
Name (string)
TableName (string): specifying the table of interest
FieldName (string): specifying the column of interest

### XML Example

Example XML for a CaseProperty object:

```
<Property>
  <Name>vTargetMail CaseDataTable_HouseOwnerFlag</Name>
  <TableName>vTargetMail CaseDataTable</TableName>
  <FieldName>HouseOwnerFlag</FieldName>
</Property>
```

### CaseConstraint

The CaseConstraint object specifies a logical rule (constraint) to be applied to a case set to limit the cases that are used for given analysis operations, such as aggregation, etc.

### Class Description

The CaseConstraint object consists of the following members:
Property (CaseProperty)
OperatorType: one of {Equal, LessThan, MoreThan, LessThanOrEqual, MoreThanOrEqual, NotEqual, IsNull, IsNotNull, Between}
A list of Parameters
[Optional] DisplayText (string)

### XML Description

Example XML for a CaseConstraint object:

```
    <item>
        <Property>
          <Name>vTargetMail
          CaseDataTable_HouseOwnerFlag</Name>
          <TableName>vTargetMail CaseDataTable</TableName>
          <FieldName>HouseOwnerFlag</FieldName>
        </Property>
        <OperatorType>Equal</OperatorType>
        <Operands>
          <item>
            <Name>Operand 1</Name>
            <Value>True</Value>
          </item>
        </Operands>
        <DisplayText>vTargetMail CaseDataTable_HouseOwnerFlag =
True</DisplayText>
      </item>
```

### CaseRule

The CaseRule object represents a logical rule, which is defined as the conjunction (“and”) of a number of constraints. The CaseRule object is used to specify logic on the cases that are returned or used for an aggregation or a result-set.

### Class Description

The CaseRule object consists of the following members:
A list of CaseConstraint objects
Result (string)
[Optional] DisplayText (string)

### XML Example

Example XML for a CaseRule object:

```
    <item>
      <Constraints>
        <item>
          <Property>
            <Name>vTargetMail
CaseDataTable_HouseOwnerFlag</Name>
            <TableName>vTargetMail CaseDataTable</TableName>
            <FieldName>HouseOwnerFlag</FieldName>
          </Property>
          <OperatorType>Equal</OperatorType>
          <Operands>
            <item>
              <Name>Operand 1</Name>
              <Value>True</Value>
            </item>
          </Operands>
          <DisplayText>vTargetMail
CaseDataTable_HouseOwnerFlag = True</DisplayText>
        </item>
      </Constraints>
      <Result>Include</Result>
      <DisplayText>if vTargetMail CaseDataTable_HouseOwnerFlag =
True</DisplayText>
    </item>
```

### CaseDataQuery

The CaseDataQuery object specifies a list of data columns that are to be returned from a query after a set of filters (rules) are applied.

### Class Description

The CaseDataQuery object consists of the following members:
Name (string)
List of CaseProperty objects, specifying the list of columns to be returned
[Optional] List of CaseRule objects, specifying logic on the cases to be returned

### XML Example

Example XML for a CaseDataQuery object:

```
  <item>
    <Name>Query1</Name>
    <Properties>
    <item>
      <Name>vTargetMail CaseDataTable_CustomerKey</Name>
      <TableName>vTargetMail CaseDataTable</TableName>
      <FieldName>CustomerKey</FieldName>
    </item>
    <item>
      <Name>vTargetMail CaseDataTable_Gender</Name>
      <TableName>vTargetMail CaseDataTable</TableName>
      <FieldName>Gender</FieldName>
    </item>
    <item>
      <Name>vTargetMail CaseDataTable_TotalChildren</Name>
      <TableName>vTargetMail CaseDataTable</TableName>
      <FieldName>TotalChildren</FieldName>
    </item>
    <item>
      <Name>vTargetMail CaseDataTable_BikeBuyer</Name>
      <TableName>vTargetMail CaseDataTable</TableName>
      <FieldName>BikeBuyer</FieldName>
    </item>
    </Properties>
    <Filter>
    <item>
      <Constraints>
      <item>
        <Property>
        <Name>vTargetMail
CaseDataTable_HouseOwnerFlag</Name>
        <TableName>vTargetMail CaseDataTable</TableName>
        <FieldName>HouseOwnerFlag</FieldName>
        </Property>
        <OperatorType>Equal</OperatorType>
        <Operands>
        <item>
          <Name>Operand 1</Name>
          <Value>True</Value>
        </item>
        </Operands>
        <DisplayText>vTargetMail CaseDataTable_HouseOwnerFlag =
True</DisplayText>
      </item>
      </Constraints>
      <Result>Include</Result>
      <DisplayText>if vTargetMail CaseDataTable_HouseOwnerFlag =
True</DisplayText>
    </item>
    </Filter>
  </item>
```

### CaseAggregation

The CaseAggregation object defines an aggregate query over a CaseDataSet. The CaseAggregation requires the specification of the following items:
Properties: Columns which are used in the CaseAggregation
Filter: Constraints that specify logic on which to filter which are used in the aggregation.
Conditions: Values by which to group in the aggregation
Measures: The aggregations to be performed

### Class Description

The CaseAggregation object contains the following members:
CaseDataSetName (string)
List of CaseDataQuery objects
List of Condition objects
List of Measure objects
MeasureType: one of {CountDistinct, Maximum, Minimum, Sum, SumSquares, Average, StandardDeviation}
Measure: Another metadata class having members:
   Name (string)
   Type (MeasureType)
   [Optional] QueryName (string)
   [Optional] PropertyName (string)
Condition: Another metadata class having members
   Name (string)
   QueryName (string)
   PropertyName (string)

### XML Example

Example of a CaseAggregation XML object:

```
  <Value type=“CaseAggregation”>
    <CaseDataSetName>vTargetMail CaseDataSet</CaseDataSetName>
    <Queries>
    <item>
      <Name>Query1</Name>
      <Properties>
      <item>
        <Name>vTargetMail CaseDataTable_CustomerKey</Name>
        <TableName>vTargetMail CaseDataTable</TableName>
        <FieldName>CustomerKey</FieldName>
      </item>
      <item>
        <Name>vTargetMail CaseDataTable_Gender</Name>
        <TableName>vTargetMail CaseDataTable</TableName>
        <FieldName>Gender</FieldName>
      </item>
      <item>
        <Name>vTargetMail CaseDataTable_TotalChildren</Name>
        <TableName>vTargetMail CaseDataTable</TableName>
        <FieldName>TotalChildren</FieldName>
      </item>
      <item>
        <Name>vTargetMail CaseDataTable_BikeBuyer</Name>
        <TableName>vTargetMail CaseDataTable</TableName>
        <FieldName>BikeBuyer</FieldName>
      </item>
      </Properties>
      <Filter>
      <item>
        <Constraints>
        <item>
          <Property>
          <Name>vTargetMail
CaseDataTable_HouseOwnerFlag</Name>
          <TableName>vTargetMail CaseDataTable</TableName>
          <FieldName>HouseOwnerFlag</FieldName>
          </Property>
          <OperatorType>Equal</OperatorType>
          <Operands>
          <item>
            <Name>Operand 1</Name>
            <Value>True</Value>
          </item>
          </Operands>
          <DisplayText>vTargetMail
CaseDataTable_HouseOwnerFlag = True</DisplayText>
        </item>
        </Constraints>
        <Result>Include</Result>
        <DisplayText>if vTargetMail
CaseDataTable_HouseOwnerFlag = True</DisplayText>
      </item>
      </Filter>
    </item>
    </Queries>
    <Conditions>
    <item>
      <Name>Condition1</Name>
      <QueryName>Query1</QueryName>
      <PropertyName>vTargetMail
CaseDataTable_BikeBuyer</PropertyName>
    </item>
    </Conditions>
    <Measures>
    <item>
      <Name>Measure1</Name>
      <Type>Sum</Type>
      <QueryName>Query1</QueryName>
      <PropertyName>vTargetMail
CaseDataTable_TotalChildren</PropertyName>
    </item>
    <item>
      <Name>Measure2</Name>
      <Type>Average</Type>
      <QueryName>Query1</QueryName>
      <PropertyName>vTargetMail
CaseDataTable_BikeBuyer</PropertyName>
    </item>
    </Measures>
  </Value>
```

### DataFieldTransform

The DataFieldTransform object simply contains the information that describes a transformation to a given source data field.

### Class Description

The DataFieldTransform object consists of the following members:
FieldName (string)
SQLExpression (string): SQL specifying the transformation to be performed

### XML Example

Example XML of a DataFieldTransform object:

```
<item>
    <FieldName>LogOfTotalChilden</FieldName>
    <SQLExpression>log(TotalChildren)</SQLExpression>
</item>
```

### DerivedDataField

Similar to the DataFieldTransform, the DerivedDataField specifies a derived field for a data set.

### Class Description

The DerivedDataField object consist of the following members:
Name (string)
StorageType (DataType)
LogicalType (LogicalType)
SQLExpression (string): SQL specifying the computation of the derived field

### XML Example

Example XML for a DerivedDataField object:

```
        <item>
            <SQLExpression>100*(cast(NumberChildrenAtHome as
float))/(cast(TotalChildren as float))</SQLExpression>
            <Name>PercentChildrenAtHome</Name>
            <StorageType type=“RealDataType” />
            <LogicalType>Numeric</LogicalType>
        </item>
```

### DataFormat

The DataFormat object describes the columns, transforms and derived fields that exist or may be computed from source data tables.

### Class Description

The DataFormat class consists of the following members:
A list of DataField objects: descriptions of the source columns in a data table.
[Optional] A list of DataFieldTransform objects: descriptions of transformations of source fields
[Optional] A list of DerivedDataField objects: describing fields derived from source fields.

### XML Example

Example XML for a DataFormat object

```
    <Value type=“DataFormat”>
      <Fields>
        <item>
          <Name>CustomerKey</Name>
          <StorageType type=“IntegerDataType” />
          <LogicalType>Key</LogicalType>
        </item>
        <item>
          <Name>GeographyKey</Name>
          <StorageType type=“IntegerDataType” />
          <LogicalType>Key</LogicalType>
        </item>
        <item>
          <Name>CustomerAlternateKey</Name>
          <StorageType type=“StringDataType”>
            <Unicode />
            <Width>15</Width>
          </StorageType>
          <LogicalType>Key</LogicalType>
        </item>
        <item>
          <Name>Title</Name>
          <StorageType type=“StringDataType”>
            <Unicode />
            <Width>8</Width>
          </StorageType>
          <LogicalType>Categorical</LogicalType>
        </item>
        <item>
          <Name>FirstName</Name>
          <StorageType type=“StringDataType”>
            <Unicode />
            <Width>50</Width>
          </StorageType>
          <LogicalType>Categorical</LogicalType>
        </item>
        <item>
          <Name>MiddleName</Name>
          <StorageType type=“StringDataType”>
            <Unicode />
            <Width>50</Width>
          </StorageType>
          <LogicalType>Categorical</LogicalType>
        </item>
        <item>
          <Name>LastName</Name>
          <StorageType type=“StringDataType”>
            <Unicode />
            <Width>50</Width>
          </StorageType>
          <LogicalType>Categorical</LogicalType>
        </item>
        <item>
          <Name>NameStyle</Name>
          <StorageType type=“BitDataType” />
          <LogicalType>Boolean</LogicalType>
        </item>
        <item>
          <Name>BirthDate</Name>
          <StorageType type=“TimeDataType” />
          <LogicalType>Temporal</LogicalType>
        </item>
        <item>
          <Name>MaritalStatus</Name>
          <StorageType type=“StringDataType”>
            <Unicode />
            <Width>1</Width>
          </StorageType>
          <LogicalType>Categorical</LogicalType>
        </item>
        <item>
          <Name>Suffix</Name>
          <StorageType type=“StringDataType”>
            <Unicode />
            <Width>10</Width>
          </StorageType>
          <LogicalType>Categorical</LogicalType>
        </item>
        <item>
          <Name>Gender</Name>
          <StorageType type=“StringDataType”>
            <Unicode />
            <Width>1</Width>
          </StorageType>
          <LogicalType>Categorical</LogicalType>
        </item>
        <item>
          <Name>EmailAddress</Name>
          <StorageType type=“StringDataType”>
            <Unicode />
            <Width>50</Width>
          </StorageType>
          <LogicalType>Categorical</LogicalType>
        </item>
        <item>
          <Name>YearlyIncome</Name>
          <StorageType type=“ArbitrarySQLDataType”>
            <SQLTypeName>money</SQLTypeName>
          </StorageType>
          <LogicalType>RawData</LogicalType>
        </item>
        <item>
          <Name>TotalChildren</Name>
          <StorageType type=“IntegerDataType” />
          <LogicalType>Numeric</LogicalType>
        </item>
        <item>
          <Name>NumberChildrenAtHome</Name>
          <StorageType type=“IntegerDataType” />
          <LogicalType>Numeric</LogicalType>
        </item>
        <item>
          <Name>EnglishEducation</Name>
          <StorageType type=“StringDataType”>
            <Unicode />
            <Width>40</Width>
          </StorageType>
          <LogicalType>Categorical</LogicalType>
        </item>
        <item>
          <Name>SpanishEducation</Name>
          <StorageType type=“StringDataType”>
            <Unicode />
            <Width>40</Width>
          </StorageType>
          <LogicalType>Categorical</LogicalType>
        </item>
        <item>
          <Name>FrenchEducation</Name>
          <StorageType type=“StringDataType”>
            <Unicode />
            <Width>40</Width>
          </StorageType>
          <LogicalType>Categorical</LogicalType>
        </item>
        <item>
          <Name>EnglishOccupation</Name>
          <StorageType type=“StringDataType”>
            <Unicode />
            <Width>100</Width>
          </StorageType>
          <LogicalType>Categorical</LogicalType>
        </item>
        <item>
          <Name>SpanishOccupation</Name>
          <StorageType type=“StringDataType”>
            <Unicode />
            <Width>100</Width>
          </StorageType>
          <LogicalType>Categorical</LogicalType>
        </item>
        <item>
          <Name>FrenchOccupation</Name>
          <StorageType type=“StringDataType”>
            <Unicode />
            <Width>100</Width>
          </StorageType>
          <LogicalType>Categorical</LogicalType>
        </item>
        <item>
          <Name>HouseOwnerFlag</Name>
          <StorageType type=“StringDataType”>
            <Unicode />
            <Width>1</Width>
          </StorageType>
          <LogicalType>Categorical</LogicalType>
        </item>
        <item>
          <Name>NumberCarsOwned</Name>
          <StorageType type=“IntegerDataType” />
          <LogicalType>Numeric</LogicalType>
        </item>
        <item>
          <Name>AddressLine1</Name>
          <StorageType type=“StringDataType”>
            <Unicode />
            <Width>120</Width>
          </StorageType>
          <LogicalType>Categorical</LogicalType>
        </item>
        <item>
          <Name>AddressLine2</Name>
          <StorageType type=“StringDataType”>
            <Unicode />
            <Width>120</Width>
          </StorageType>
          <LogicalType>Categorical</LogicalType>
        </item>
        <item>
          <Name>Phone</Name>
          <StorageType type=“StringDataType”>
            <Unicode />
            <Width>20</Width>
          </StorageType>
          <LogicalType>Categorical</LogicalType>
        </item>
        <item>
          <Name>DateFirstPurchase</Name>
          <StorageType type=“TimeDataType” />
          <LogicalType>Temporal</LogicalType>
        </item>
        <item>
          <Name>CommuteDistance</Name>
          <StorageType type=“StringDataType”>
            <Unicode />
            <Width>15</Width>
          </StorageType>
          <LogicalType>Categorical</LogicalType>
        </item>
        <item>
          <Name>Region</Name>
          <StorageType type=“StringDataType”>
            <Unicode />
            <Width>50</Width>
          </StorageType>
          <LogicalType>Categorical</LogicalType>
        </item>
        <item>
          <Name>Age</Name>
          <StorageType type=“IntegerDataType” />
          <LogicalType>Numeric</LogicalType>
        </item>
        <item>
          <Name>BikeBuyer</Name>
          <StorageType type=“IntegerDataType” />
          <LogicalType>Numeric</LogicalType>
        </item>
      </Fields>
      <Transforms>
        <item>
          <FieldName>LogOfTotalChilden</FieldName>
          <SQLExpression>log(TotalChildren)</SQLExpression>
        </item>
      </Transforms>
      <DerivedFields>
        <item>
          <SQLExpression>100*(cast(NumberChildrenAtHome as
float))/(cast(TotalChildren as float))</SQLExpression>
          <Name>PercentChildrenAtHome</Name>
          <StorageType type=“RealDataType” />
          <LogicalType>Numeric</LogicalType>
        </item>
      </DerivedFields>
    </Value>
```

### CaseAttribute

The CaseAttribute metadata object is used to characterize an attribute of a case which may be dimensional or not.

### Class Description

The CaseAttribute object consists of the following members:
Name (string)
[Optional] TargetProperty (CaseProperty)
[Optional] DimensionProperty (CaseProperty)

The CaseAttribute object exposes the following methods:
Ability to determine if the attribute is dimensional
Ability to determine if the attribute models ‘existence only’

### XML Example

Example XML for a CaseAttribute object is:

```
<item>
    <Name>vTargetMail CaseDataTable.Age</Name>
    <TargetProperty>
        <Name>vTargetMail CaseDataTable_Age</Name>
        <TableName>vTargetMail CaseDataTable</TableName>
        <FieldName>Age</FieldName>
    </TargetProperty>
</item>
```

### DistributionReportSpec

The DistributionReportSpec object is used to specify the information needed to generate a distribution report which characterizes a population of cases.

### Class Description

The DistributionReportSpec object consists of the following members:
Title (string)
CaseDataSetName (string): Name of the CaseDataSet object over which the report is generated
A list of CaseProperty objects: Specifies conditions for the report
A list of CaseAttribute objects: Specifies the values to plot in the report.

### XML Example

Example XML for a DistributionReportSpec object is:

```
<Value type=“DistributionReportSpec”>
    <Title>DistributionReportSpec1</Title>
    <CaseDataSetName>vTargetMail CaseDataSet</CaseDataSetName>
    <Coditions>
        <item>
            <Name>Gender</Name>
            <TableName>vTargetMail CaseDataTable</TableName>
            <FieldName>Gender</FieldName>
        </item>
    </Conditions>
    <Attributes>
        <item>
            <Name>vTargetMail CaseDataTable.Age</Name>
            <TargetProperty>
                <Name>vTargetMail CaseDataTable_Age</Name>
                <TableName>vTargetMail
                CaseDataTable</TableName>
                <FieldName>Age</FieldName>
            </TargetProperty>
        </item>
    </Attributes>
</Value>
```

### ChartDataTable

The ChartDataTable object describes a dataset that has been generated and aggregated for the purposes of charting the results.

### Class Description

The ChartDataTable object has the following members:
Title (string)
[Optional] CreatedAt (datetime): time at which the chart dataset was created
[Optional] LastUpdatedAt (datetime): time at which the chart dataset was last updated
TableName (string): Name of the relational table where the chart data is to be stored.
[Optional] Query (string): SQL query used to populate the table
DimensionFields (list of DataField objects): data fields which are to be charted as dimensions
MeasureFields (list of DataField objects): data fields which are to be charted as measures.

### XML Example

An example of the ChartDataTable XML is:

```
    <item>
      <Title>Population Groups</Title>
      <CreatedAt>1/22/2008 11:52:45 AM</CreatedAt>
      <LastUpdatedAt>1/22/2008 11:52:45 AM</LastUpdatedAt>
      <TableName>Report_TestDistributionReport_Base</TableName>
      <Query>select [BikeBuyer], count(distinct [CaseKey]) as
NumberOfCases, 100.0 * cast(count(distinct [CaseKey]) as
float)/cast(18484 as float) as PercentOfCases from
[Report_TestDistributionReport_Cases] group by [BikeBuyer]</Query>
      <DimensionFields>
        <item>
          <Name>BikeBuyer</Name>
          <StorageType type=“IntegerDataType” />
          <LogicalType>Boolean</LogicalType>
        </item>
      </DimensionFields>
      <MeasureFields>
        <item>
          <Name>NumberOfCases</Name>
          <StorageType type=“IntegerDataType” />
          <LogicalType>Numeric</LogicalType>
        </item>
        <item>
          <Name>PercentOfCases</Name>
          <StorageType type=“RealDataType” />
          <LogicalType>Numeric</LogicalType>
        </item>
      </MeasureFields>
    </item>
```

### DistributionReport

The DistributionReport object provides a container for a number of charts, along with a title for similar charts generated over the same dataset (CaseDataset).

### Class Description

The DistributionReport object consists of the following members:
Title (string)
ConnectionString (string): OLE DB connection string to the data source
Charts (list of ChartTable objects): the data that is to be charted.

The DistributionReport object also exposes the following methods:
Ability to get determine if there is a chart with a given name
Ability to get the ChartTable object associated with a chart with the given name

### XML Example

Example XML for the DistributionReport object is:

```
<Value type=“DistributionReport”>
  <Title>DistributionReportSpec1</Title>
  <ConnectionString>Provider = SQLOLEDB;Data Source =
V-PAULBR-N2;Initial Catalog =
AdventureWorksDW_DataStore;Integrated Security =
SSPI;</ConnectionString>
  <Charts>
    <item>
      <Title>Population Groups</Title>
      <CreatedAt>1/22/2008 11:52:45 AM</CreatedAt>
      <LastUpdatedAt>1/22/2008 11:52:45 AM</LastUpdatedAt>
      <TableName>Report_TestDistributionReport_Base</TableName>
      <Query>select [BikeBuyer], count(distinct [CaseKey]) as
NumberOfCases, 100.0 * cast(count(distinct [CaseKey]) as
float)/cast(18484 as float) as PercentOfCases from
[Report_TestDistributionReport_Cases] group by [BikeBuyer]</Query>
      <DimensionFields>
        <item>
          <Name>BikeBuyer</Name>
          <StorageType type=“IntegerDataType” />
          <LogicalType>Boolean</LogicalType>
        </item>
      </DimensionFields>
      <MeasureFields>
        <item>
          <Name>NameOfCases</Name>
          <StorageType type=“IntegerDataType” />
          <LogicalType>Numeric</LogicalType>
        </item>
        <item>
          <Name>PercentOfCases</Name>
          <StorageType type=“RealDataType” />
          <LogicalType>Numeric</LogicalType>
        </item>
      </MeasureFields>
    </item>
  </Charts>
</value>
```

### DataMiningTable

The DataMiningTable object describes a case table object that stores source data for data mining.

### Class Description

The DataMiningTable object consists of the following members:
Name (string)
List of DataMiningProperties: Additional attribute/column-level propertiers that are needed to automate the data mining process.
   The DataMiningProperty appends the following items to the CaseProperty object (it derives from the CaseProperty object):
      isPredictable (Boolean)
      isCaseKey (Boolean)
      isNestedKey (Boolean): indicating that the column is a nested table key.
      Discretize (Boolean): indicating that the column's values are numeric and can be candidates for discretization.
      [Optional] List of CaseRule objects that specify a logical rule indicating which cases will be used for modeling.

### XML Example

Example XML for a DataMiningTable object:

```
<item>
    <Name>vTargetMail DataMiningTable</Name>
    <Properties>
        <item>
            <isCaseKey />
            <Name>CustomerKey</Name>
            <TableName>vTargetMail CaseDataTable</TableName>
            <FieldName>CustomerKey</FieldName>
        </item>
        <item>
            <Name>MaritalStatus</Name>
            <TableName>vTargetMail CaseDataTable</TableName>
            <FieldName>MaritalStatus</FieldName>
        </item>
        <item>
            <Name>Gender</Name>
            <TableName>vTargetMail CaseDataTable</TableName>
            <FieldName>Gender</FieldName>
        </item>
        <item>
            <Name>YearlyIncome</Name>
            <TableName>vTargetMail CaseDataTable</TableName>
            <FieldName>YearlyIncome</FieldName>
        </item>
        <item>
            <Name>TotalChildren</Name>
            <TableName>vTargetMail CaseDataTable</TableName>
            <FieldName>TotalChildren</FieldName>
        </item>
        <item>
            <Name>NumberChildrenAtHome</Name>
            <TableName>vTargetMail CaseDataTable</TableName>
            <FieldName>NumberChildrenAtHome</FieldName>
        </item>
        <item>
            <Name>EnglishEducation</Name>
            <TableName>vTargetMail CaseDataTable</TableName>
            <FieldName>EnglishEducation</FieldName>
        </item>
        <item>
            <Name>EnglishOccupation</Name>
            <TableName>vTargetMail CaseDataTable</TableName>
            <FieldName>EnglishOccupation</FieldName>
        </item>
        <item>
            <Name>HouseOwnerFlag</Name>
            <TableName>vTargetMail CaseDataTable</TableName>
            <FieldName>HouseOwnerFlag</FieldName>
        </item>
        <item>
            <Name>NumberCarsOwned</Name>
            <TableName>vTargetMail CaseDataTable</TableName>
            <FieldName>NumberCarsOwned</FieldName>
        </item>
        <item>
            <Name>CommuteDistance</Name>
            <TableName>vTargetMail CaseDataTable</TableName>
            <FieldName>CommuteDistance</FieldName>
        </item>
        <item>
            <Name>Region</Name>
            <TableName>vTargetMail CaseDataTable</TableName>
            <FieldName>Region</FieldName>
        </item>
        <item>
            <Name>Age</Name>
            <TableName>vTargetMail CaseDataTable</TableName>
            <FieldName>Age</FieldName>
        </item>
        <item>
            <isPredictable />
            <Name>BikeBuyer</Name>
            <TableName>vTargetMail CaseDataTable</TableName>
            <FieldName>BikeBuyer</FieldName>
        </item>
    </Properties>
</item>
```

### DataMiningView

The DataMiningView object specifies the logical set of case attributes to use when applying data mining predictive or clustering processes to a case data set.

### Class Description:

The DataMiningView object has the following members:
CaseDataSetName (string): Name of the underlying CaseDataSet object that specifies the superset of attributes to use for modeling.
A list of DataMiningTable objects.

### XML Example

Example of a DataMiningView object XML:

```
<Value type=“DataMiningView”>
  <CaseDataSetName>vTargetMail CaseDataSet</CaseDataSetName>
  <DataTables>
    <item>
      <Name>vTargetMail DataMiningTable</Name>
      <Properties>
        <item>
          <isCaseKey />
          <Name>CustomerKey</Name>
          <TableName>vTargetMail CaseDataTable</TableName>
          <FieldName>CustomerKey</FieldName>
        </item>
        <item>
          <Name>MaritalStatus</Name>
          <TableName>vTargetMail CaseDataTable</TableName>
          <FieldName>MaritalStatus</FieldName>
        </item>
        <item>
          <Name>Gender</Name>
          <TableName>vTargetMail CaseDataTable</TableName>
          <FieldName>Gender</FieldName>
        </item>
        <item>
          <Name>YearlyIncome</Name>
          <TableName>vTargetMail CaseDataTable</TableName>
          <FieldName>YearlyIncome</FieldName>
        </item>
        <item>
          <Name>TotalChildren</Name>
          <TableName>vTargetMail CaseDataTable</TableName>
          <FieldName>TotalChildren</FieldName>
        </item>
        <item>
          <Name>NumberChildrenAtHome</Name>
          <TableName>vTargetMail CaseDataTable</TableName>
          <FieldName>NumberChildrenAtHome</FieldName>
        </item>
        <item>
          <Name>EnglishEducation</Name>
          <TableName>vTargetMail CaseDataTable</TableName>
          <FieldName>EnglishEducation</FieldName>
        </item>
        <item>
          <Name>EnglishOccupation</Name>
          <TableName>vTargetMail CaseDataTable</TableName>
          <FieldName>EnglishOccupation</FieldName>
        </item>
        <item>
          <Name>HouseOwnerFlag</Name>
          <TableName>vTargetMail CaseDataTable</TableName>
          <FieldName>HouseOwnerFlag</FieldName>
        </item>
        <item>
          <Name>NumberCarsOwned</Name>
          <TableName>vTargetMail CaseDataTable</TableName>
          <FieldName>NumberCarsOwned</FieldName>
        </item>
        <item>
          <Name>CommuteDistance</Name>
          <TableName>vTargetMail CaseDataTable</TableName>
          <FieldName>CommuteDistance</FieldName>
        </item>
        <item>
          <Name>Region</Name>
          <TableName>vTargetMail CaseDataTable</TableName>
          <FieldName>Region</FieldName>
        </item>
        <item>
          <Name>Age</Name>
          <TableName>vTargetMail CaseDataTable</TableName>
          <FieldName>Age</FieldName>
        </item>
        <item>
          <isPredictable />
          <Name>BikeBuyer</Name>
          <TableName>vTargetMail CaseDataTable</TableName>
          <FieldName>BikeBuyer</FieldName>
        </item>
      </Properties>
    </item>
  </DataTables>
</Value>
```

### DMColumn

The DMColumn class derives from DataField and appends the following information onto a DataField:
DMIsAutoDiscretizeCandidate (Boolean): Specifies that the columns is numeric and may be a candidate for discretization.
DMIsPredictable (Boolean): Specifies that a data mining predictive model should be constructed to predict the values of the given column.
DMModelColumnUsages: one of {INPUT, KEY, PREDICT, PREDICTONLY, IGNORE}
DMName (string): Name of the column
DMStructureColumnType: one of {BOOLEAN, DATE, DOUBLE, LONG, TEXT}
DMStructureColumnContents: one of {CONTINUOUS, CYCLICAL, DISCRETE, DISCRETIZED, KEY, KEYSEQUENCE, KEYTIME, ORDERED, PROBABILITY, PROBABILITYSTDDEV, PROBABILITYVARIANCE, STDDEV, SUPPORT, VARIANCE}. This column specifies a “hint” on how a data mining predictive algorithm may want to treat the values of the column
DMOleDBtype: one of {Wchar, Integer, Boolean, Double, Bigint}

### DMCaseTable

The DMCaseTable object describes the case table for modeling. Note that ‘case’ table corresponds to the same notion from SQL Server 2005 Analysis Services.

### Class Description

The DMCaseTable object contains the following members:
DMTableName (string): name of the source case table for modeling
DMColumns (List of DMColumn objects): describing the columns in the case table
DMTableType (string): either “Table” or “View” depending upon how the case table for modeling is represented

### XML Example

Example XML for a DMCaseTable object:

```
<CaseTable>
  <DMTableName>vTargetMail DataMiningTable</DMTableName>
  <DMColumns>
    <item>
      <DMModelColumnUsages>KEY</DMModelColumnUsages>
      <Name>CustomerKey</Name>
      <StorageType type=“IntegerDataType” />
      <LogicalType>Key</LogicalType>
    </item>
    <item>
      <DMModelColumnUsages>INPUT</DMModelColumnUsages>
      <Name>MaritalStatus</Name>
      <StorageType type=“StringDataType”>
        <Unicode />
        <Width>1</Width>
      </StorageType>
      <LogicalType>Categorical</LogicalType>
    </item>
    <item>
      <DMModelColumnUsages>INPUT</DMModelColumnUsages>
      <Name>Gender</Name>
      <StorageType type=“StringDataType”>
        <Unicode />
        <Width>1</Width>
      </StorageType>
      <LogicalType>Categorical</LogicalType>
    </item>
    <item>
      <DMModelColumnUsages>INPUT</DMModelColumnUsages>
      <Name>YearlyIncome</Name>
      <StorageType type=“ArbitrarySQLDataType”>
        <SQLTypeName>money</SQLTypeName>
      </StorageType>
      <LogicalType>RawData</LogicalType>
    </item>
    <item>
      <DMModelColumnUsages>INPUT</DMModelColumnUsages>
      <Name>TotalChildren</Name>
      <StorageType type=“IntegerDataType” />
      <LogicalType>Numeric</LogicalType>
    </item>
    <item>
      <DMModelColumnUsages>INPUT</DMModelColumnUsages>
      <Name>NumberChildrenAtHome</Name>
      <StorageType type=“IntegerDataType” />
      <LogicalType>Numeric</LogicalType>
    </item>
    <item>
      <DMModelColumnUsages>INPUT</DMModelColumnUsages>
      <Name>EnglishEducation</Name>
      <StorageType type=“StringDataType”>
        <Unicode />
        <Width>40</Width>
      </StorageType>
      <LogicalType>Categorical</LogicalType>
    </item>
    <item>
      <DMModelColumnUsages>INPUT</DMModelColumnUsages>
      <Name>EnglishOccupation</Name>
      <StorageType type=“StringDataType”>
        <Unicode />
        <Width>100</Width>
      </StorageType>
      <LogicalType>Categorical</LogicalType>
    </item>
    <item>
      <DMModelColumnUsages>INPUT</DMModelColumnUsages>
      <Name>HouseOwnerFlag</Name>
      <StorageType type=“StringDataType”>
        <Unicode />
        <Width>1</Width>
      </StorageType>
      <LogicalType>Categorical</LogicalType>
    </item>
    <item>
      <DMModelColumnUsages>INPUT</DMModelColumnUsages>
      <Name>NumberCarsOwned</Name>
      <StorageType type=“IntegerDataType” />
      <LogicalType>Numeric</LogicalType>
    </item>
    <item>
      <DMModelColumnUsages>INPUT</DMModelColumnUsages>
      <Name>CommuteDistance</Name>
      <StorageType type=“StringDataType”>
        <Unicode />
        <Width>15</Width>
      </StorageType>
      <LogicalType>Categorical</LogicalType>
    </item>
    <item>
      <DMModelColumnUsages>INPUT</DMModelColumnUsages>
      <Name>Region</Name>
      <StorageType type=“StringDataType”>
        <Unicode />
        <Width>50</Width>
      </StorageType>
      <LogicalType>Categorical</LogicalType>
    </item>
    <item>
      <DMModelColumnUsages>INPUT</DMModelColumnUsages>
      <Name>Age</Name>
      <StorageType type=“IntegerDataType” />
      <LogicalType>Numeric</LogicalType>
    </item>
    <item>
      <DMIsPredictable />
      <DMModelColumnUsages>PREDICTONLY</
      DMModelColumnUsages>
      <Name>BikeBuyer</Name>
      <StorageType type=“IntegerDataType” />
      <LogicalType>Boolean</LogicalType>
    </item>
  </DMColumns>
  <DMTableType>Table</DMTableType>
</CaseTable>
```

### DMNestedTable

The DMNestedTable object describes a nested table for modeling. Note that ‘nested’ table corresponds to the same notion from SQL Server 2005 Analysis Services.

### Class Description

The DMNestedTable object is very similar to the DMCaseTable object, except that it contains a specification of the foreign-key relationship between the nested table and the case table, hence there is no assumption that the case-IDs in the case table and the nested table have the same column name.

The members of the DMNestedTable object are:
DMTablename (string): table name for the nested table
DMForeignKeyName (string): name of the foreign-key in the nested table that joins with the case key in the case table.
DMColumns (list of DMColumn objects)
DMTableType: either “Table” or “View” depending upon the actual representation of the nested table.

### DMDataset

The DMDataset object describes the physical layout of a dataset that is to be used for statistical modeling. Note that ‘case’ and ‘nested’ table correspond to the same notions when modeling using SQL Server 2005 Analysis Services.

### Class Description

The DMDataset object consists of the following members:
ConnectionString (string): specifying the connection to the data source containing the datasets to be modeled.
CaseTable (DMCaseTable): describes the structure of the case table for modeling
NestedTables (List of DMNestedTable objects).

### XML Example

Example XML for a DMDataset object:

```
    <Value type=“DMDataset”>
      <ConnectionString>Provider = SQLOLEDB;Data Source = V-PAULBR-
N2;Initial Catalog = AdventureWorksDW_DataStore;Integrated Security =
SSPI;</ConnectionString>
      <CaseTable>
        <DMTableName>vTargetMail DataMiningTable</DMTableName>
        <DMColumns>
          <item>
            <DMModelColumnUsages>KEY</DMModelColumnUsages>
            <Name>CustomerKey</Name>
            <StorageType type=“IntegerDataType” />
            <LogicalType>Key</LogicalType>
          </item>
          <item>
            <DMModelColumnUsages>INPUT</DMModelColumnUsages>
            <Name>MaritalStatus</Name>
            <StorageType type=“StringDataType”>
              <Unicode />
              <Width>1</Width>
            </StorageType>
            <LogicalType>Categorical</LogicalType>
          </item>
          <item>
            <DMModelColumnUsages>INPUT</DMModelColumnUsages>
            <Name>Gender</Name>
            <StorageType type=“StringDataType”>
              <Unicode />
              <Width>1</Width>
            </StorageType>
            <LogicalType>Categorical</LogicalType>
          </item>
          <item>
            <DMModelColumnUsages>INPUT</DMModelColumnUsages>
            <Name>YearlyIncome</Name>
            <StorageType type=“ArbitrarySQLDataType”>
              <SQLTypeName>money</SQLTypeName>
            </StorageType>
            <LogicalType>RawData</LogicalType>
          </item>
          <item>
            <DMModelColumnUsages>INPUT</DMModelColumnUsages>
            <Name>TotalChildren</Name>
            <StorageType type=“IntegerDataType” />
            <LogicalType>Numeric</LogicalType>
          </item>
          <item>
            <DMModelColumnUsages>INPUT</DMModelColumnUsages>
            <Name>NumberChildrenAtHome</Name>
            <StorageType type=“IntegerDataType” />
            <LogicalType>Numeric</LogicalType>
          </item>
          <item>
            <DMModelColumnUsages>INPUT</DMModelColumnUsages>
            <Name>EnglishEducation</Name>
            <StorageType type=“StringDataType”>
              <Unicode />
              <Width>40</Width>
            </StorageType>
            <LogicalType>Categorical</LogicalType>
          </item>
          <item>
            <DMModelColumnUsages>INPUT</DMModelColumnUsages>
            <Name>EnglishOccupation</Name>
            <StorageType type=“StringDataType”>
              <Unicode />
              <Width>100</Width>
            </StorageType>
            <LogicalType>Categorical</LogicalType>
          </item>
          <item>
            <DMModelColumnUsages>INPUT</DMModelColumnUsages>
            <Name>HouseOwnerFlag</Name>
            <StorageType type=“StringDataType”>
              <Unicode />
              <Width>1</Width>
            </StorageType>
            <LogicalType>Categorical</LogicalType>
          </item>
          <item>
            <DMModelColumnUsages>INPUT</DMModelColumnUsages>
            <Name>NumberCarsOwned</Name>
            <StorageType type=“IntergerDataType” />
            <LogicalType>Numeric</LogicalType>
          </item>
          <item>
            <DMModelColumnUsages>INPUT</DMModelColumnUsages>
            <Name>CommuteDistance</Name>
            <StorageType type=“StringDataType”>
              <Unicode />
              <Width>15</Width>
            </StorageType>
            <LogicalType>Categorical</LogicalType>
          </item>
          <item>
            <DMModelColumnUsages>INPUT</DMModelColumnUsages>
            <Name>Region</Name>
            <StorageType type=“StringDataType”>
              <Unicode />
              <Width>50</Width>
            </StorageType>
            <LogicalType>Categorical</LogicalType>
          </item>
          <item>
            <DMModelColumnUsages>INPUT</DMModelColumnUsages>
            <Name>Age</Name>
            <StorageType type=“IntegerDataType” />
            <LogicalType>Numeric</LogicalType>
          </item>
          <item>
            <DMIsPredictable />
            <DMModelColumnUsages>PREDICTONLY</DMModelColumnUsages>
            <Name>BikeBuyer</Name>
            <StorageType type=“IntegerDataType” />
            <LogicalType>Boolean</LogicalType>
          </item>
        </DMColumns>
        <DMTableType>Table</DMTableType>
      </CaseTable>
      <NestedTables />
    </Value>
```

### DMEnvironment

The DMEnvironment object simply specifies the SQL Server Analysis Server and SQL Server 2005 Analysis database that should be used for modeling.

### Class Description

The DMEnvironment object has 2 members:
ASServerName (string)
ASDatabasename (string)

### Example XML

Example XML for a DMEnvironment object is:

```
<Value type=“DMEnvironment”>
  <ASServerName>V-PAULBR-N2</ASServerName>
  <ASDatabaseName>AdventureWorks_ASDB</ASDatabaseName>
</Value>
```

### Learning Process

The Algorithm object specifies which statistical/machine learning algorithm to apply when modeling a given dataset, and the specific algorithm parameters that are to be used when modeling the dataset.

### Class Description

The Algorithm object contains the following members:
AlgorithmType (string)
AlgorithmName (string)
[Optional] Description (string): description of the algorithm
AlgorithmParameters (List of Parameter objects)

### XML Example

XML example of an Algorithm object is:

```
<Value type=“Algorithm”>
  <AlgorithmType>MICROSOFT_DECISION_TREES
  </AlgorithmType>
  <AlgorithmName>MICROSOFT_DECISION_TREES
  </AlgorithmName>
  <Description>DT CompPen 0.75, MinSupp 30</Description>
  <AlgorithmParameters>
    <item>
      <Name>COMPLEXITY_PENALTY</Name>
      <Value>0.75</Value>
    </item>
    <item>
      <Name>MAXIMUM_INPUT_ATTRIBUTES</Name>
      <Value>255</Value>
    </item>
    <item>
      <Name>MAXIMUM_OUTPUT_ATTRIBUTES</Name>
      <Value>255</Value>
    </item>
    <item>
      <Name>MINIMUM_SUPPORT</Name>
      <Value>30</Value>
    </item>
    <item>
      <Name>FORCE_REGRESSOR</Name>
      <Value />
    </item>
    <item>
      <Name>SCORE_METHOD</Name>
      <Value>4</Value>
    </item>
    <item>
      <Name>SPLIT_METHOD</Name>
      <Value>3</Value>
    </item>
  </AlgorithmParameters>
</Value>
```

### Model

The Model object defines a statistical/machine learning model that has been built as a result of applying a given algorithm to a specific dataset. The Model object stores this information along with location information of the model (i.e. the SQL Server 2005 Analysis Services server, database, and associated Analysis Services objects that represent the model)

### Class Description

The Model object consists of the following members:
ModelType: one of {Predict, Cluster}
dmDataset (DMDataset): the DMDataset object representing the source data over which the model was estimated.
dmAlgorithm (Algorithm): the Algorithm object representing
dmEnvironment (DMEnvironment): the Analysis Server/Analysis Database where the model was built
DMModelName (string): name of the model
ASDataSourceName (string): name of the Analysis Services Data Source object associated with the model
ASDataSourceViewName (string): name of the Analysis Services Data Source View object associated with the model
ASMiningStructureName (string): name of the Analysis Services Mining Structure associated with the model

### XML Example

Example XML for a Model object:

```
    <Value type=“Model”>
      <ModelType>Predict</ModelType>
      <dmDataset>
        <ConnectionString>Provider = SQLOLEDB;Data Source = V-PAULBR-
N2;Initial Catalog = AdventureWorksDW_DataStore;Integrated Security =
SSPI;</ConnectionString>
        <CaseTable>
          <DMTableName>vTargetMail DataMiningTable</DMTableName>
          <DMColumns>
            <item>
              <DMModelColumnUsages>KEY</DMModelColumnUsages>
              <Name>CustomerKey</Name>
              <StorageType type=“IntegerDataType” />
              <LogicalType>Key</LogicalType>
            </item>
            <item>
              <DMModelColumnUsages>INPUT</DMModelColumnUsages>
              <Name>MaritalStatus</Name>
              <StorageType type=“StringDataType”>
                <Unicode />
                <Width>1</Width>
              </StorageType>
              <LogicalType>Categorical</LogicalType>
            </item>
            <item>
              <DMModelColumnUsages>INPUT</DMModelColumnUsages>
              <Name>Gender</Name>
              <StorageType type=“StringDataType”>
                <Unicode />
                <Width>1</Width>
              </StorageType>
              <LogicalType>Categorical</LogicalType>
            </item>
            <item>
              <DMModelColumnUsages>INPUT</DMModelColumnUsages>
              <Name>YearlyIncome</Name>
              <StorageType type=“RealDataType” />
              <LogicalType>Numeric</LogicalType>
            </item>
            <item>
              <DMModelColumnUsages>INPUT</DMModelColumnUsages>
              <Name>TotalChildren</Name>
              <StorageType type=“IntegerDataType” />
              <LogicalType>Numeric</LogicalType>
            </item>
            <item>
              <DMModelColumnUsages>INPUT</DMModelColumnUsages>
              <Name>NumberChildernAtHome</Name>
              <StorageType type=“IntegerDataType” />
              <LogicalType>Numeric</LogicalType>
            </item>
            <item>
              <DMModelColumnUsages>INPUT</DMModelColumnUsages>
              <Name>EnglishEducation</Name>
              <StorageType type=“StringDataType”>
                <Unicode />
                <Width>40</Width>
              </StorageType>
              <LogicalType>Categorical</LogicalType>
            </item>
            <item>
              <DMModelColumnUsages>INPUT</DMModelColumnUsages>
              <Name>EnglishOccupation</Name>
              <StorageType type=“StringDataType”>
                <Unicode />
                <Width>100</Width>
              </StorageType>
              <LogicalType>Categorical</LogicalType>
            </item>
            <item>
              <DMModelColumnUsages>INPUT</DMModelColumnUsages>
              <Name>HouseOwnerFlag</Name>
              <StorageType type=“StringDataType”>
                <Unicode />
                <Width>1</Width>
              </StorageType>
              <LogicalType>Categorical</LogicalType>
            </item>
            <item>
              <DMModelColumnUsages>INPUT</DMModelColumnUsages>
              <Name>NumberCarsOwned</Name>
              <StorageType type=“IntegerDataType” />
              <LogicalType>Numeric</LogicalType>
            </item>
            <item>
              <DMModelColumnUsages>INPUT</DMModelColumnUsages>
              <Name>CommuteDistance</Name>
              <StorageType type=“StringDataType”>
                <Unicode />
                <Width>15</Width>
              </StorageType>
              <LogicalType>Categorical</LogicalType>
            </item>
            <item>
              <DMModelColumnUsages>INPUT</DMModelColumnUsages>
              <Name>Region</Name>
              <StorageType type=“StringDataType”>
                <Unicode />
                <Width>50</Width>
              </StorageType>
              <LogicalType>Categorical</LogicalType>
            </item>
            <item>
              <DMModelColumnUsages>INPUT</DMModelColumnUsages>
              <Name>Age</Name>
              <StorageType type=“IntegerDataType” />
              <LogicalType>Numeric</LogicalType>
            </item>
            <item>
              <DMIsPredictable />
              <DMModelColumnUsages>PREDICTONLY</DMModelColumnUsages>
              <Name>BikeBuyer</Name>
              <StorageType type=“IntegerDataType” />
              <LogicalType>Boolean</LogicalType>
            </item>
          </DMColumns>
          <DMTableType>Table</DMTableType>
        </CaseTable>
        <NestedTables />
      </dmDataset>
      <dmAlgorithm>
        <AlgorithmType>MICROSOFT_DECISION_TREES</AlgorithmType>
        <AlgorithmName>MICROSOFT_DECISION_TREES</AlgorithmName>
        <Description>DT CompPen 0.75, MinSupp 30</Description>
        <AlgorithmParameters>
          <item>
            <Name>COMPLEXITY_PENALTY</Name>
            <Value>0.75</Value>
          </item>
          <item>
            <Name>MAXIMUM_INPUT_ATTRIBUTES</Name>
            <Value>255</Value>
          </item>
          <item>
            <Name>MAXIMUM_OUTPUT_ATTRIBUTES</Name>
            <Value>255</Value>
          </item>
          <item>
            <Name>MINIMUM_SUPPORT</Name>
            <Value>30</Value>
          </item>
          <item>
            <Name>FORCE_REGRESSOR</NAME>
            <Value />
          </item>
          <item>
            <Name>SCORE_METHOD</Name>
            <Value>4</Value>
          </item>
          <item>
            <Name>SPLIT_METHOD</Name>
            <Value>3</Value>
          </item>
          </AlgorithmParameters>
      </dmAlgorithm>
      <dmEnvironment>
        <ASServerName>V-PAULBR-N2</ASServerName>
        <ASDatabaseName>AdventureWorks_ASDB</ASDatabaseName>
      </dmEnvironment>
      <DMModelName>DT-Foo</DMModelName>
      <ASDataSourceName>DT-Foo_DS</ASDataSourceName>
      <ASDataSourceViewName>DT-Foo_DSV</ASDataSourceViewName>
      <ASMiningStructureName>DT-Foo_MS</ASMiningStructureName>
    </Value>
```

### DiscreteModelEvaluation

The DiscreteModelEvaluation object stores the results of testing (evaluating) a modeling configuration over a holdout set (or holdout sets). The DiscreteModelEvaluation object stores these test results in the case that the variable being predicted is discrete (i.e. has values that come from a small, finite, typically unordered set).

### Class Description

The DiscreteModelEvaluation object has the following members:
numFolds (integer): number of folds used when Cross-Validation is used to evaluate model performance
numData (integer): number of cases tested
AccuracyModelTest (double): accuracy of the model over the test set
AdjustedAccuracyModelTest (double): accuracy, taking into account the predicted probability of the associated model prediction
AccuracyMarginalTest (double): the accuracy of the marginal model over the testing set(s).
AdjustedAccuracyMarginalTest (double): accuracy of the marginal model, taking into account the probability associated with the marginal prediction
Lift: (model accuracy over the test set(s))/(marginal accuracy over the test set(s))
Adjusted Lift: (model adjusted accuracy over the test set(s))/(marginal adjusted accuracy over the test set(s))
Confusion Matrix: confusion matrix representation for the discrete prediction results

1DMROCNumPointsToPlot (integer): If the discrete prediction problem is Boolean (2-classes), the value for this member is that number of ROC curve points that are available.
[Optional] DMROCCurve (List of ROC Points): list of (x,y) pairs representing the ROC curve for the associated model evaluation.
RateFalseValue (string): name of the predictable value corresponding to ‘false’
RateTrueValue (string): name of the predictable value corresponding to ‘true’
FalsePositiveRate (double): false positive rate associated with the predictions made by the given model
TruePositiveRate (double): true positive rate associated with the predictions made by the given model
MissedPositiveRate (double): 1.0—TruePositiveRate
AccuracyModelTrain (double): Accuracy of the model computed over the training set(s)
AdjustedAccuracyModelTrain (double): Accuracy of the model, taking into account predicted probability, over the training set(s)
AccuracyMarginalTrain (double): Accuracy of the marginal model over the training set(s).
AdjustedAccuracyMarginalTrain (double): Accuracy of the marginal model, taking into account the probability of the marginal prediction, over the training set(s).

### XML Example

Example XML for a DiscreteModelEvaluation object is:

```
  <value type=“DiscreteModelEvaluation”>
    <numFolds>3</numFolds>
    <numData>18484</numData>
    <AccuracyModelTest>0.456665223977494</AccuracyModelTest>
    <AdjustedAccuracyModelTest>0.339129972819107</AdjustedAccuracyModelTest
  >
    <AccuracyMarginalTest>1</AccuracyMarginalTest>
  <AdjustedAccuracyMarginalTest>0.505951498981709</AdjustedAccuracyMarginalTest>
    <Lift>−0.543334776022506</Lift>
    <AdjustedLift>−0.329718414706451</AdjustedLift>
    <ConfusionMatrix>
      <ConfusionMatrixNames>
        <item>0</item>
        <item>1</item>
      </ConfusionMatrixNames>
      <Matrix>
        <item>
          <PredValue>0</PredValue>
          <ActualValue>0</ActualValue>
          <MatrixValue>8441<MatrixValue>
        </item>
        <item>
          <PredValue>0</PredValue>
          <ActualValue>1</ActualValue>
          <MatrixValue>0</MatrixValue>
        </item>
        <item>
          <PredValue>1</PredValue>
          <ActualValue>0</ActualValue>
          <MatrixValue>10043</MatrixValue>
        </item>
        <item>
          <PredValue>1</PredValue>
          <ActualValue>1</ActualValue>
          <MatrixValue>0</MatrixValue>
        </item>
      </Matrix>
    </ConfusionMatrix>
    <DMROCNumPointsToPlot>0</DMROCNumPointsToPlot>
    <RateFalseValue>0</RateFalseValue>
    <RateTrueValue />
    <FalsePositiveRate>0.543334776022506</FalsePositiveRate>
    <TruePositiveRate>NaN</TruePositiveRate>
    <MissedPositiveRate>NaN</MissedPositiveRate>
    <AccuracyModelTrain>0.458234148452716</AccuracyModelTrain>
  <AdjustedAccuracyModelTrain>0.340344745117976</AdjustedAccuracyModelTrain>
    <AccuracyMarginalTrain>1</AccuracyMarginalTrain>
  <AdjustedAccuracyMarginalTrain>0.505951092837061</AdjustedAccuracyMarginalTrain>
    <dmAlgorithm>
      <AlgorithmType>MICROSOFT_DECISION_TREES</AlgorithmType>
      <AlgorithmName>MICROSOFT_DECISION_TREES</AlgorithmName>
      <Description>DT CompPen 0.75, MinSupp 30</Description>
      <AlgorithmParameters>
        <item>
          <Name>COMPLEXITY_PENALTY</Name>
          <Value>0.75</Value>
        </item>
        <item>
          <Name>MAXIMUM_INPUT_ATTRIBUTES</Name>
          <Value>255</Value>
        </item>
        <item>
          <Name>MAXIMUM_OUTPUT_ATTRIBUTES</Name>
          <Value>255</Value>
        </item>
        <item>
          <Name>MINIMUM_SUPPORT</Name>
          <Value>30</Value>
        </item>
        <item>
          <Name>FORCE_REGRESSOR</Name>
          <Value />
        </item>
        <item>
          <Name>SCORE_METHOD</Name>
          <Value>4</Value>
        </item>
        <item>
          <Name>SPLIT_METHOD</Name>
        <Value>3</Value>
      </item>
    </AlgorithmParameters>
  </dmAlgorithm>
  <dmDataset>
    <ConnectionString>Provider = SQLOLEDB;Data Source = V-PAULBR-
N2;Initial Catalog = AdventureWorksDW_DataStore;Integrated Security =
SSPI;</ConnectionString>
    <CaseTable>
      <DMTableName>vTargetMail_DataMining_Table</DMTableName>
      <DMColumns>
        <item>
          <DMModelColumnUsages>KEY</DMModelColumnUsages>
          <Name>CustomerKey</Name>
          <StorageType type=“IntegerDataType” />
          <LogicalType>Key</LogicalType>
        </item>
        <item>
          <DMModelColumnUsages>INPUT</DMModelColumnUsages>
          <Name>MaritalStatus</Name>
          <StorageType type=“StringDataType”>
            <Unicode />
            <Width>1</Width>
          </StorageType>
          <LogicalType>Categorical</LogicalType>
        </item>
        <item>
          <DMModelColumnUsages>INPUT</DMModelColumnUsages>
          <Name>Gender</Name>
          <StorageType type=“StringDataType”>
            <Unicode />
            <Width>1</Width>
          </StorageType>
          <LogicalType>Categorical</LogicalType>
        </item>
        <item>
          <DMModelColumnUsages>INPUT</DMModelColumnUsages>
          <Name>YearlyIncome</Name>
          <StorageType type=“RealDataType” />
          <LogicalType>Numeric</LogicalType>
        </item>
        <item>
          <DMModelColumnUsages>INPUT</DMModelColumnUsages>
          <Name>TotalChildren</Name>
          <StorageType type=“IntegerDataType” />
          <LogicalType>Numeric</LogicalType>
        </item>
        <item>
          <DMModelColumnUsages>INPUT</DMModelColumnUsages>
          <Name>NumberChildrenAtHome</Name>
          <StorageType type=“IntegerDataType” />
          <LogicalType>Numeric</LogicalType>
        </item>
        <item>
          <DMModelColumnUsages>INPUT</DMModelColumnUsages>
          <Name>EnglishEducation</Name>
          <StorageType type=“StringDataType”>
            <Unicode />
            <Width>40</Width>
          </StorageType>
          <LogicalType>Categorical</LogicalType>
        </item>
        <item>
          <DMModelColumnUsages>INPUT</DMModelColumnUsages>
          <Name>EnglishOccupation</Name>
          <StorageType type=“StringDataType”>
            <Unicode />
            <Width>100</Width>
          </StorageType>
          <LogicalType>Categorical</LogicalType>
        </item>
        <item>
          <DMModelColumnUsages>INPUT</DMModelColumnUsages>
          <Name>HouseOwnerFlag</Name>
          <StorageType type=“StringDataType”>
            <Unicode />
            <Width>1</Width>
          </StorageType>
          <LogicalType>Categorical</LogicalType>
        </item>
        <item>
          <DMModelColumnUsages>INPUT</DMModelColumnUsages>
          <Name>NumberCarsOwned</Name>
          <StorageType type=“IntegerDataType” />
          <LogicalType>Numeric</LogicalType>
        </item>
        <item>
          <DMModelColumnUsages>INPUT</DMModelColumnUsages>
          <Name>CommuteDistance</Name>
          <StorageType type=“StringDataType”>
            <Unicode />
            <Width>15</Width>
          </StorageType>
          <LogicalType>Categorical</LogicalType>
        </item>
        <item>
          <DMModelColumnUsages>INPUT</DMModelColumnUsages>
          <Name>Region</Name>
          <StorageType type=“StringDataType”>
            <Unicode />
            <Width>50</Width>
          </StorageType>
          <LogicalType>Categorical</LogicalType>
        </item>
        <item>
          <DMModelColumnUsages>INPUT</DMModelColumnUsages>
          <Name>Age</Name>
          <StorageType type=“IntegerDataType” />
          <LogicalType>Numeric</LogicalType>
        </item>
        <item>
          <DMIsPredictable />
          <DMModelColumnUsages>PREDICTONLY</DMModelColumnUsages>
          <Name>BikeBuyer</Name>
          <StorageType type=“IntegerDataType” />
          <LogicalType>Boolean</LogicalType>
        </item>
      </DMColumns>
      <DMTableType>View</DMTableType>
    </CaseTable>
    <NestedTables />
  </dmDataset>
</value>
```

### ContinuousModelEvaluation

Similar to the DiscreteModelEvaluation object, the ContinuousModelEvaluation object holds results when evaluating the performance of a predictive model that is estimating the value of a continuous column (i.e. a regression model).

### Class Description

The ContinuousModelEvaluation object has the following members:
numFolds (int): number of folds used if Cross-Validation is utilized as the method for model evaluation.
numData (int): number of cases tested on.
AvgAbsErrorTest (double): average absolute error between predicted and actual values over the test set(s)
AvgRelErrorTest (double): average relative error between predicted and actual values over the test set(s)
AvgAbsErrorTrain (double): average absolute error between predicted and actual over the training set(s)
AvgRelErrorTrain (double): average relative error between predicted and actual over the training set(s)
AvgSSEModelTest (double): average sum of squared errors between predicted and actual over the test set(s)
AvgeSSEMeanValueTest (double): average sum of squared errors between the mean value and actual values over the test set(s)
SqrtAvgSSEModelTest (double): sqrt(AvgSSEModelTest)
SqrtAvgSSEMeanValueTest (double): sqrt(AvgSSEMeanValueTest)
AvgNormalizedErrorTest (double): average sum of squared errors between the predicted and actual values, divided by the predicted variance, averaged over the test set(s).
Lift (double): 1.0—(AvgSSEModelTest)/(AvgSSEMeanValueTest)
AvgSSEModelTrain (double): average sum of squared errors between predicted and actual over the training set(s)
AvgSSEMeanValueTrain (double): average sum of squared errors between the mean value and actual values over the training set(s)
SqrtAvgSSEModelTrain (double): sqrt(AvgSSEModelTrain)
SqrtAvgSSEMeanValueTrain (double): sqrt(AvgSSEMeanValueTrain)
AvgNormalizedErrorTrain (double): average sum of squared errors between the predicted and actual values, divided by the predicted variance, averaged over the training set(s).
dmAlgorithm (Algorithm): the algorithm that was used to build the statistical model being evaluated.
dmDataset (DMDataset): the dataset over which the model was built/evalutated

### Dimension

The Dimension class is used to store the name and type associated with a dimension for charting purposes.

### Class Description

The Dimension object consists of the following two members:
Name (string): name of the dimension
Type (LogicalType): the type of the dimension

### XML Example

Example XML for the Dimension object is:

<Name>Percentage</Name>
<Type>Numeric</Type>

### ReportChart

The ReportChart object describes a given reporting chart that is used in the EvaluationReport object.

### Class Description

The ReportChart object has the following members:
Series_Dimension (Dimension): series for the chart
X_Dimension (Dimension): x-values for the chart
Y_Dimension (Dimension): y-values for the chart
Data (List of (Series_Value, X_Value, Y_Value) items): data to be plotted
ChartViewType: one of {Line, Bar, Points, Pie}
Stacked (Boolean): indicator on whether the plot can be stacked
ThreeDimensiona (Boolean): indicator on whether the plot can be shown in 3-dimensions

### Example XML

Example XML for the ReportChart object is:

```
<item>
  <Title>Category Accuracy and Adjusted Accuracy</Title>
  <Series_Dimension>
    <Name>Predicted Category</Name>
    <Type>Categorical</Type>
  </Series_Dimension>
  <X_Dimension>
    <Name>Player Worth Category</Name>
    <Type>Categorical</Type>
  </X_Dimension>
  <Y_Dimension>
    <Name>Percentage</Name>
    <Type>Numeric</Type>
  </Y_Dimension>
  <Data>
    <item>
      <Series_Value>
        <Value>Accuracy</Value>
      </Series_Value>
      <X_Value>
        <Value>1</Value>
      </X_Value>
      <Y_Value>
        <Value>88.3</Value>
      </Y_Value>
    </item>
    <item>
      <Series_Value>
        <Value>Accuracy</Value>
      </Series_Value>
      <X_Value>
        <Value>2</Value>
      </X_Value>
      <Y_Value>
        <Value>47.2</Value>
      </Y_Value>
    </item>
    <item>
      <Series_Value>
        <Value>Accuracy</Value>
      </Series_Value>
      <X_Value>
        <Value>3</Value>
      </X_Value>
      <Y_Value>
        <Value>46.1</Value>
      </Y_Value>
    </item>
    <item>
      <Series_Value>
        <Value>Accuracy</Value>
      </Series_Value>
      <X_Value>
        <Value>4</Value>
      </X_Value>
      <Y_Value>
        <Value>32.0</Value>
      </Y_Value>
    </item>
    <item>
      <Series_Value>
        <Value>Accuracy</Value>
      </Series_Value>
      <X_Value>
        <Value>5</Value>
      </X_Value>
      <Y_Value>
        <Value>47.5</Value>
      </Y_Value>
    </item>
    <item>
      <Series_Value>
        <Value>Accuracy</Value>
      </Series_Value>
      <X_Value>
        <Value>6</Value>
      </X_Value>
      <Y_Value>
        <Value>45.0</Value>
      </Y_Value>
    </item>
    <item>
      <Series_Value>
        <Value>Adj. Accuracy</Value>
      </Series_Value>
      <X_Value>
        <Value>1</Value>
      </X_Value>
      <Y_Value>
        <Value>97.5</Value>
      </Y_Value>
    </item>
    <item>
      <Series_Value>
        <Value>Adj. Accuracy</Value>
      </Series_Value>
      <X_Value>
        <Value>2</Value>
      </X_Value>
      <Y_Value>
        <Value>96.6</Value>
      </Y_Value>
    </item>
    <item>
      <Series_Value>
        <Value>Adj. Accuracy</Value>
      </Series_Value>
      <X_Value>
        <Value>3</Value>
      </X_Value>
      <Y_Value>
        <Value>79.9</Value>
      </Y_Value>
    </item>
    <item>
      <Series_Value>
        <Value>Adj. Accuracy</Value>
      </Series_Value>
      <X_Value>
        <Value>4</Value>
      </X_Value>
      <Y_Value>
        <Value>73.5</Value>
      </Y_Value>
    </item>
    <item>
      <Series_Value>
        <Value>Adj. Accuracy</Value>
      </Series_Value>
      <X_Value>
        <Value>5</Value>
      </X_Value>
      <Y_Value>
        <Value>64.8</Value>
      </Y_Value>
    </item>
    <item>
      <Series_Value>
        <Value>Adj. Accuracy</Value>
      </Series_Value>
      <X_Value>
        <Value>6</Value>
      </X_Value>
      <Y_Value>
        <Value>69.6</Value>
      </Y_Value>
    </item>
  </Data>
  <ViewType>Points</ViewType>
</item>
```

### EvaluationReport

The EvaluationReport object is used to represent the results of either a discrete model evaluation computation or a continuous model evaluation computation.

### Class Description

The EvaluationReport object contains the following members:
Infos (list of (name, description, value) items): Generic list of items that describe the evaluation that was performed and is to be charted or reported.
Metrics (list of (name, description, value) items): List of evaluation metrics and the specific values that have been computed during the evaluation computations.
Charts (list of ReportChart objects): charts for plotting various model evaluation results.

The EvaluationReport object exposes the following methods:
Ability to add a new metric item with given name, description, and value
Ability to add a new info item with give name, description, and value

### XML Example

Example XML for the EvaluationReport object is:

```
  <Value type=“EvaluationReport”>
    <Infos>
      <item>
        <Description>Type of evaluation performed</Description>
        <Name>Evaluation Type</Name>
        <Value>Cross-Validation</Value>
      </item>
      <item>
        <Description>Cross validation number of folds executed in
evaluation</Description>
        <Name>Cross Validation: Number of Folds</Name>
        <Value>10</Value>
      </item>
      <item>
        <Description>Dataset used in the evaluation</Description>
        <Name>Dataset</Name>
        <Value>N180_ClusterRatings_NoTierOldRatings</Value>
      </item>
      <item>
        <Description>Algorithm used in the evaluation</Description>
        <Name>Algorithm</Name>
        <Value>Microsoft Decision Trees</Value>
      </item>
      <item>
        <Description>Decision Tree Complexity Penalty parameter
value used in the evaluation</Description>
        <Name>Microsoft Decision Tree: Complexity Penalty
        Value</Name>
        <Value>0.5</Value>
      </item>
      <item>
        <Description>Decision Tree Maximum Input Attributes
parameter value used in the evaluation</Description>
        <Name>Microsoft Decision Tree: Maximum Input Attributes
Value</Name>
        <Value>255</Value>
      </item>
      <item>
        <Description>Decision Tree Maximum Output Attributes
parameter value used in the evaluation</Description>
        <Name>Microsoft Decision Tree: Maximum Output Attributes
Value</Name>
        <Value>255</Value>
      </item>
      <item>
        <Description>Decision Tree Minimum Support parameter value
used in the evaluation</Description>
        <Name>Microsoft Decision Tree: Minimum Support Value
        </Name>
        <Value>10</Value>
      </item>
      <item>
        <Description>Decision Tree Force Regressor parameter value
used in the evaluation</Description>
        <Name>Microsoft Decision Tree: Force Regressor</Name>
        <Value>
        </Value>
      </item>
      <item>
        <Description>Decision Tree Score Method parameter value used
in the evaluation</Description>
        <Name>Microsoft Decision Tree: Score Method</Name>
        <Value>Entropy</Value>
      </item>
      <item>
        <Description>Decision Tree Split Method parameter value used
in the evaluation</Description>
        <Name>Microsoft Decision Tree: Split Method</Name>
        <Value>Either Binary or Complete</Value>
      </item>
    </Infos>
    <Metrics>
      <item>
        <Description>Average percentage of cases in which predicted
bin value is equal to actual bin value, averaged over each
fold</Description>
        <Name>Average Overall Accuracy</Name>
        <Value>67.3%</Value>
      </item>
      <item>
        <Description>Standard deviation of the percentage of cases in
which predicted bin value is equal to actual bin value, over each
fold</Description>
        <Name>Standard Deviation Overall Accuracy</Name>
        <Value>0.3%</Value>
      </item>
      <item>
        <Description>Average percentage of cases in which predicted
bin value is +/− 1 bin from actual bin value, averaged over each
fold</Description>
        <Name>Average Overall Adjusted Accuracy</Name>
        <Value>91.6%</Value>
      </item>
      <item>
        <Description>Standard deviation of the percentage of cases in
which predicted bin value is +/− 1 bin from actual bin value, over each
fold</Description>
        <Name>Standard Deviation Overall Adjusted Accuracy</Name>
        <Value>0.2%</Value>
      </item>
    </Metrics>
    <Charts>
      <item>
        <Title>Category Accuracy and Adjusted Accuracy</Title>
        <Series_Dimension>
          <Name>Predicted Category</Name>
          <Type>Categorical</Type>
        </Series_Dimension>
        <X_Dimension>
          <Name>Player Worth Category</Name>
          <Type>Categorical</Type>
        </X_Dimension>
        <Y_Dimension>
          <Name>Percentage</Name>
          <Type>Numeric</Type>
        </Y_Dimension>
        <Data>
          <item>
            <Series_Value>
              <Value>Accuracy</Value>
            </Series_Value>
            <X_Value>
              <Value>1</Value>
            </X_Value>
            <Y_Value>
              <Value>88.3</Value>
            </Y_Value>
          </item>
          <item>
            <Series_Value>
              <Value>Accuracy</Value>
            </Series_Value>
            <X_Value>
              <Value>2</Value>
            </X_Value>
            <Y_Value>
              <Value>47.2</Value>
            </Y_Value>
          </item>
          <item>
            <Series_Value>
              <Value>Accuracy</Value>
            </Series_Value>
            <X_Value>
              <Value>3</Value>
            </X_Value>
            <Y_Value>
              <Value>46.1</Value>
            </Y_Value>
          </item>
          <item>
            <Series_Value>
              <Value>Accuracy</Value>
            </Series_Value>
            <X_Value>
              <Value>4</Value>
            </X_Value>
            <Y_Value>
              <Value>32.0</Value>
            </Y_Value>
          </item>
          <item>
            <Series_Value>
              <Value>Accuracy</Value>
            </Series_Value>
            <X_Value>
              <Value>5</Value>
            </X_Value>
            <Y_Value>
              <Value>47.5</Value>
            </Y_Value>
          </item>
          <item>
            <Series_Value>
              <Value>Accuracy</Value>
            </Series_Value>
            <X_Value>
              <Value>6</Value>
            </X_Value>
            <Y_Value>
              <Value>45.0</Value>
            </Y_Value>
          </item>
          <item>
            <Series_Value>
              <Value>Adj. Accuracy</Value>
            </Series_Value>
            <X_Value>
              <Value>1</Value>
            </X_Value>
            <Y_Value>
              <Value>97.5</Value>
            </Y_Value>
          </item>
          <item>
            <Series_Value>
              <Value>Adj. Accuracy</Value>
            </Series_Value>
            <X_Value>
              <Value>2</Value>
            </X_Value>
            <Y_Value>
              <Value>96.6</Value>
            </Y_Value>
          </item>
          <item>
            <Series_Value>
              <Value>Adj. Accuracy</Value>
            </Series_Value>
            <X_Value>
              <Value>3</Value>
            </X_Value>
            <Y_Value>
              <Value>79.9</Value>
            </Y_Value>
          </item>
          <item>
            <Series_Value>
              <Value>Adj. Accuracy</Value>
            </Series_Value>
            <X_Value>
              <Value>4</Value>
            </X_Value>
            <Y_Value>
              <Value>73.5</Value>
            </Y_Value>
          </item>
          <item>
            <Series_Value>
              <Value>Adj. Accuracy</Value>
            </Series_Value>
            <X_Value>
              <Value>5</Value>
            </X_Value>
            <Y_Value>
              <Value>64.8</Value>
            </Y_Value>
          </item>
          <item>
            <Series_Value>
              <Value>Adj. Accuracy</Value>
            </Series_Value>
            <X_Value>
              <Value>6</Value>
            </X_Value>
            <Y_Value>
              <Value>69.6</Value>
            </Y_Value>
          </item>
        </Data>
        <ViewType>Points</ViewType>
    </item>
  </Charts>
</Value>
```

### Execution Engine

The primary purpose of the Execution Engine is to execute the tasks defined in pipeline objects and store information on errors that may be encountered, the time it takes to execute various tasks, etc.

The execution engine is implemented as a command-line application. When it is run, it requires an XML file (whose location is specified as a command-line parameter) known as the “config.xml” file. This file contains the following information:
The name of the SQL-Server and the relational database that contains the metadata storage schema (see FIG. 4)
The path to various SQL files, etc. that are used to “install” the system
The path to a “temp” file directory used to store intermediate files, etc.

### Config.xml

“config.xml” has the following structure:

```
<params>
  <param key=“Server”>V-PAULBR-N2</param>
  <param key=“Database”>AdventureWorksDW_Metadata</param>
  <param key=“Build Folder”></param>
  <param key=“Temp Folder”>C:\Documents and
Settings\paul.APOLLO\My Documents\APOLLO\projects\apollo-
platform\builds></param>
</params>
```

### Instantiating Metadata Objects

The execution engine has access to C# classes corresponding to the metadata classes described previously. Since each of these objects can save their state to XML and load from XML, which is stored in the [Definitions] table in the metadata relational database (see FIG. 4), the execution engine can easily load pipelines, tasks, and instantiate the parameters required for these tasks to execute them.

### Utilization of SQL-Server and Other Components

This general metadata-driven system was constructed to largely automate as much of the data analysis and modeling process as possible. To accomplish this, the execution engine, via specific tasks, will call functionality that is provided by 3^{rd} party components that can be automated at a code-level. 3^{rd} party components utilized by the execution engine to perform various actions include SQL Server 2005 functionality provided by Microsoft Corp.

### Execution Engine Functionality

The command line “driver.exe” program (which is generally referred to as the “execution engine”) supports the following functionality (which is described in more detail in following sections):
Install the metadata database with schema described in FIG. 4 (Install).
Ability to create a new project (Create Project)
Ability to drop a project (Drop Project)
Ability to export all metadata objects associated with a project to an XML file (Export Project)
Ability to import all metadata objects associated with a project from an XML file (Import Project)
Ability to execute a specific pipeline (Execute Pipeline)
Ability to execute all pipelines that are in a pending state (Execute Pending)
Ability to, on a regular basis, check to determine if there are any pipelines in a pending state and execute them (Emulate Server)

### Install Functionality

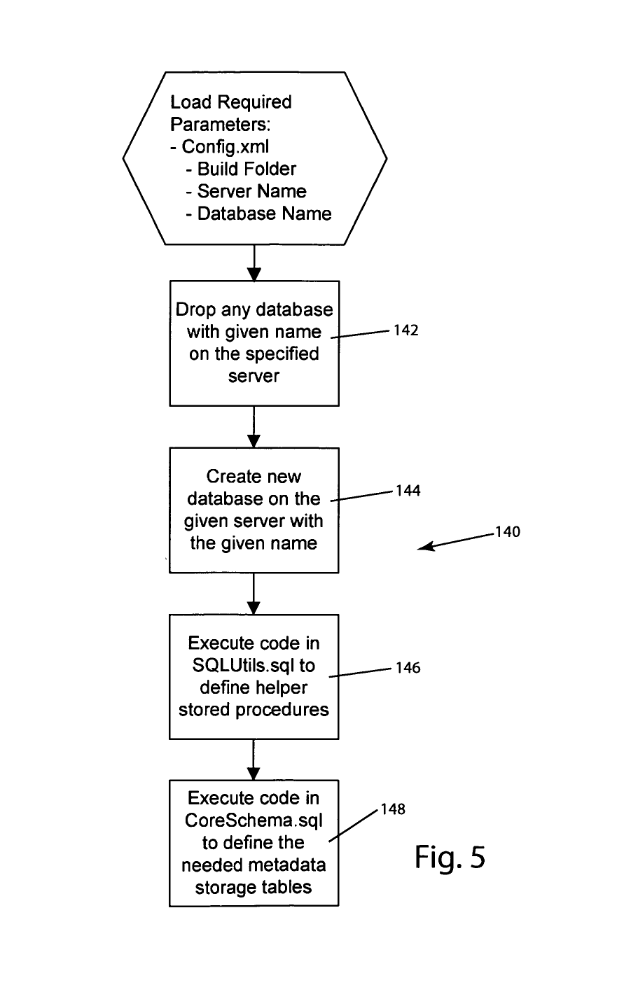

FIG. 5 describes a process 140 that the driver.exe program executes when called with the/install option.

### Process Overview

1. The following elements defined in “config.xml” are extracted:
   a. Build Folder: this specifies the location of the SQL files that will be executed to define helper stored procedures and to define the schema needed to store the metadata objects.
   b. Server Name: the database server name is needed to create databases, etc.
   c. Database Name: the database name is needed to create the database and then to connect to it, etc.
2. A check is made to determine if a database with the name <Database Name> already exists in the server with name <Server Name>. If so, the database is dropped 142.
3. A new database with name <Database Name> is created 144 on the server with name <Server Name>.
4. Helper stored procedures defined in a SQL script (SQLUtils.sql) are executed 146 in the new database, hence creating the helper stored procedures there. These stored procedures help manage tables, views, functions and other stored procedures.
5. A SQL script is executed 148 against the given database to create the table structure described in FIG. 4 for storing the system metadata.

### Create Project Functionality

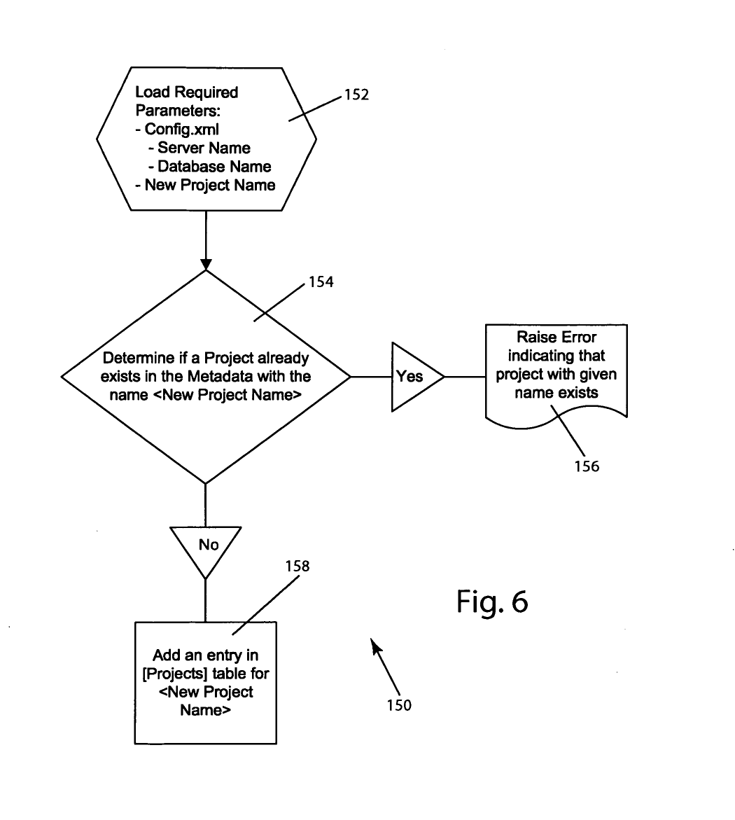

When the execution engine is called with the/create-project switch a process 150 of FIG. 6 is executed. The <Server Name> and <Database Name> are loaded 152 from “config.xml” to determine where the metadata database is located. The project name <New Project Name> is also loaded from the command line 152. Then the execution engine queries the [Projects] table (FIG. 4) to determine 154 if a project already exists with the given name <New Project Name>. If so, an error is raised 156. If not, an entry is created 158 in the [Projects] table and a new project has been defined.

### Drop Project Functionality

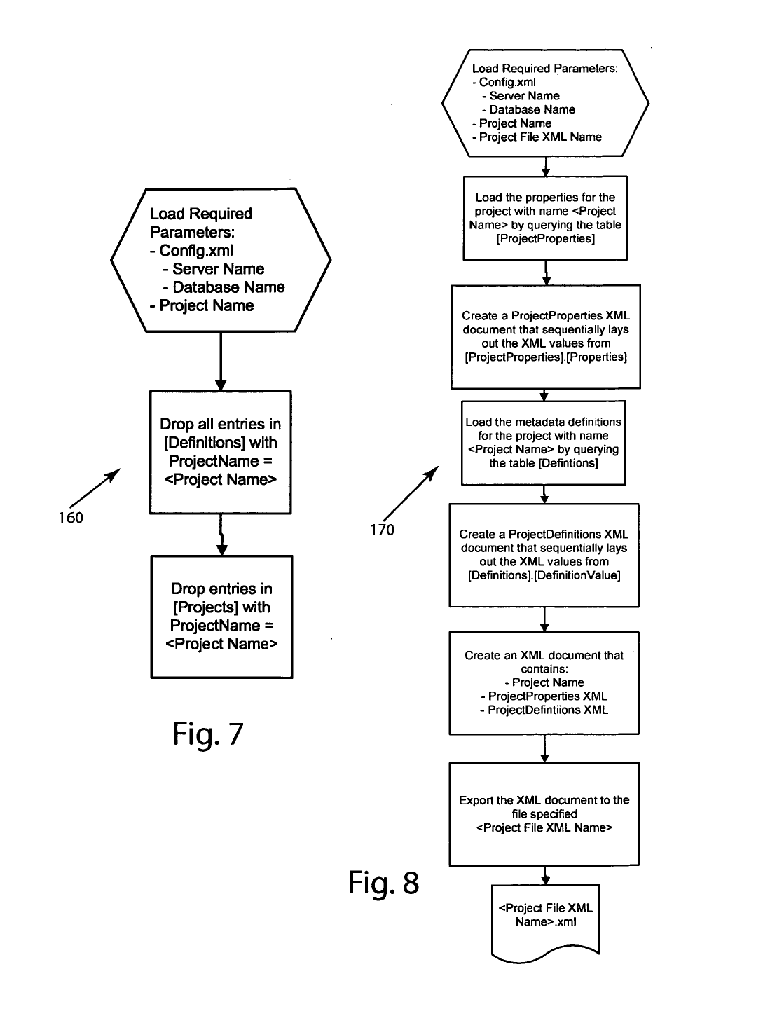

When the execution engine is called with the/drop-project switch a process 160 of FIG. 7 is executed. The execution engine component 116 is passed the “config.xml” file along with the <Project Name> value, the following steps are performed:
1. The execution engine connects to the metadata database and does the following:
   a. Drops all objects in the [Definitions] table associated with the project <Project Name>
   b. Drops the entry in [Projects] with the name <Project Name>

### Export Project Functionality

When driver.exe is called with the/export-project switch, a process 170 of FIG. 8 is executed. The execution engine component 116 is passed the “config.xml” file, along with the project name to be exported and a filename (and path) for the xml file to be generated, the following steps are executed:
1. The execution engine connects to the metadata database and does the following:
   a. Obtains a list of all of the Project Properties associated with the <Project Name> by querying the table [ProjectProperties] (FIG. 4).
   b. Creates an XML document that lays out the values of [ProjectProperties].[Properties] (XML) for the given <Project Name>
   c. Obtains the list of all metadata definitions associated with the <Project Name> by querying the table [Definitions]
   d. Creates an XML document that lays out the values of [Definitions].[Definition value] (XML) for the given <ProjectName>
2. A new XML document is generated containing:
   a. The <Project Name>
   b. The XML document summarizing the Project Properties (item 1.b above)
   c. The XML document summarizing the metadata definitions (item 1.d above)
3. The XML document generated in 2 is saved to the specified file.

### Import Project Functionality

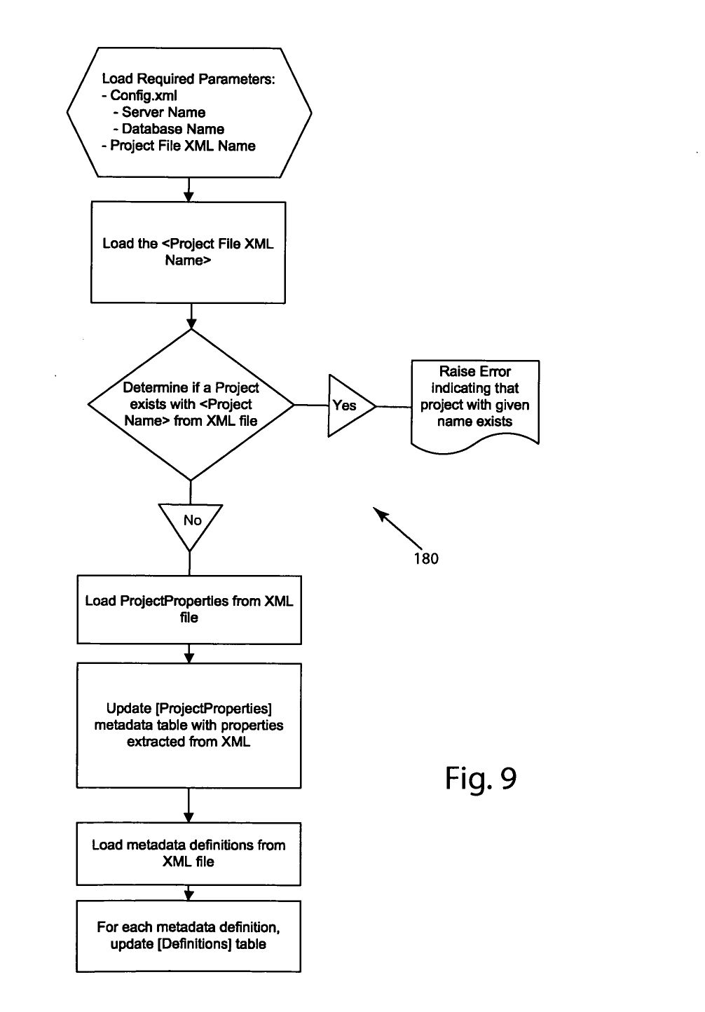

When driver.exe is called with the/import-project switch a process 180 of FIG. 9 is executed. The execution component 116 is passed the “config.xml” file, along with the filename (and path) for the xml file containing the project information, the following steps are executed:
1. The execution engine component loads the XML file into memory and extracts the <Project Name>.
2. The execution engine connects to the metadata database and queries the table [Projects] (FIG. 4) to determine whether or not a project with <Project Name> already exists.
   a. If a project already exists with <Project Name>, an error is raised and the import is not allowed to happen.
   b. If a project does not yet exist, then
      i. The Project Properties are extracted from the XML file
      ii. The Project Properties are added to the table [ProjectProperties] (FIG. 4) with the given <Project Name>
      iii. All of the metadata definitions are extracted from the XML file
      iv. The metatdata definitions are added to the table [Definitions] (FIG. 4) with the given <Project Name>

### Execute Pipeline Functionality

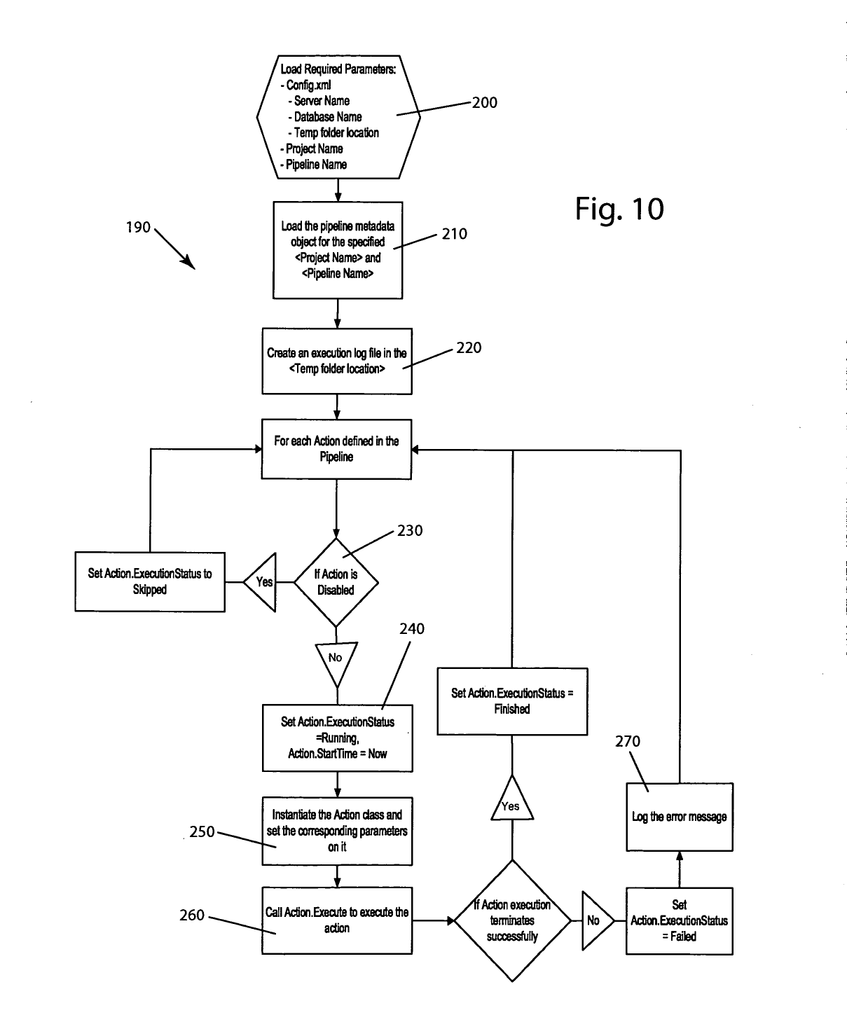

When driver.exe is called with the/execute-pipeline switch the process 190 of FIG. 10 is executed. The execution component 116 is passed 200 the “config.xml” file, along with the project name and pipeline name to be executed and the following process performed.
1. The driver (driver.exe) connects to the metadata datastore to load 210 the given Pipeline metadata object for the specified project. Recall that the Pipeline metadata object consists of a series of Action objects (see FIG. 3 ).
2. The execution engine creates 220 a log file in the temp folder location specified in config.xml
3. For each Action object:
   a. The process determines 230 if the action is disabled or not
      i. If it is disabled, it's ExecutionStatus is set to Skipped and control goes to the next action
      ii. If not,
         1. ExecutionStatus is set 240 to Running and the time that the execution is started is set to Now (the current time).
         2. The class corresponding to the given action is instantiated 250 with the various required other metadata parameters specified with the Action in the Pipeline object.
         3. Action.Execute is called 260 to execute the action
         4. If the action terminates successfully, its execution status is set to Finished and control goes onto the next action
         5. If the action terminates unsuccessfully, its execution status is set to Failed, the error message is caught and logged 270 to the log file.

### Execute Pending Functionality

When driver.exe is called with the/execute-pipeline switch, and is passed the “config.xml” file, along with the project name, the following processes are executed:
1. The project metadata table [PipelineInfo] (FIG. 4) is queried to obtain the names of all pipelines in the project that are in Pending status
2. Execute Pipeline is called for each pipeline that is pending (see Section Execute Pipeline Functionality above).

### Emulate Server Functionality

When driver.exe is called with the/emulate-server switch, and is passed the “config.xml” file, along with the project name and the number of seconds to wait, the following processes are executed:
1. Every <seconds to wait> seconds, execute-pending is called to execute any pending pipelines (see Section Execute Pending Functionality above).

### Pipeline Actions

Actions that have been designed and implemented and interfaced with the pipeline architecture of the system perform the specific tasks needed to successfully address various analysis and data mining problems. Actions will operate on various metadata objects (or the source objects such as tables or files that the metadata objects describe) and will often generate new metadata and source objects that can be consumed by further actions downstream in the pipeline.

No action requires knowledge of previous actions or subsequent actions since all “communication” between actions takes place via metadata in the metadata store.

This section describes a set of pipeline actions that have been implemented to assist in analysis projects.

### Execute Pipeline

One task that can be put into a Pipeline object is the ability to execute another Pipeline object.

### Task Parameters

The Execute Pipeline task requires the following parameters:
PipelineName (string): Name of the Pipeline object to be executed

### Task Execution

The Execute Pipeline task will load 210 the metadata associated with the specified PipelineName and execute it (see FIG. 10).

### Execute Command

The Execute Command task will execute a command-line argument with given parameters. This task is useful when automating command-line data manipulations.

### Task Parameters

The Execute Command task requires the specification of the following parameters:
Command (string): name of the command-line executable, batch file, etc. to be run
Arguments (string): any command-line arguments that should be passed to the executable, batch file, etc. that is to be run.

### Task Execution

This task is implemented utilizing the .NET library System.Diagnostics.Process

### Execute SQL

The Execute SQL task allows the automation of a specific SQL query to be executed over a specified server and database.

### Task Parameters

The Execute SQL task requires the specification of the following parameters:
Server (string): Name of the SQL-Server
Database (string): Name of the database over which the query should be executed
Statement (string): SQL query to be executed

### Task Execution

The task executes by making an OLE DB connection to the specified Server and Database, then the Statement is executing using the OleDbCommand object (contained in the .NET namespace System.Data.OleDb).

### Execute SQL Script

The Execute SQL Script task will execute the SQL statements in a file (typically suffixed with sql) over a specified SQL Server and database.

### Task Parameters

The Execute SQL Script task requires the specification of the following parameters:
Server (string): Name of the SQL-Server
Database (string): Name of the database over which the SQL script should be executed.
Filename (string): Full path to the SQL script file to be executed.

### Task Execution

The Execute SQL task is implemented by making a command line call to the command line executable “sqlcmd”, specifying the Server (via the —S flag), the database (via the —d flag) and the script (via the —i flag).

### Create Data Store

The Create Data Store task is used to create a relational database to hold source and aggregated data. The Data Store database is a separate repository from the Metadata database (which contains the storage schema for metadata objects) described in FIG. 4.

The Data Store typically contains source data for a project, aggregations executed over this source data, datasets prepared for modeling, predictions from data mining algorithms, etc.

### Task Parameters

The Create Data Store task requires the specification of the following parameters:
Server (string): SQL-Server that will host the Data Store relational database
Database (string): name of the Data Store relational database to be created

### Task Execution

The Create Data Store task is implemented by making an OLE DB connection to the given Server and executing a “create database . . . ” statement to generate the database with the given name. Then helper stored procedures are defined in the data store database.

### Backup Data Store

The Backup Data Store task will backup a given database to a specified backup file location. This task is useful so that regular database backups can be automated.

### Task Parameters

The Backup Data Store task requires the specification of the following parameters:
Server (string): SQL-Server containing the database to be backed up
Database (string): name of the database to be backed up
Filepath (string): full file-path to the backup file location where the backup file will be created.

### Task Execution

The Backup Data Store task is implemented by making an OLE DB connection to the given SQL Server and executing a “backup database . . . ” statement for the specified database, specifying the backup location Filepath.

### Compute Aggregation

The Compute Aggregation task executes the aggregation defined in the CaseAggregation metadata object (see Section CaseAggregation for details), over a given SQL Server and database, storing the result in the table specified.

### Task Parameters

The Compute Aggregation task requires the specification of the following parameters:
Server (string): SQL-Server over which the aggregation will be performed
Database (string): database name over which the aggregation will be performed
AggregationName (string): name of the CaseAggregation object the describes the aggregation to be performed.
TableName (string): name of the table in which the result of the aggregation will be stored.

After the Compute Aggregation task is executed, it generates a DataTable object describing the table that contains the aggregation result that can be used by other data analysis processes. See Section DataTable for more information on the DataTable metadata object.

### Task Execution

The Compute Aggregation task is implemented by constructing a SQL query from the information in the CaseAggregation metadata object and making an OLE DB connection to the specified SQL Server/database and executing the task. The resultset is then stored in a table in the same server/database and a DataTable metadata object is created representing the resultset table.

### Create Distribution Report

The Create Distribution Report task takes a DistributionReportSpec metadata object, along with other required parameters and computes the corresponding distribution report. The result of executing the Create Distribution Report task is that a DistributionReport metadata object is saved in the metadata store for the given project.

### Task Parameters

The Create Distribution Report requires the specification of the following parameters:
Server (string): SQL-Server containing the source information
Database (string): database containing the source tables
DistributionReportSpec (string): name of the DistributionReportSpec object that defines the Distribution Report to be generated. See Section DistributionReportSpec for details on this object).
DistributionReportName (string): name of the distribution report to be created
Replace (Boolean): replace the report?
RefreshCases (Boolean): flag indicating whether the CaseDataset cases should be refreshed (re-generated)
[Optional] BeginFrom: If the report has a temporal component, limit the beginning date for reporting.
[Optional] EndAt: If the report has a temporal component, limit the end date for reporting

After the Create Distribution Report task is executed, a DistributionReport object is generated and saved in metadata. See Section DistributionReport for details on this metadata object.

### Drop Distribution Report

The Drop Distribution Report task is used to remove a given DistributionReport object and the associated data tables needed to generate its values, etc.

### Task Parameters

The Drop Distribution Report task requires the specification of the following parameters:
Server (string): SQL-Server containing the source data for the distribution report charts, etc.
Database (string): SQL-Server database containing the source data for the distribution report charts, etc.
DistributionReport (string): Name of the DistributionReport object to be dropped.

### Task Execution

The Drop Distribution Report task loads the DistributionReport object with the given <DistributionReport> name. For each ChartDataTable contained with the DistributionReport object, the corresponding <TableName> table is dropped from the relational database (<Server>, <Database>). Then the DistributionReport metadata object is deleted.

### Drop DataTable

Similar to the Drop Distribution Report task, the Drop DataTable task drops the underlying relational database table summarized by the DataTable metadata object, then also deletes this object.

### Task Parameters

The Drop DataTable task requires the specification of the following parameters:
Server (string): SQL-Server containing the source data for the DataTable.
Database (string): SQL-Server database containing the source data for the DataTable.
DataTable (string): Name of the DataTable object to drop.

### Task Execution

The Drop DataTable task load the DataTable metadata object with the given <DataTable> name by querying the [Definitions] table (FIG. 4). Then an OLE DB connection is made to the specified SQL Server <Server> and <Database> and the relational table corresponding to the DataTable object is dropped by executing a “drop table . . . ” command. Then the DataTable metadata object itself is dropped.

### Create Affinity Report

The Create Affinity Report task is useful to determine pairwise correlation relationships between various attributes in a CaseDataSet. The pairwise correlation information is returned as a DistributionReport.

### Task Parameters

The Create Affinity Report task requires the specification of the following parameters:
Server Server (string): SQL-Server containing the source data
Database (string): SQL-Server database containing the source data
CaseDataSet (string): Name of the CaseDataSet metadata object to be used to determine the correlation information. Please see Section CaseDataSet for more information on this metadata object.
DistributionReportSpec (string): Name of the DistributionReportSpec metadata object for displaying the correlation information in report form. Please see Section DistributionReportSpec for more information on this metadata object.
ReportName (string): Name of the DistributionReport object to be created.
MinSupport (integer): Minimum number of cases that a given attribute value needs to have to be considered for correlation computation. Default is 5.
TempFolderPath (string): Path to a temporary folder for storing intermediate, temporary files.

When the Create Affinity Report task completes, it generates a DistributionReport object in the project metadata. See Section DistributionReport for more information about this metadata object.

### Task Execution

The Create Affinity Report task utilizes cosine-similarity between attribute values to determine their correlation with one another. After this is completed, the report is generated.

### Normalize Attributes

The Normalize Attributes task takes a case data set and determines buckets for the continuous-valued attributes, generates a report summarizing the discretization, and creates a new table containing discretized (normalized) versions of the attributes.

### Task Parameters

The Normalize Attributes task requires the specification of the following parameters:
Server (string): SQL-Server containing the source data for normalization, etc.
Database (string): SQL-Server database containing the source data for normalization, etc.
CaseDataSet (string): Name of the CaseDataSet metadata object to be used to determine attribute normalization. Please see Section CaseDataSet for more information on this metadata object.
DistributionReportSpec (string): Name of the DistributionReportSpec metadata object for displaying the normalization information in report form. Please see Section DistributionReportSpec for more information on this metadata object.
ReportName (string): Name of the DistributionReport object to be created.
NumBuckets (int): number of buckets to use for discretization (normalization). Default is 5.
TempFolderPath (string): Path to a temporary folder for storing intermediate, temporary files.

After the Normalize Attributes task has completed successfully, it generates a DistributionReport object and a DataTable in the project metadata. See Section DistributionReport for more information about this metadata object. See Section DataTable for more information on this metadata object. Note that the DataTable can be utilized then by further downstream pipeline tasks, etc.

### Make DataFormat From File

The Make DataFormat From File task scans a specified data file (e.g. comma-delimited data file) and extracts the DataFormat metadata object information. This is then used when importing the file into a relational database.

### Task Parameters

The Make DataFormat From File task requires the specification of the following parameters:
DataFormatName (string): Name of the DataFormat metadata object to be created by the task.
SourceDataFile (string): Full path to the source data file
RowTerminator (string): character representing new-row in the file
ColumnSeparator (string): character(s) separating column-values in the file
[Optional] TextQualifier (string): character indicating text value
MaxColumnSize (integer): maximum column width. Default =1000
Unicode (Boolean): flag indicating whether or not the file is Unicode
HasHeadRow (Boolean): flag indicating whether or not the 1^{st} row in the file indicates the column names
GuessType (Boolean): flag indicating that the task should attempt to guess the types of the column values

Note that when the Make DataFormat From File task has finished, it generates a DataFormat metadata object. See Section DataFormat for more information.

### Task Execution

The task is implemented by iterating over the file and deriving the DataFormat metadata object values.

### Import Data From File

The Import Data From File task utilizes the DataFormat information to create a table in a relational database containing the values from the data file.

### Task Parameters

The Import Data From File task requires the specification of the following parameters:
TargetServer (string): SQL-Server containing the database in which the file is to be imported.
TargetDatabase (string): Database in which the file is to be imported
TargetTableName (string): Name of the table that will hold the data imported from the file.
SourceDataFormat (string): Name of the DataFormat metadata object describing the columns in the source file. See DataFormat for more information.
SourceDataFile (string): Path to the source data file to be imported.
RowTerminator (string): character representing new-row in the file
ColumnSeparator (string): character(s) separating column-values in the file
[Optional] TextQualifier (string): character indicating text value
MaxColumnSize (integer): maximum column width. Default =1000
Unicode (Boolean): flag indicating whether or not the file is Unicode
HasHeadRow (Boolean): flag indicating whether or not the 1^{st} row in the file indicates the column names
AllowRaggedRows (Boolean): flag indicating that the task should allow rows that don't contain all of the columns
MaxInvalidRows (int): maximum number of invalid rows before raising an error
TempFolder (string): temporary folder
ImportMode: one of {Overwrite, Append}

After the Import Data From File task has executed, a DataTable metadata object is created describing the data that has just been imported and is available for use by other pipeline processes. See Section DataTable for a description of this metadata object.

### Task Execution

The Import Data From File task makes use of the BCP command to import data into a relational database table. The task automates the generation and execution of the specific BCP command.

### Make DataFormat From Table

Similar to Make DataFormat From File task, the Make DataFormat From Table task generates a DataFormat object by analyzing the column structure in a specified database table.

### Task Parameters

The Make DataFormat From Table task requires the specification of the following parameters:
DataFormatName (string): Name of the DataFormat metadata object to be created by the task.
SourceServer (string): Name of the SQL Server containing the database and table of interest.
SourceDatabase (string): Name of the database containing the table of interest
SourceTable (string): Name of the table of interest

Note that when the Make DataForm From Table task has finished, it generates a DataFormat metadata object. See Section DataFormat for more information.

### Task Execution

The task is implemented by making an OLE DB connection to the database and querying the specified table to populate the DataFormat metadata object, then saving that to the metadata store.

### Import Data From Table

The Import Data From Table task utilizes the DataFormat information to create a table in a relational database containing the data from the source table.

### Task Parameters

The Import Data From Table task requires the specification of the following parameters:
SourceDataFormat (string): Name of the DataFormat metadata object describing the table to be imported.
SourceServer (string): Name of the SQL Server containing the source database and table
SourceDatabase (string): Name of the database containing the source table
SourceTable (string): Name of the source table
TargetServer (string): Name of the SQL Server containing the database in which the data is to be imported
TargetDatabase (string): Name of the database in which the data is to be imported
TargetTableName (string): Name of the table in which the source data should be imported.
TempFolder (string): temporary folder
ImportMode: one of {Overwrite, Append}

After the Import Data From Table task has executed, a DataTable metadata object is created describing the data that has just been imported and is available for use by other pipeline processes. See Section DataTable for a description of this metadata object.

### Task Execution

The task is implemented by BCP-ing the data out to a temporary file and then BCP-ing it into the target database, generating the appropriate DataTable metadata object and saving it.

### Dump Query

The Dump Query action allows an analyst to automate the execution of a SQL query against a specific database and export the result to a file.

### Task Parameters

The Dump Query task requires the specification of the following parameters:
SourceServer (string): Name of the SQL-Server in which the query will be executed
SourceDatabase (string): Name of the database over which the query will be executed
SourceQuery (string): The query to be executed
OutputFilePath (string): Full path to the file to be created with the resultset from the query.

### Task Execution

The Dump Query task is implemented by connecting to the database of interest via OLE DB, executing the query via an OleDbCommand object, then writing the results to the specified file.

### Make Data Format From Access

The Make DataFormat From Access task scans a specified table within a Microsoft Access database and extracts the DataFormat metadata object information. This is then used when importing the contents of the Access table into a relational database.

### Task Parameters

The Make DataFormat From Access task requires the specification of the following parameters:
DataFormatName (string): Name of the DataFormat metadata object to be created by the task.
ConnectionString (string): OLE DB connection string allowing connection to the Access database.
TableName (string): Access table name to be imported into the SQL database
GuessTypes (Boolean): Flag indicating that an attempt should be made to determine the types of the table columns.

Note that when the Make DataForm From Access task has finished, it generates a DataFormat metadata object. See Section DataFormat for more information.

### Task Execution

The task is implemented by making an OLE DB connection to the Access database and scanning the specified table to populate the DataFormat metadata object values.

### Import Data From Access

The Import Data From Access task utilizes the DataFormat information to create a table in a relational database containing the values from the corresponding Access table.

### Task Parameters

The Import Data From Access task requires the specification of the following parameters:
SourceDataFormat (string): Name of the DataFormat metadata object describing the table to be imported.
ConnectionString (string): OLE DB connection string allowing connection to the Access database.
SourceTableName (string): Name of the source table
TargetServer (string): Name of the SQL Server containing the database in which the data is to be imported
TargetDatabase (string): Name of the database in which the data is to be imported
TargetTableName (string): Name of the table in which the source data should be imported.
ImportMode: one of {Overwrite, Append}

After the Import Data From Access task has executed, a DataTable metadata object is created describing the data that has just been imported and is available for use by other pipeline processes. See Section DataTable for a description of this metadata object.

### Task Execution

The task is implemented by making an OLE DB connection to the Access database and making an OLE DB connection to the target SQL Server database, then moving the data from Access to the resulting SQL table in a row-wise fashion.

### Make Data Format From Excel

The Make DataFormat From Excel task scans a specified tab within a Microsoft Excel file and extracts the DataFormat metadata object information. This is then used when importing the contents of the Excel tab into a relational database.

### Task Parameters

The Make DataFormat From Excel task requires the specification of the following parameters:
DataFormatName (string): Name of the DataFormat metadata object to be created by the task.
ConnectionString (string): OLE DB connection string allowing connection to the Excel file.
TableName (string): Excel tab name to be imported into the SQL database
GuessTypes (Boolean): Flag indicating that an attempt should be made to determine the types of the table columns.
HasHeaderRow (Boolean): Flag indicating whether the Excel sheet (tab) has a header-row with column-names

Note that when the Make DataForm From Excel task has finished, it generates a DataFormat metadata object. See Section DataFormat for more information.

### Task Execution

The task is implemented by making an OLE DB connection to the Excel file and scanning the specified table to populate the DataFormat metadata object values.

### Import Data From Excel

The Import Data From Excel task utilizes the DataFormat information to create a table in a relational database containing the values from the corresponding Excel sheet.

### Task Parameters

The Import Data From Excel task requires the specification of the following parameters:
SourceDataFormat (string): Name of the DataFormat metadata object describing the table to be imported.
ConnectionString (string): OLE DB connection string allowing connection to the Excel file.
SourceTableName (string): Name of the source sheet in the Excel file
TargetServer (string): Name of the SQL Server containing the database in which the data is to be imported
TargetDatabase (string): Name of the database in which the data is to be imported
TargetTableName (string): Name of the table in which the source data should be imported.
ImportMode: one of {Overwrite, Append}
HasHeaderRow (Boolean): Flag indicating whether the Excel sheet (tab) has a header-row with column-names

After the Import Data From Excel task has executed, a DataTable metadata object is created describing the data that has just been imported and is available for use by other pipeline processes. See Section DataTable for a description of this metadata object.

### Task Execution

The task is implemented by making an OLE DB connection to the Excel file and making an OLE DB connection to the target SQL Server database, then moving the data from Excel to the resulting SQL table in a row-wise fashion.

### Import Existing Table

The Import Existing Table task generates a DataTable object from an existing relational database table. The task saves this DataTable object in the metadata database.

### Task Parameters

The Import Existing Table task requires the specification of the following parameters
Server (string): SQL-Server containing the database and table of interest
Database (string): Database containing the table of interest.
Table (string): Table name of interest

After the Import Existing Table task has executed, a DataTable metadata object is created describing the data contained in the specified SQL table and is available for use by other pipeline processes. See Section DataTable for a description of this metadata object.

### Task Execution

The task is implemented by making an OLE DB connection to the specified SQL Server and database, then iterating over the table to collect the information needed to populate the DataTable metadata object values.

### Export Data To File

The Export Data To File task allows an analyst to export the data contained in a table to text file with specified delimiters, etc.

### Task Parameters

The Export Data To File task requires the specification of the following parameters:
SourceServer (string): SQL Server containing the source database and table to be exported.
SourceDatabase (string): Database containing the table to be exported
SoruceDataTable (string): Data table to be exported
TargetDataFile (string): Full path to the file to be created to hold the data
RowTerminator (string): Character specifying new-row in file
ColumnSeparator (string): Character(s) specifying new-column in file
[Optional] TextQualifier (string): Character indicating text-value field
Unicode (Boolean): flag indicating whether or not the file is Unicode
AddHeaderRow (Boolean): flag indicating whether or not a header row should be added to the output file with column names.

### Task Execution

The task executes by connecting to the specified SQL-Server and database and is exported to the specified file.

### Export Distribution Report

The Export Distribution Report task exports information described in the ChartDataTable metadata objects associated with a given DistributionReport object to a series to text files.

### Task Parameters

The Export Distribution Report task requires the specification of the following parameters:
SourceServer (string): SQL Server containing the data in the Distribution Report
SourceDatabase (string): Database containing the data in the Distribution Report
DistributionReport (string): Name of the DistributionReport object to be exported
OutputFolder (string): location where the text files will be generated
RowTerminator (string): Character specifying new-row in file
ColumnSeparator (string): Character(s) specifying new-column in file
[Optional] TextQualifier (string): Character indicating text-value field
Unicode (Boolean): flag indicating whether or not the file is Unicode
AddHeaderRow (Boolean): flag indicating whether or not a header row should be added to the output file with column names.

### Task Execution

The task is executed by making an OLE DB connection to the specified SQL Server database and exporting the data contained in the ChartDataTable objects to text files. The text files have the same name as the ChartDataTable. See Section ChartDataTable for more information on this metadata object.

### Build Predictive Model

The Build Predictive Model task is used to construct a predictive model by applying a statistical/machine learning algorithm to a given dataset. Depending upon the algorithm that is selected for model building, the Build Predictive Model task may utilize SQL Server 2005 Analysis Services to build the predictive model.

Note that the Build Predictive Model task requires that there be a predictable or output variable specified in the training dataset (e.g. a DMColumn with DMIsPredictable set to True, see Section DMColumn for details).

### Task Parameters

The Build Predictive Model task requires the specification of the following parameters:
Server (string): SQL-Server containing the source datasets for model building
Database (string): Database containing the source datasets for model building
DMDataset (string): Name of the DMDataset object describing how the various dataset columns should be modeled, etc. See Section DMDataset for a more detailed description of this metadata object. Note that that Build Predictive Model task requires that there be a predictable or output variable (column) specified in the DMDataset.
Algorithm (string): Name of the Algorithm object that specifies the data mining/statistical algorithm that will be applied to the datasets, along with the parameter values for that algorithm.
DMModelName (string): Name used when constructing the model
DMEnvironment (string): Name of the DMEnvironment object specifying the Analysis Server and Analysis Database to use for model building, etc. See Section DMEnvironment for a more detailed description of this metadata object.

After the Build Predictive Model task completes successfully, it generates a Model metadata object summarizing the data mining model that has been constructed. See Section Model for more details related to this metadata object.

### Task Execution

The Build Predictive Model task constructs the given model by applying the algorithm (with given parameter settings) specified in the Algorithm object to the dataset described by the DMDataset object.

If the algorithm is one of the SQL Server 2005 Analysis Services data mining algorithms, then the model is built on the given Analysis Server/Analysis Database specified in the DMEnvironment parameter. In this case, the model is built by interfacing with SQL Server 2005 Analysis Services using the ADOMD APIs.

### Get Predictions

The Get Predictions task is used to apply a given model to a dataset and obtain predicted values (or scores) from the model. This task allows the analyst to automate the process of regularly scoring new data, etc. with a given data mining model.

### Task Parameters

The Get Predictions task requires the specification of the following parameters
Server (string): SQL-Server containing the source datasets for model building
Database (string): Database containing the source datasets for model building
DMModelName (string): Name of the Model metadata object specifying the actual predictive model to use for generating the predictions. See Section Model for a more detailed description of this metadata object.
DMDataset (string): Name of the DMDataset object describing how the various dataset columns should be modeled over the scoring set, etc. See Section DMDataset for a more detailed description of this metadata object.
DMEnvironment (string): Name of the DMEnvironment object specifying the Analysis Server and Analysis Database to use for making predictions, etc. See Section DMEnvironment for a more detailed description of this metadata object.
DMPredictTable (string): Name of the table that will hold the predicted values for each case.
[Optional] IncludeTrueValueColumn: If the source data has actual values for the predicted variable, these will be included in the DMPredictTable if IncludeTrueValueColumn is True.
ReplaceNegativeWithZero (Boolean): If the predicted variable is continuous-valued, then, if ReplaceNegativeWithZero is true, any negative predicted value is set to zero. This is useful in cases when predicting a continuous-valued attribute that is known to never be negative (e.g. sales, etc.).

When the Get Predictions task has successfully completed, it generates a DataTable object describing the table containing the predictions. This DataTable object is saved in the metadata store.

### Task Execution

The task is implemented by obtaining predictions using the given model for each case in the DMDataset object. These predictions are then stored in the DMPredictTable by making an OLE DB connection to the specific database, creating the predict table and populating it.

Note that if the model was built using Analysis Services 2005, the predictions are obtained by connecting to the appropriate Analysis Server/Analysis Database via an OLE DB connection and executing the appropriate DMX prediction join. See http://msdn2.microsoft.com/en-us/library/ms132031.aspx for more information on the DMX prediction join.

### Build Cluster Model

The Build Cluster Model task is similar to the Build Predictive Model except that it requires that the statistical algorithm used to model the data be a clustering algorithm (e.g. MICROSOFT_CLUSTERING). Also, the dataset used for modeling is not required to have a predictable or output column.

Cluster models are typically applied to datasets to determine “natural” or data-driven groupings in the dataset, facilitating a high-level understanding of the source data.

### Task Parameters

The Build Cluster Model task requires the specification of the following parameters:
Server (string): SQL-Server containing the source datasets for model building
Database (string): Database containing the source datasets for model building
DMDataset (string): Name of the DMDataset object describing how the various dataset columns should be modeled, etc. See Section DMDataset for a more detailed description of this metadata object.
Algorithm (string): Name of the Algorithm object that specifies the data mining/statistical algorithm that will be applied to the datasets, along with the parameter values for that algorithm. Note that the algorithm is required to be a clustering algorithm.
DMModelName (string): Name used when constructing the model
DMEnvironment (string): Name of the DMEnvironment object specifying the Analysis Server and Analysis Database to use for model building, etc. See Section DMEnvironment for a more detailed description of this metadata object.

After the Build Cluster Model task completes successfully, it generates a Model metadata object summarizing the data mining model that has been constructed. See Section Model for more details related to this metadata object.

### Task Execution

The Build Cluster Model task constructs the given model by applying the algorithm (with given parameter settings) specified in the Algorithm object to the dataset described by the DMDataset object.

If the algorithm is one of the SQL Server 2005 Analysis Services data mining algorithms, then the model is built on the given Analysis Server/Analysis Database specified in the DMEnvironment parameter. In this case, the model is built by interfacing with SQL Server 2005 Analysis Services using the ADOMD APIs.

### Get Cluster Labels

The Get Cluster Labels task is used to apply a given cluster model to a dataset to assign each case in the dataset to the cluster in which it most likely belongs. This task allows the analyst to automate the process of assigning new cases to clusters.

### Task Parameters

The Get Cluster Labels task requires the specification of the following parameters
Server (string): SQL-Server containing the source datasets for model building
Database (string): Database containing the source datasets for model building
DMModelName (string): Name of the Model metadata object specifying the actual cluster model to use for generating the predictions. See Section Model for a more detailed description of this metadata object.
DMDataset (string): Name of the DMDataset object describing how the various dataset columns should be modeled, etc. See Section DMDataset for a more detailed description of this metadata object.
DMEnvironment (string): Name of the DMEnvironment object specifying the Analysis Server and Analysis Database to use for making predictions, etc. See Section DMEnvironment for a more detailed description of this metadata object.
DMClusterTable (string): Name of the table that will hold the cluster label values for each case.

When the Get Cluster Labels task has successfully completed, it generates a DataTable object describing the table containing the labels. This DataTable object is saved in the metadata store.

### Task Execution

The task is implemented by obtaining cluster label assignments using the given model for each case in the DMDataset object. These cluster labels are then stored in the DMClusterTable by making an OLE DB connection to the specific database, creating the predict table and populating it.

Note that if the model was built using Analysis Services 2005, the cluster labels are obtained by connecting to the appropriate Analysis Server/Analysis Database via an OLE DB connection and executing the appropriate DMX prediction join.

### Evaluate Model Cross-Validation

The Evaluate Model Cross-Validation task is designed to estimate the predictive performance of a model built using a given statistical algorithm (with given parameter settings) that is applied to a specified dataset. The approach is based upon the methods described in:

M. Stone. Cross-validatory choice and assessment of statistical predictions. Journal of the Royal Statistical Society, 36:111-147, 1974.

In this approach, the analyst specifies a number of folds to be executed. For each fold, 1/(total number of folds) proportion of the dataset is set aside as a test set. The remaining dataset cases are used to estimate the predictive model by applying the given algorithm and parameters to the given training set. Then the resulting model is applied to the test set. Accuracy and other performance metrics (typically aggregates between the difference of the predicted values and actual values) are estimated.

These metrics are then averaged over each fold. These average performance metrics are an estimate of how well a model built with the given algorithm and parameters would perform when applied to similar, unseen data.

### Task Parameters

The Evaluate Model Cross-Validation task requires the specification of the following parameters:
Server (string): SQL-Server containing the source datasets for evaluation
Database (string): Database containing the source datasets for evaluation
DMDataset (string): Name of the DMDataset object describing how the various dataset columns should be modeled, etc. See Section DMDataset for a more detailed description of this metadata object.
Algorithm (string): Name of the Algorithm object that specifies the data mining/statistical algorithm that will be applied to the datasets, along with the parameter values for that algorithm.
DMModelName (string): Name used when constructing models during evaluation
DMEnvironment (string): Name of the DMEnvironment object specifying the Analysis Server and Analysis Database to use for model building, etc. See Section DMEnvironment for a more detailed description of this metadata object.
DMNumberOfFolds (int): Number of folds to use for the evaluation
[Optional] PredictionTable (string): Name of table to use to store predicted and actual values, along with probability of the predicted value.
[Optional] PredictionIdentifier (string): Since results of multiple case-level predictions can be saved to the same PredictionTable, an identifier is provided to separate out those from different runs.
ReplaceNegativeWithZero (Boolean): If the predicted variable is continuous-valued, then, if ReplaceNegativeWithZero is true, any negative predicted value is set to zero. This is useful in cases when predicting a continuous-valued attribute that is known to never be negative (e.g. sales, etc.).

When the Evaluate Model Cross-Validation task has terminated, a metadata object is saved that summarizes the performance as calculated during the evaluation:
If the predicted variable is discrete-valued, then a DiscreteModelEvaluation object is saved to the metadata store. See Section DiscreteModelEvaluation for details on this object.
If the predicted variable is continuous-valued, then a ContinuousModelEvaluation object is saved to the metadata store. See Section ContinuousModelEvaluation for more details on this metadata object.

### Task Execution

For each fold of cross-validation, the task implements the sampling needed to create the training and testing sets (sampling over the case table (SQL-Server Analysis Services case-table notion) and internally DMDataset objects are created—one for the training set and one for the testing set.

Then, a model is built over the training set (with algorithm and parameters specified by the Algorithm object) (see Section Build Predictive Model for details). Then, predictions are generated using the information in the testing DMDataset object to obtain predicted and actual values over the testing set. The performance metrics in the DiscreteModelEvaluation or ContinuousModelEvaluation object are then computed. Performance metrics are also computed in the same way over the training DMDataset to determine training effectiveness.

Note that if the algorithm used for evaluation is one from SQL Server 2005 Analysis Services, then model building is done using the ADOMD interface to these objects and predictions are obtained by connecting to the appropriate Analysis Server via an OLE DB connection and executing the appropriate DMX prediction join.

### Evaluate Model Single Training/Testing Sets

The Evaluate Model Single Training/Testing Sets task is similar to the Evaluate Model Cross-Validation task, except that instead of sampling multiple training and testing sets from a given dataset, the analyst specifies one dataset for training and one for testing. All performance metrics are then estimated over the single testing set, after the model has been built over the training set.

### Task Parameters

The Evaluate Model Single Training/Testing Sets task requires the specification of the following parameters:
Server (string): SQL-Server containing the source datasets for evaluation
Database (string): Database containing the source datasets for evaluation
DMDatasetTrain (string): Name of the training DMDataset object describing how the various dataset columns should be modeled, etc. See Section DMDataset for a more detailed description of this metadata object.
DMDatasetTest (string): Name of the testing DMDataset object describing how the various dataset columns should be modeled, etc. See Section DMDataset for a more detailed description of this metadata object.
Algorithm (string): Name of the Algorithm object that specifies the data mining/statistical algorithm that will be applied to the datasets, along with the parameter values for that algorithm.
DMModelName (string): Name used when constructing models during evaluation
DMEnvironment (string): Name of the DMEnvironment object specifying the Analysis Server and Analysis Database to use for model building, etc. See Section DMEnvironment for a more detailed description of this metadata object.
DMNumberOfFolds (int): Number of folds to use for the evaluation
[Optional] PredictionTable (string): Name of table to use to store predicted and actual values, along with probability of the predicted value.
[Optional] PredictionIdentifier (string): Since results of multiple case-level predictions can be saved to the same PredictionTable, an identifier is provided to separate out those from different runs.

When the Evaluate Model Single Training/Testing Sets has terminated, a metadata object is saved that summarizes the performance as calculated during the evaluation:
If the predicted variable is discrete-valued, then a DiscreteModelEvaluation object is saved to the metadata store. See Section DiscreteModelEvaluation for details on this object.
If the predicted variable is continuous-valued, then a ContinuousModelEvaluation object is saved to the metadata store. See Section ContinuousModelEvaluation for more details on this metadata object.

### Task Execution

A model is built over the training set (with algorithm and parameters specified by the Algorithm object) (see Section Build Predictive Model for details). Then, predictions are generated using the information in the testing DMDataset object to obtain predicted and actual values over the testing set. The performance metrics in the DiscreteModelEvaluation or ContinuousModelEvaluation object are then computed. Performance metrics are also computed in the same way over the training DMDataset to determine training effectiveness.

Note that if the algorithm used for evaluation is one from SQL Server 2005 Analysis Services, then model building is done using the ADOMD interface to these objects and predictions are obtained by connecting to the appropriate Analysis Server via an OLE DB connection and executing the appropriate DMX prediction join.

### Import Model Content

The Import Model Content task allows the analyst to export SQL Server 2005 Mining Model content from a given Analysis Server/Analysis database and store it in a relational database table for querying. The ability to query this content via SQL is very useful to determine the patterns and trends that are extracted.

### Task Parameters

The Import Model Content task requires the specification of the following parameters:
TargetServer (string): Target SQL-Server to hold the table containing the mining model content.
TargetDatabase (string): Target database to hold the table containing the mining model content.
DMModelName (string): Name of the data mining model for which the content should be extracted.
SourceDMEnvironment (string): Name of the DMEnvironment object specifying the Analysis Server/Analysis Database containing the mining model of interest. See Section DMEnvironment for more information on this metadata object.
ModelContentTableName (string): Name of the table to create in the relational database that contains the mining model content.

### Task Execution

This task is implemented by making an OLE DB connection to the given Analysis Server/Analysis database containing the mining model of interest. The DMX query is then executed against the Analysis Server: “select flattened * from [<DMModelName>].Content”. Another OLE DB connection is made to the target relational SQL Server and database and the results are populated into the table <ModelContentTableName>.

### Execute DMX Query

Similar to the Import Model Content task, the Execute DMX Query task allows the analyst to execute an arbitrary DMX query against a specified SQL Server 2005 Analysis Server and the results then stored in a specified relational database table. The ability to further query these results via SQL is beneficial to the analyst in a number of instances.

### Task Parameters

The Execute DMX Query task requires the specification of the following parameters:
TargetServer (string): Target SQL-Server to hold the table containing the mining model content.
TargetDatabase (string): Target database to hold the table containing the mining model content.
SourceDMEnvironment (string): Name of the DMEnvironment object specifying the Analysis Server/Analysis Database of interest. See Section DMEnvironment for more information on this metadata object.
TargetTableName (string): Name of the table to create in the relational database that contains the result of the DMX query.
DMXStatement (string): The DMX query to be executed.

### Task Execution

This task is implemented by making an OLE DB connection to the given Analysis Server/Analysis database containing the mining model of interest. The DMX query is then executed against the Analysis Server. Another OLE DB connection is made to the target relational SQL Server and database and the results are populated into the table <TargetTableName>.

### Analyst User Interface

The Analyst User Interface allows the analyst end-user to interact with the metadata datastore (see Section System Metadata Storage). And, by defining pipelines and setting their ExecutionStatus to Pending, the pipelines can then be executed by the Execution Engine (driver.exe). Depending upon the tasks executed by pipelines, the Analyst User Interface allows the end-user to inspect the metadata objects that are created by a task.

Also, the Analyst User Interface allows the end-user to determine pipeline processing information by interfacing with the metadata tables [PipelineInfo] and [ExecutionLog] (see FIG. 4 ).

This section provides an overview 300 of the system Analyst User Interface.

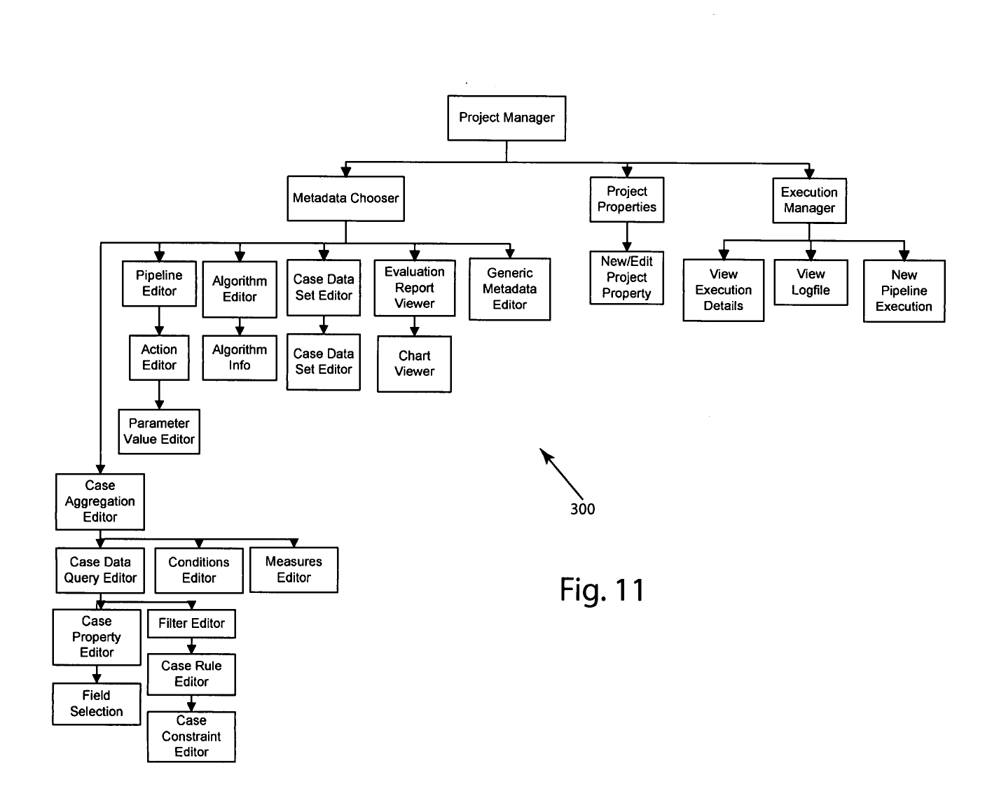

FIG. 11 provides an overview of flow of movement from one form to another in the Analyst UI.

These forms are described in the sub-sections below.

Note that when the Analyst User Interface is executed, it is passed the same “config.xml” file that is utilized by the Execution Engine (see Section Config.xml for details on the contents of this file). “config.xml” allows the Analyst User Interface code to connect to the metadata datastore so that metadata items can be accessed, created, and manipulated by the Analyst UI.

### Project Manager

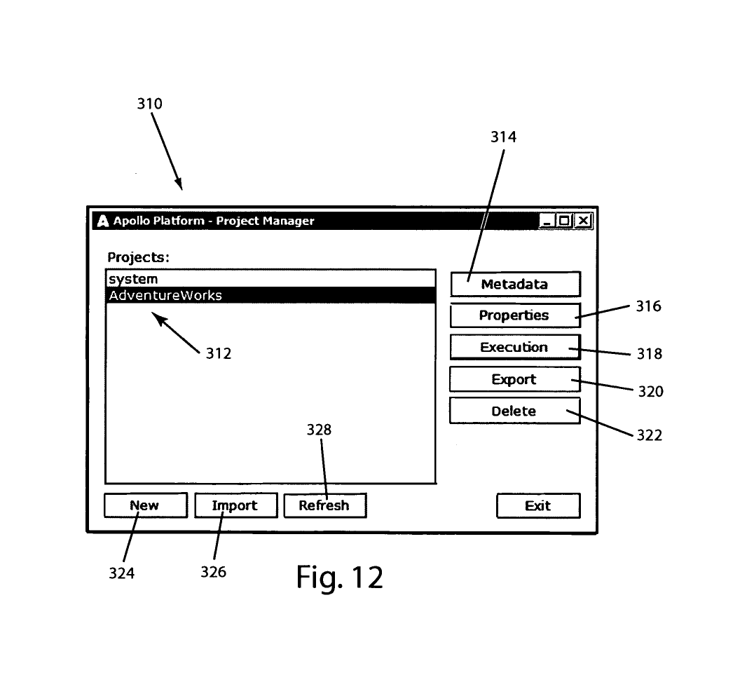

When the Analyst UI is executed, the first form shown to the end-user is the “Project Manager” 310 (see FIG. 12 ).

This form allows the end-user analyst to:
Select the Project that they wish to work on from the list 312 of available projects. This is done by clicking on the name of the project of interest in the text-box underneath “Projects:” in FIG. 12)
Access, create, and edit all metadata objects associated with the selected project. This includes creating and editing pipelines. This is done by clicking on the “Metadata” button 314 shown in FIG. 12.
Access, create, and edit Project Properties associated with the given project (see Section Project Properties for more information). This is done by clicking on the “Properties” button 316 in FIG. 12.
Check the status of pipelines execution. This is done by clicking on the “Execution” button 318 in FIG. 12.
Export all properties and metadata to an XML file (see Section FIG. 12 for details on this operation). This is done by clicking on the “Export” button 320 in FIG. 12 and providing the path to the XML file location desired.
Delete the selected project (see Section Drop Project Functionality for more details). This is done by clicking on the “Delete” button 322 in FIG. 12.
Create a new project (see Section FIG. 12 for details on this operation). This is done by clicking on the “New” button 324 in FIG. 12.
Import a project from a project XML file (see Section FIG. 12 for more details). This is done by clicking on the “Import” button 326 in FIG. 12.
Refresh the list of available projects. This is done by clicking on the “Refresh” button 328 in FIG. 12. “Refresh” causes the Analyst UI to query the metadata table [Projects] (see FIG. 4) for the list of available projects.

### Metadata Chooser

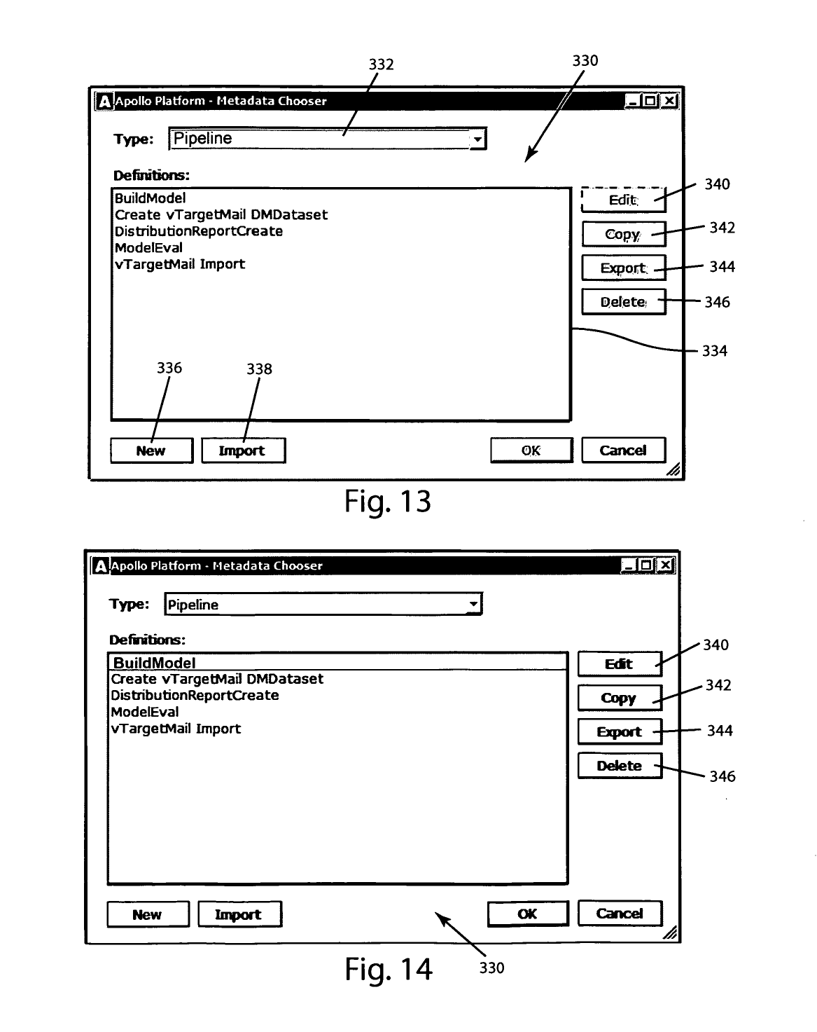

By clicking on the “Metadata” button 314 in the Project Manager form (FIG. 12), the Metadata Chooser form 330 is launched, allowing the end-user to access, inspect, edit, and create system metadata objects. See FIG. 13 for an example.

After making a selection of the metadata type of interest in a “Type:” drop-down box 332, the Metadata Choose form displays the names of the metadata definitions of the selected type in a “Definitions:” text-box 334.

The analyst can then:
Create a new metadata object of the given type by clicking on the “New” button 336 in FIG. 13, which will launch a form that may be specifically tailored to aiding in creating metadata objects of the given type.
Import a metadata object of the given type by clicking on the “Import” button 338 in FIG. 13. The analyst will then be asked to specify the location of the appropriate XML file describing the metadata of the given type to load.
After selecting one of the existing entries in the “Definitions:” text-box (assuming that there are entries), the following buttons are made available to the end-user: Edit, Copy, Export, Delete. This allows the end-user to:
   Edit the selected metadata item by clicking the “Edit” button 340 in FIG. 14. This will launch a form that may be specifically tailored to aiding in editing metadata objects of the given type.
   Copy the selected metadata object by clicking the “Copy” button 342 in FIG. 14.
   Export the selected metadata object to an XML file by clicking the “Export” button 344 in FIG. 14 and specifying an XML file to be generated.
   Delete the selected metadata object by clicking the “Delete” button 346 in FIG. 14.

Values available in the “Type:” dropdown include:
Algorithm
CaseAggregation
CaseDataQuery
CaseDataSet
ChartProfile
ContinuousModelEvaluation
DataFormat
DataMiningView
DataTable
DiscreteModelEvaluation
DistributionReport
DistributionReportSpec
DMDataset
DMEnvironment
EvaluationReport
Model
Pipeline

Specific “Editor” forms have either been developed or a “Generic Metadata Editor” form is used. The following sub-sections describe these forms in more detail.

### Pipeline Editor

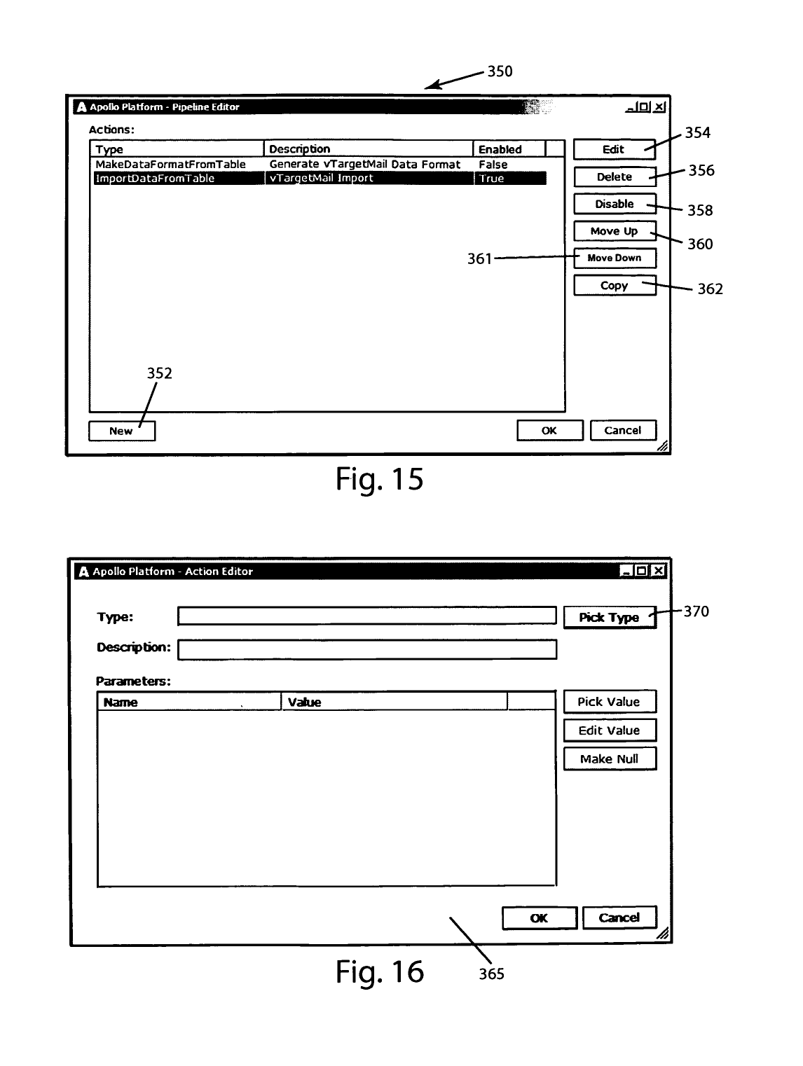

The Pipeline Editor 350 allows the analyst to define, add, and edit the Actions that make up a selected pipeline. See FIG. 15 .

The Pipeline Editor Form allows the end-user analyst to do the following:
Create a new Action to be added to the Pipeline. This is done by clicking the “New” button 352 in FIG. 15. This launches the “Action Editor” form described below in Section Action Editor.
After selecting an existing Action in the Pipeline (if there are any), the end-user can:
   Edit the Action. This is done by clicking on the “Edit” button 354 in FIG. 15. This launches the “Action Editor” from described below in Section Action Editor.
   Delete the Action from the Pipeline. This is done by clicking on the “Delete” button 356 in FIG. 15.
   Disable the Action in the Pipeline. This is done by clicking on the “Disable” button 358 in FIG. 15. Note that this changes the value in the “Enabled” column to False and indicates that the particular action will not be executed when the pipeline is executed (see FIG. 10).
   Move the Action up in the pipeline so that it is executed prior to other Actions. This is accomplished by clicking on the “Move Up” button 360 in FIG. 15.
   Move the Action down in the pipeline so that it is executed after other Actions. This is accomplished by clicking on the “Move Down” button 361 in FIG. 15.
   Copy the selected Action. This is done by clicking on the “Copy” button 362 in FIG. 15.

### Action Editor

The Action Editor 365 allows the end-user to define a specific action and the parameters required to execute the Action.

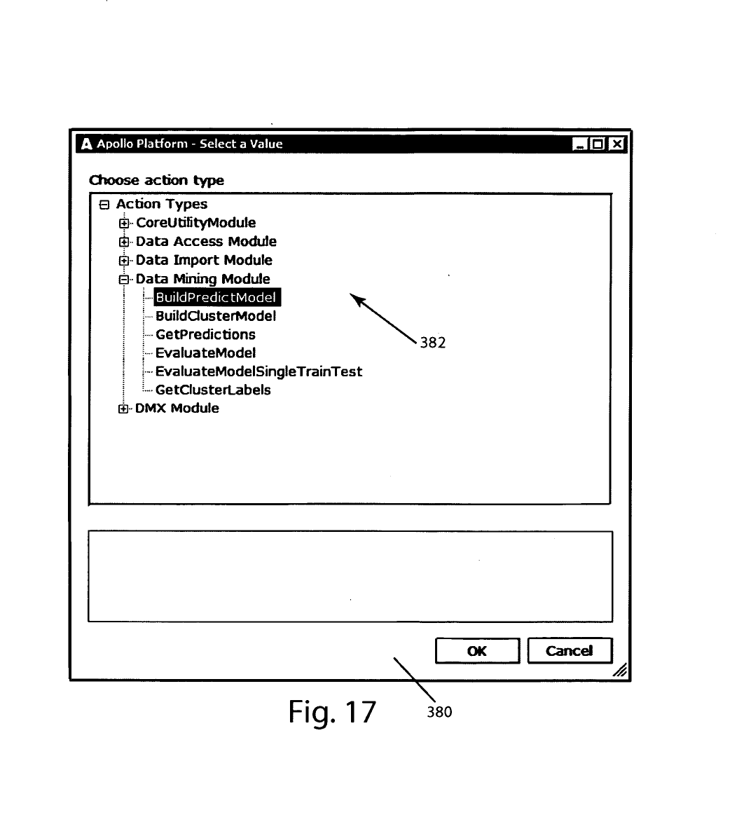

When the Action Editor is launched to create a new Action, the user is first required to choose the Action type that they wish to create (see FIG. 16). Clicking on the “Pick Type” button 370 launches the window 380 in FIG. 17.

Action types are logically grouped into a tree-view 382 of multiple action types:
Action Types
   Core Utility Module
      Execute Pipeline
      Execute Command
      Execute SQL
      Execute SQL Script
      Create Data Store
      Backup Data Store
   Data Access Module
      Compute Aggregation
      Create DMDataset
      Create Distribution Report
      Drop Distribution Report
      Drop DataTable
      Create Affinity Report
      Normalize Attributes
   Data Import Module
      Make DataFormat From File
      Import Data From File
      Make Data Format From Table
      Dump Query
      Import Data From Table
      Make DataFormat From Access
      Make DataFormat From Excel
      Import Data From Access
      Import Data From Excel
      Import Existing Table
      Export Data To File
      Export Distribution Report
      Sparse To Dense Transform
   Data Mining Module
      Build Predict Model
      Build Cluster Model
      Get Predictions
      Evaluate Model (Cross-Validation)
      Evaluate Model Single Train Test
      Get Cluster Labels
   DMX Module
      Import Model Content
      Execute DMX Query
      Get Node Sets

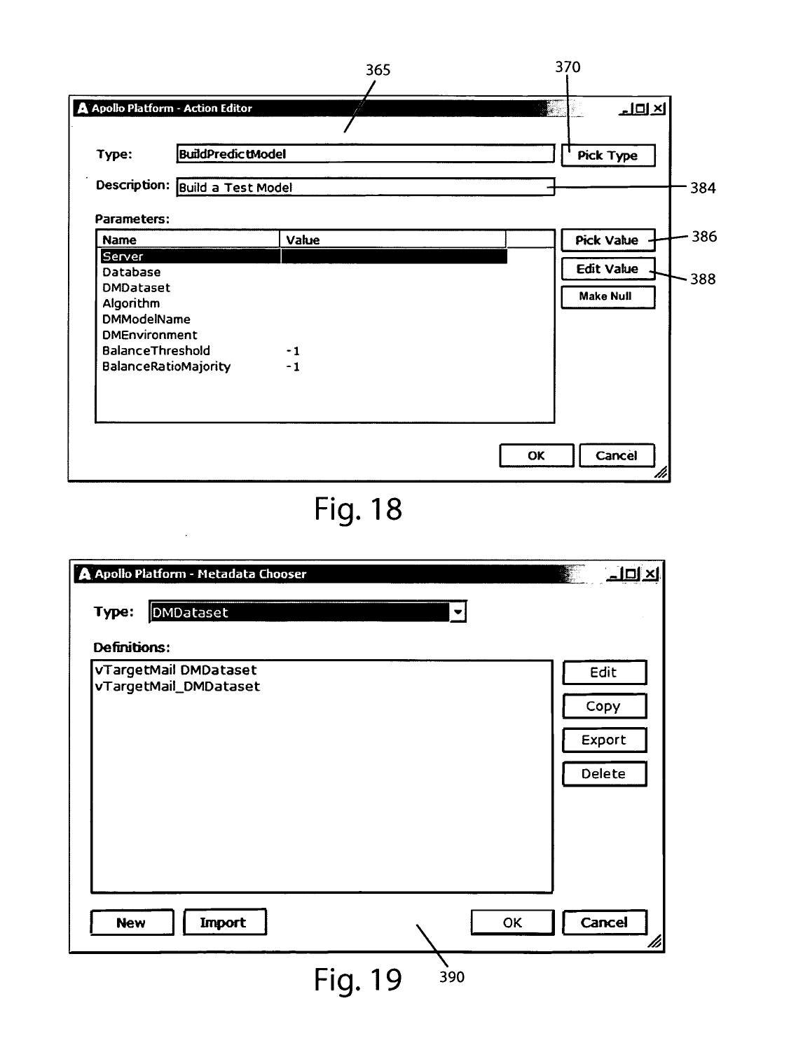

After choosing the Action to be created from the tree view 382, the user is returned to the Action Editor allowing the user to provide a description along with the required parameters that need to be specified. See FIG. 18.

The user can type a description for the action in the “Description:” text-box 384.

The user then selects one of the parameters and can pick a value (useful when the parameter value is the name of another metadata object or a project property) by clicking a “Pick Value” button 386.

If the parameter value references a metadata object, the end-user is shown a window 390 that lists appropriate metadata objects that could be used as the parameter value. An example of choosing the DMDataset parameter is shown in FIG. 19. The user can then either select the metadata object of interest or create a new one, etc.

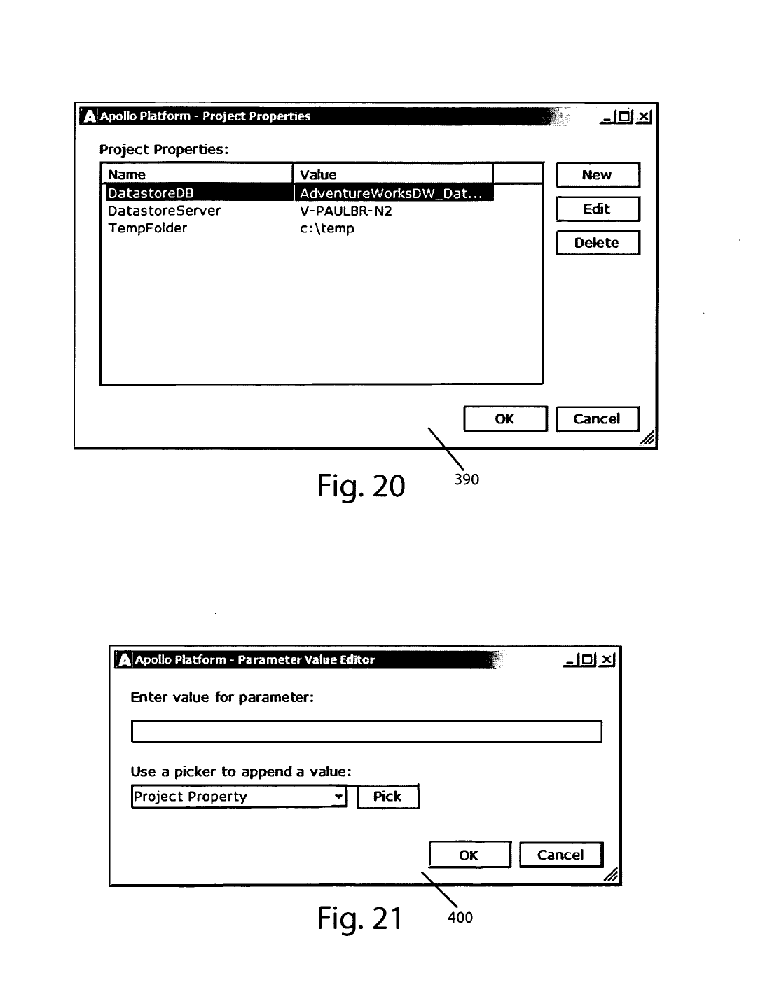

If the parameter value does not reference a metadata object, the end user can pick a value by clicking the “Pick Value” button 386 in FIG. 18, from a defined Project Properties window 390 (see FIG. 20). Or the end-user can edit the value directly by clicking the “Edit Value” button 388 in FIG. 18, which launches a Parameter Value Editor window 400 of FIG. 21. The Parameter Value Editor Form allows the end-user to directly type in the value in the “Enter value for parameter:” text-box 402, or to select a value from Project Properties (FIG. 20).

### Algorithm Editor

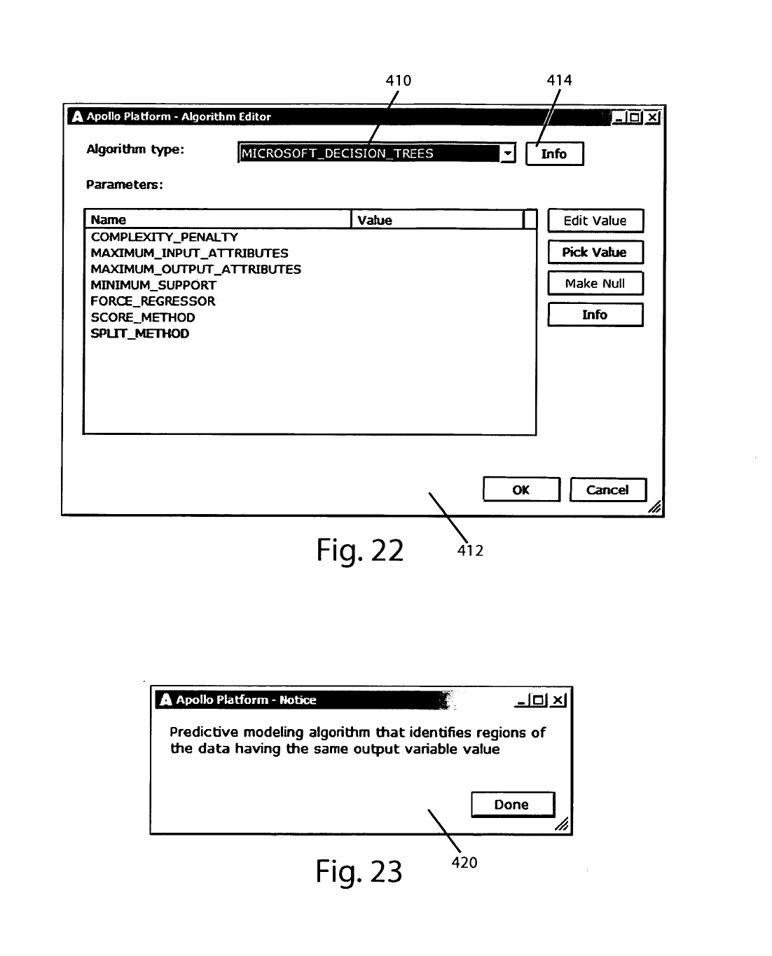

The Algorithm Editor allows the end-user to create or edit Algorithm metadata objects. When defining an Algorithm object, the end-user first chooses the algorithm type from a drop-down list 410 of a window 412 shown in FIG. 22. Values include:
MICROSOFT_ASSOCIATION_RULES
MICROSOFT_CLUSTERING
MICROSOFT_DECISION_TREES
MICROSOFT_NAIVE_BAYES
MICROSOFT_NEURAL_NETWORK

After a selection is made, the end-user can click on an “Info” button 414 of FIG. 22 to get a brief description of the algorithm. An illustrative window 420 is shown in FIG. 23. After the “Algorithm type:” selection is made, the grid-view is populated with the specific algorithm parameters required for the algorithm selection. The end-user provides a value for the algorithm parameter by selecting it and either clicking “Edit Value” and providing a value or clicking “Pick Value” and choosing a value (see FIG. 22).

### CaseAggregation Editor

A CaseAggregation Editor 430 allows the end user to define a CaseAggregation metadata object (see Section CaseAggregation for more details on this metadata object). See FIG. 24. The CaseAggregation Editor allows the user to select the CaseDataSet value from those already defined in the metadata datastore (via a “CaseDataSet:” dropdown 432 in FIG. 24). The list of CaseDataQueries can be created, removed or edited by clicking on the buttons “Add” 434, “Delete” 436 or “Edit” 438 in FIG. 24. The list of Conditions can be created, removed or edited by clicking on the buttons “Add” 433, “Delete” 431 or “Edit” 435 in FIG. 24. Similarly, the list of Measures can be created, removed or edited by clicking on the buttons “Add” 437, “Delete” 438 or “Edit” 439 in FIG. 24.

### Case Data Query Editor

Clicking the “Add” or “Edit” button next to “CaseDataQueries” in the CaseAggregation Editor (FIG. 24), launches the Case Data Query Editor 440 (see FIG. 25).

The Case Data Query Editor allows the end-user to specify the name of the query and to construct the list of CaseProperties and to also edit any filters associated with the query that may limit the cases included in the overall aggregation.

The list of CaseProperties is managed by clicking on the “Add”, “Delete” or “Edit”buttons 442, 444, 446 underneath the “CaseProperties” text-box in FIG. 25.

The filter is constructed or managed by clicking the button 448 “Edit Filter” in FIG. 25.

### Case Property Editor

By clicking the “Add” 442 or “Edit” 446 buttons underneath the CaseProperties textbox in FIG. 25, launches a Case Property Editor 450 (see FIG. 26).

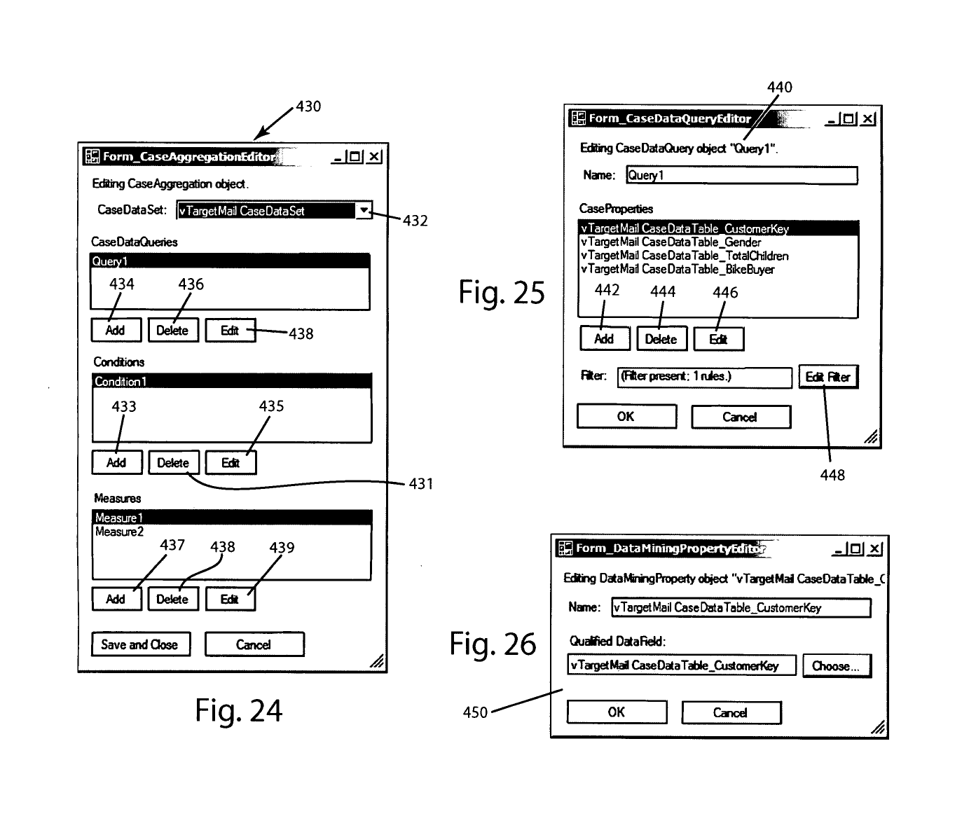

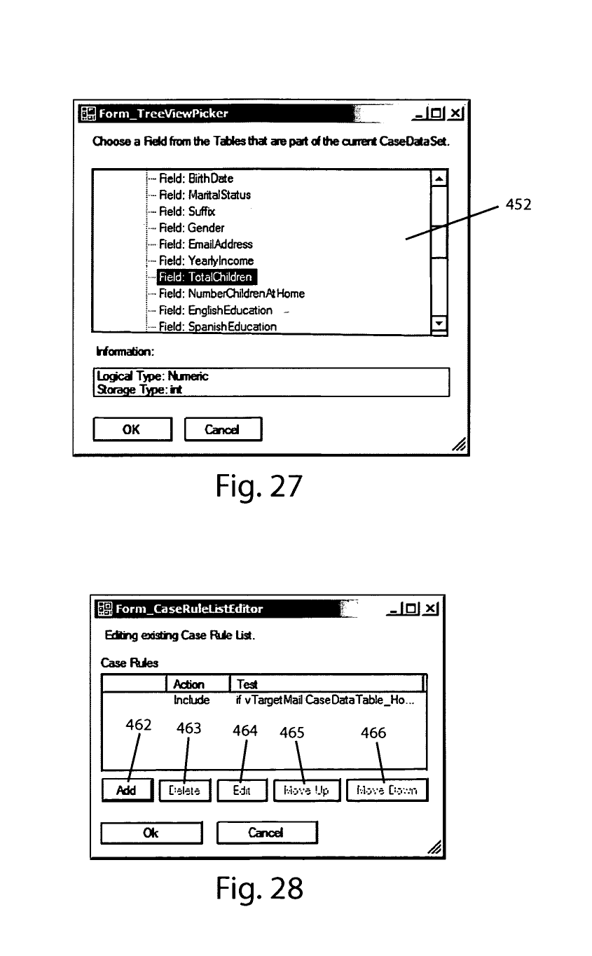

Clicking the “Choose . . . ” button in FIG. 25, shows a tree-view 452 allowing the end-user to select the appropriate data fields. See FIG. 27.

### Filter Editor

By clicking the “Edit Filter” button 448 in FIG. 25, a Filter Editor 460 is launched (see FIG. 28). This editor allows the end-user to construct a rule list to define which cases are to be used in the aggregation.

The Filter Editor allows the end-user to create and manage the rule-list and to change the order in which the rules are applied by using the buttons “Add”, “Delete”, “Edit”, “Move Up”, and “Move Down” 462-466 in FIG. 28.

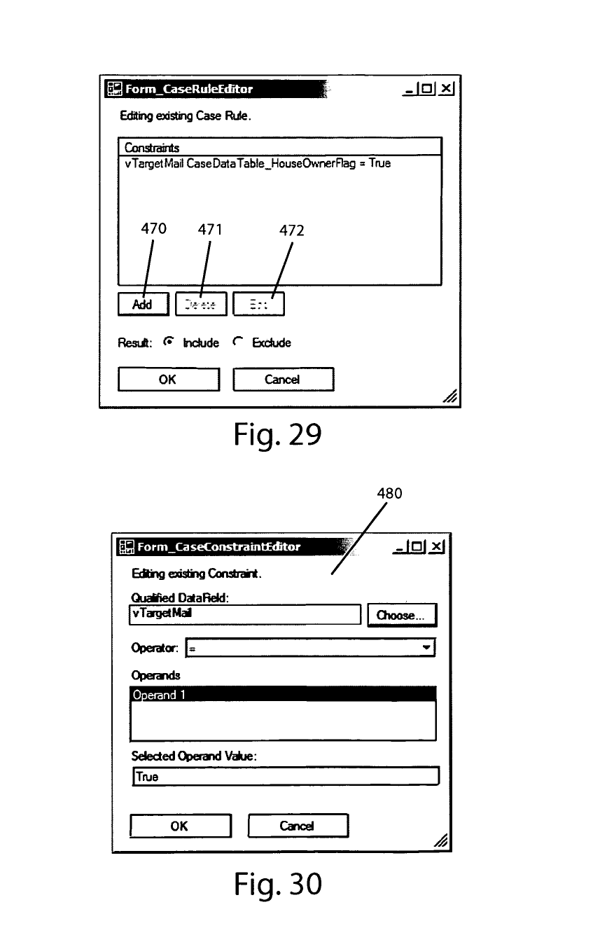

By clicking “Add” 462 or by highlighting a rule and clicking “Edit” 464, the Case Rule Editor is launched (see Section Case Rule Editor below and FIG. 29).

### Case Rule Editor

Each Rule is made up of the conjunction (“and”) of a number of Constraints (see FIG. 29). The list of constraints associated with a rule are managed by the “Add”, “Delete” and “Edit” buttons 470-472 in FIG. 29.

Clicking either the “Add” 470 or “Edit” 472 buttons launches the Case Constraint Editor (see Section Case Constraint Editor below and FIG. 30).

The Case Rule Editor (FIG. 29) also allows the end-user to specify whether the rule indicated membership in the aggregation (by selecting “Include” next to “Result:” in FIG. 29) or exclusion from the aggregation (by selecting “Exclude” next to “Result:” in FIG. 29).

### Case Constraint Editor

The Case Constraint Editor 480 (see FIG. 30) allows the end-user to specify the data field to be used in the constraint, the operator and the selected operand value, thus defining the constraint.

### Conditions Editor

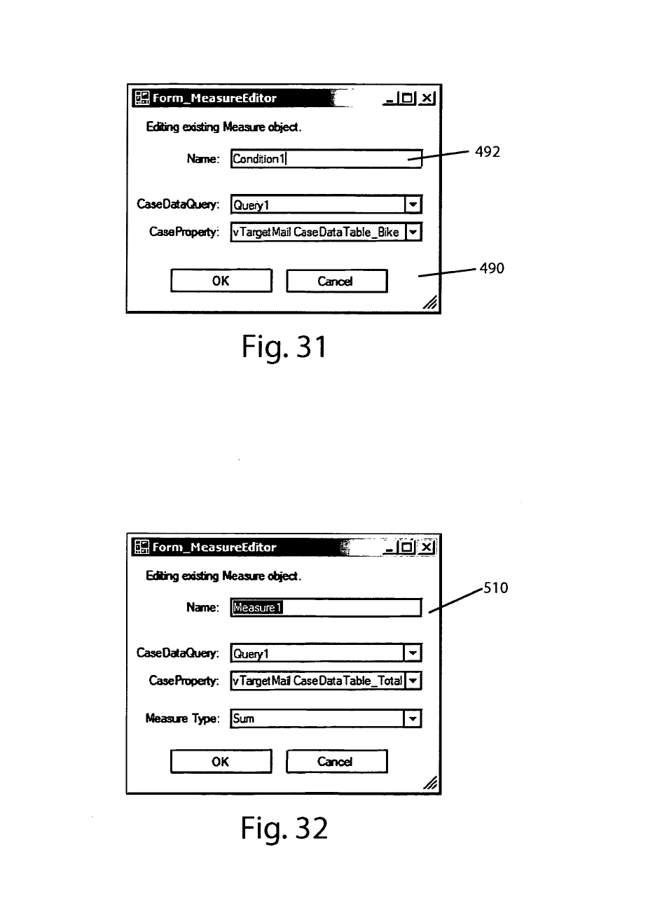

By selecting an “Add” or “Edit” buttons 433, 435 under the “Conditions:” text-box in FIG. 24, the end-user can specify conditions for the aggregation (e.g. “group-by” values). This launches a window 490 (FIG. 31).

The end-user can then provide a:
Name for the condition in a text box 492
Specify the Case Data Query to which the condition applies
And the Case Property on which to “group-by”

### Measure Editor

By selecting “Add” or “Edit” buttons 437, 439 under the “Measures:” text-box in FIG. 24, the end-user can specify measures for the aggregation. This launches a window 510 (FIG. 32).

The end-user can then provide a:
Name for the measure in a text box
Specify the Case Data Query to which the measure applies
Specify the measure type (i.e. aggregation)

### Case Data Set Editor

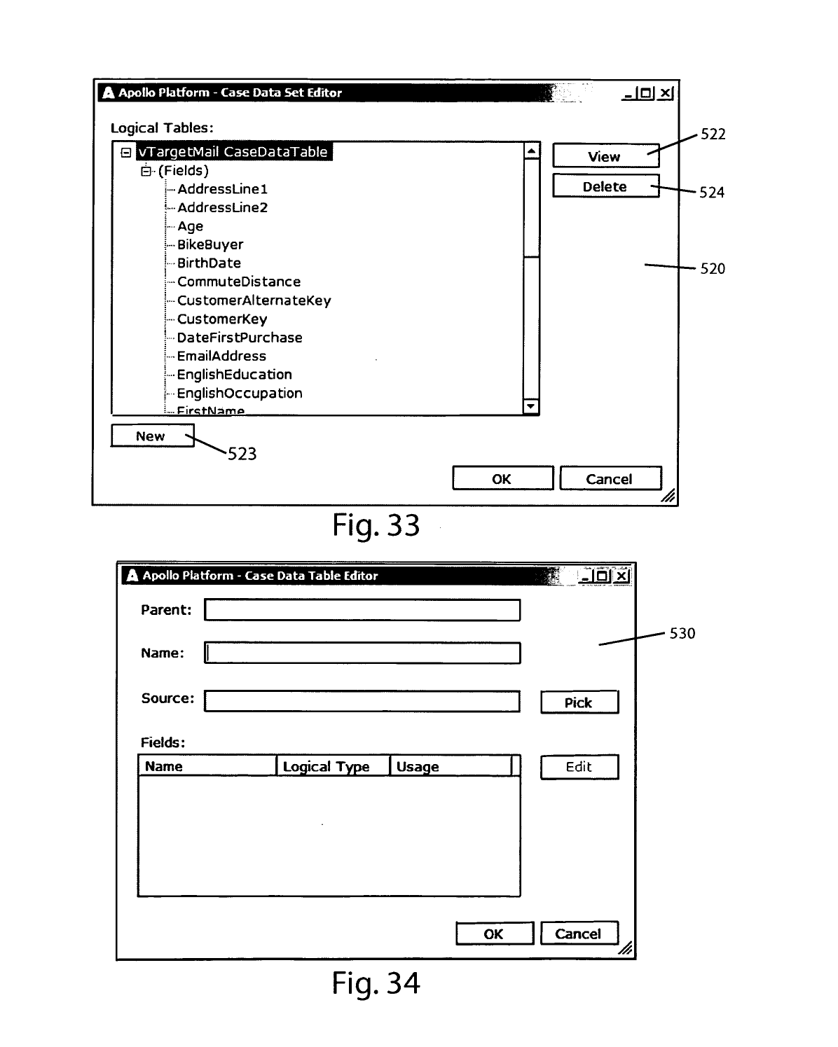

The Case Data Set Editor allows the end-user to specify a logical relationship for data fields of a “case” for analysis between various CaseDataTable metadata objects. FIG. 33 shows a CaseDataSet editor 520 having a single CaseDataTable (vTargetMail CaseDataTable).

Clicking the “View” 522 or “New” 523 buttons launches the Case Data Table Editor 530 (see FIG. 34), which allows the analyst to add or edit the CaseDataTable object—which selects columns of DataTable objects and specifies how they join with parent tables to form the “case” or entity of analysis.

### Evaluation Report Viewer

The Evaluation Report Viewer 540 provides a graphical interface to interpret the results of model evaluation objects (either DiscreteModelEvaluation metadata objects (see section DiscreteModelEvaluation) or ContinuousModelEvaluation metadata objects (see section ContinuousModelEvaluation)).

The Evaluation Report Viewer has 3 tabs 542, 544, 546:
Test Details: providing the analyst with information related to the specific test
Metrics: providing the analyst with the results of specific performance metrics
Charts: providing graphs of various metrics

### Test Details

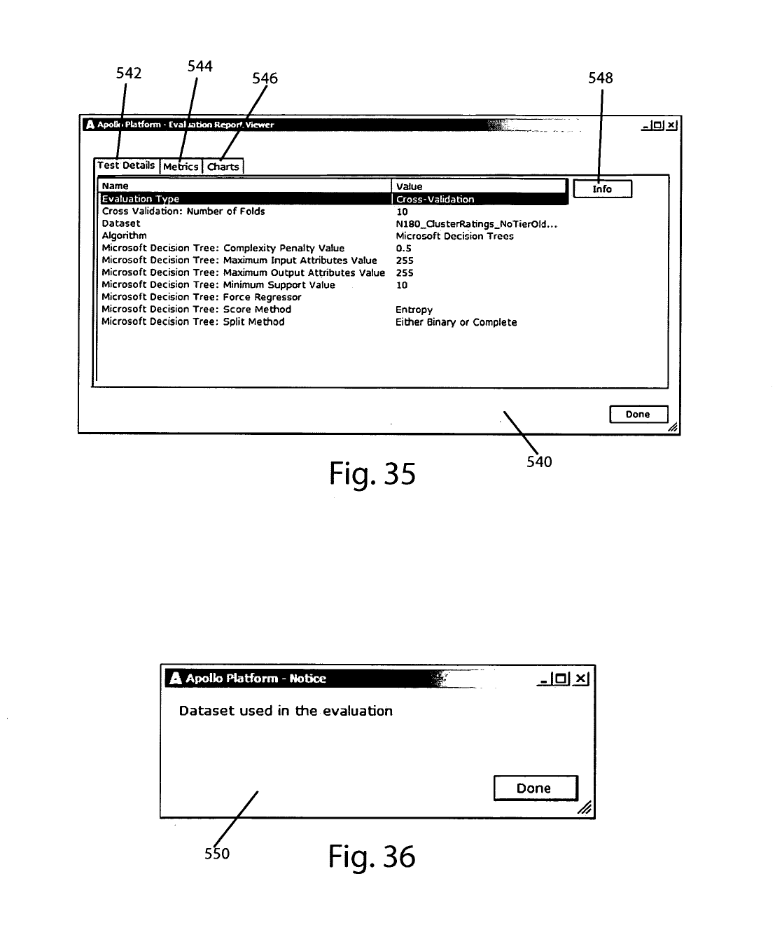

An example of the Test Details tab is shown in FIG. 35. Test Details consist of a set of (Name, Value, Info) items that are defined in the Infos portion of the EvaluationReport object (see Section EvaluationReport).

If the analyst end-user may select a row in the grid-view and click on an “Info” button 548, the corresponding Info value window 550 is displayed (see FIG. 36 for an example of the result shown when choosing “Dataset” and clicking the “Info” button).

### Metrics

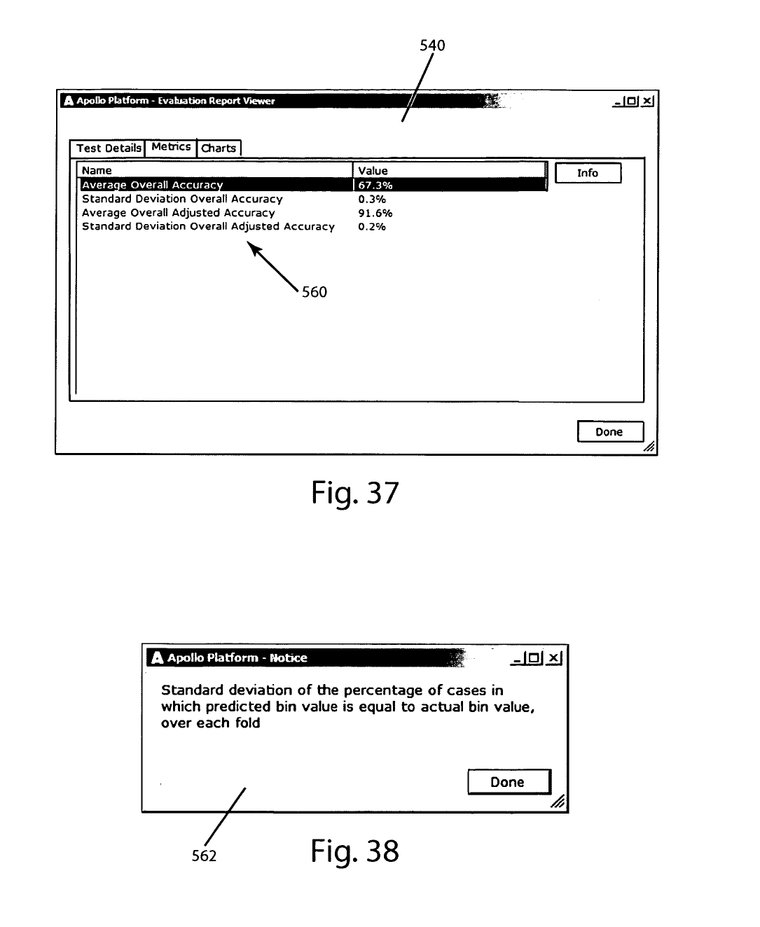

An example of the Metrics tab is shown in FIG. 37. Metrics consist of a set 560 of (Name, Value, Info) items that are defined in the Metrics portion of the EvaluationReport object (see Section EvaluationReport).

If the analyst end-user selects a row in the grid-view and clicks on “Info”, the corresponding Info value is displayed as an updated notice window 562 (see FIG. 38 for an example of the information displayed when the analyst end-user selects this item and clicks “Info”).

### Charts

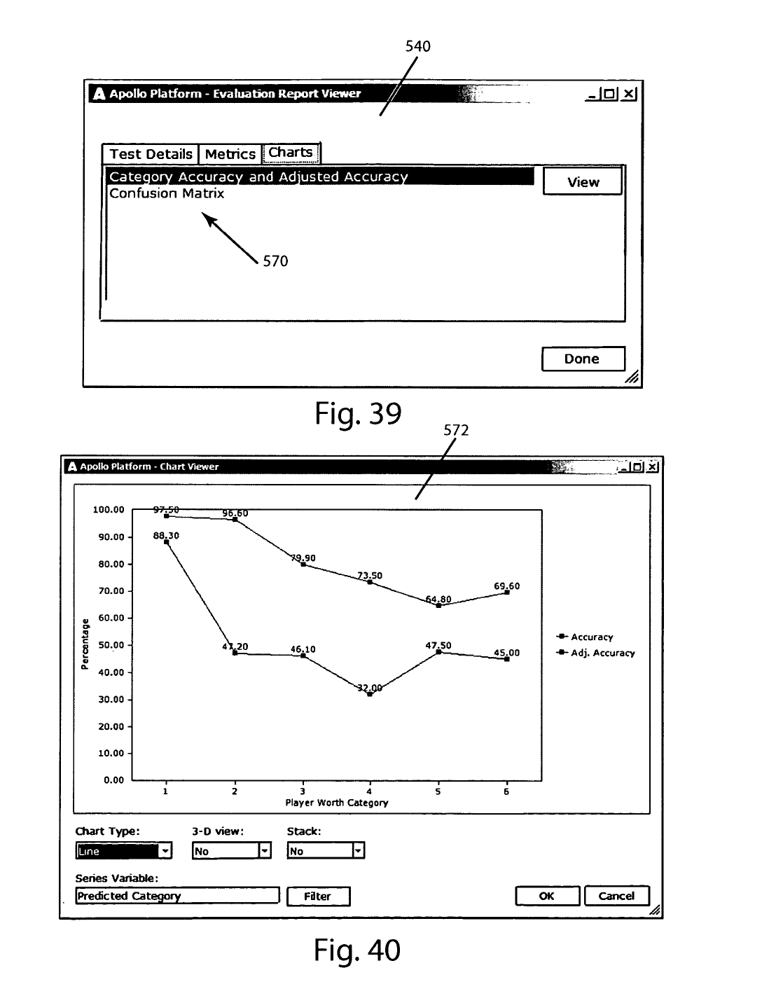

The “Charts” tab in the Evaluation Report Viewer lists any charts 570 that have been defined and allows the analyst to view via a charting control (see FIG. 39).

A chart is viewed via a charting control by selecting the chart and clicking the “View” button in FIG. 39. Producing the visualization 572 like that in FIG. 40.

### Generic Metadata Editor

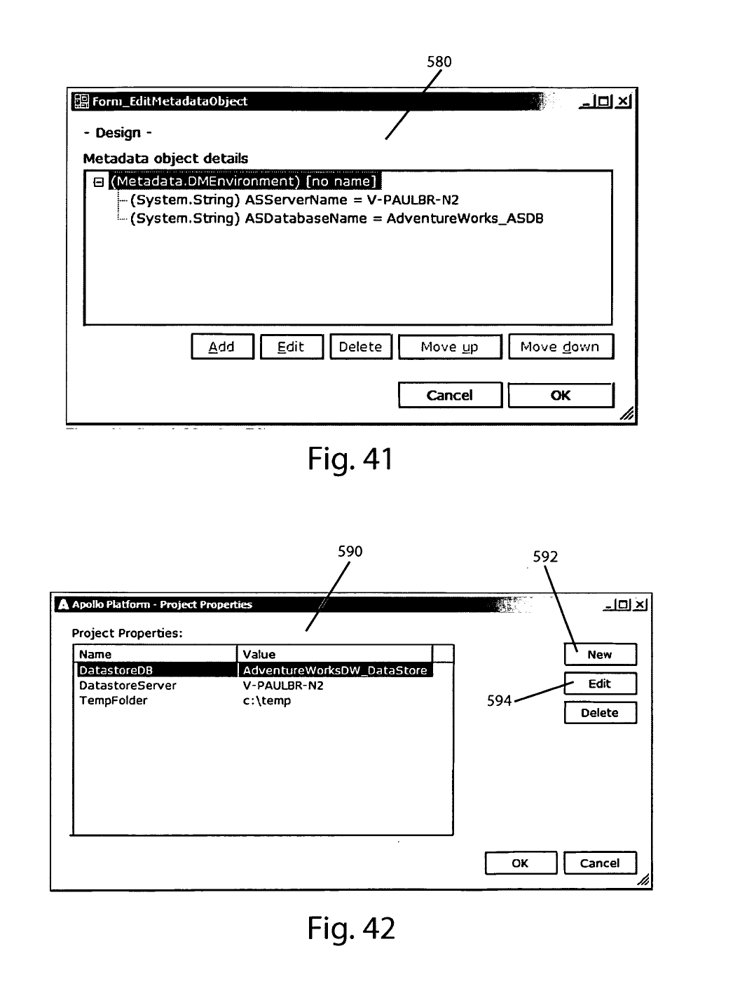

For other metadata objects, a Generic Metadata Editor 580 has been developed, which aids the analyst in populating the XML values of the corresponding metadata object. See FIG. 41.

This UI allows the end-user to manually edit the metadata values and save them to the metadata database.

### Project Properties

By clicking on the “Properties” button on the “Project Manager” form (see FIG. 12), the Project Properties form 590 is launched (see FIG. 42).

This form allows the end-user to edit existing project properties, create new ones, or delete existing ones.

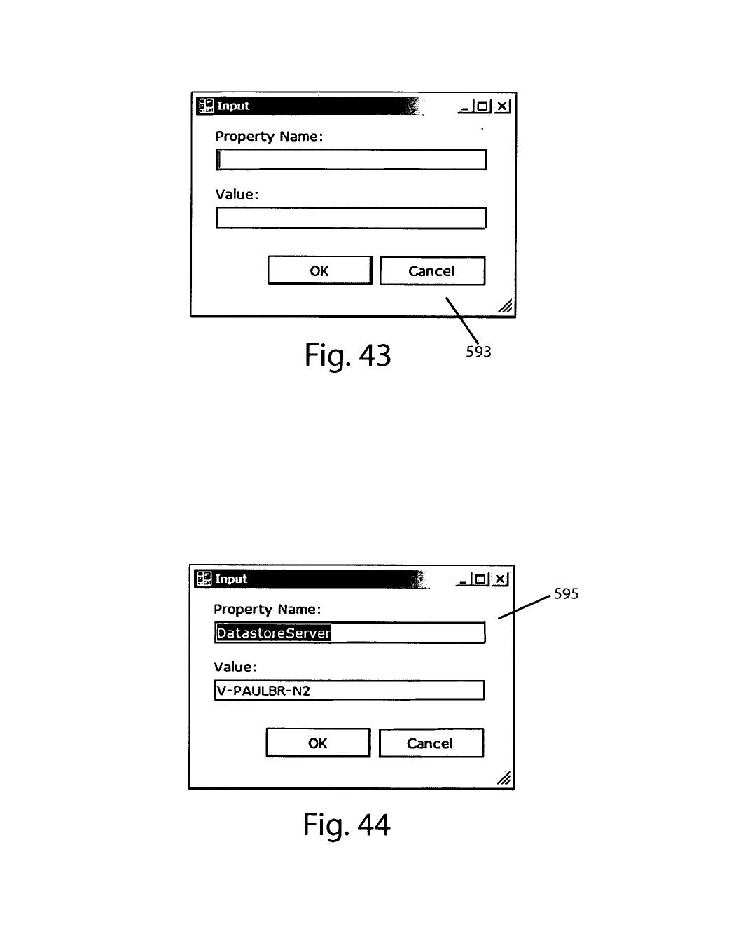

Clicking the “New” button 592 on FIG. 42, launches a form 593 (FIG. 43), allowing the end-user to specify the property name and its value.

Highlighting one of the existing properties in FIG. 42 and clicking “Edit” button 594 allows the end-user to edit the property in a form 595 (see FIG. 44).

### Execution Manager

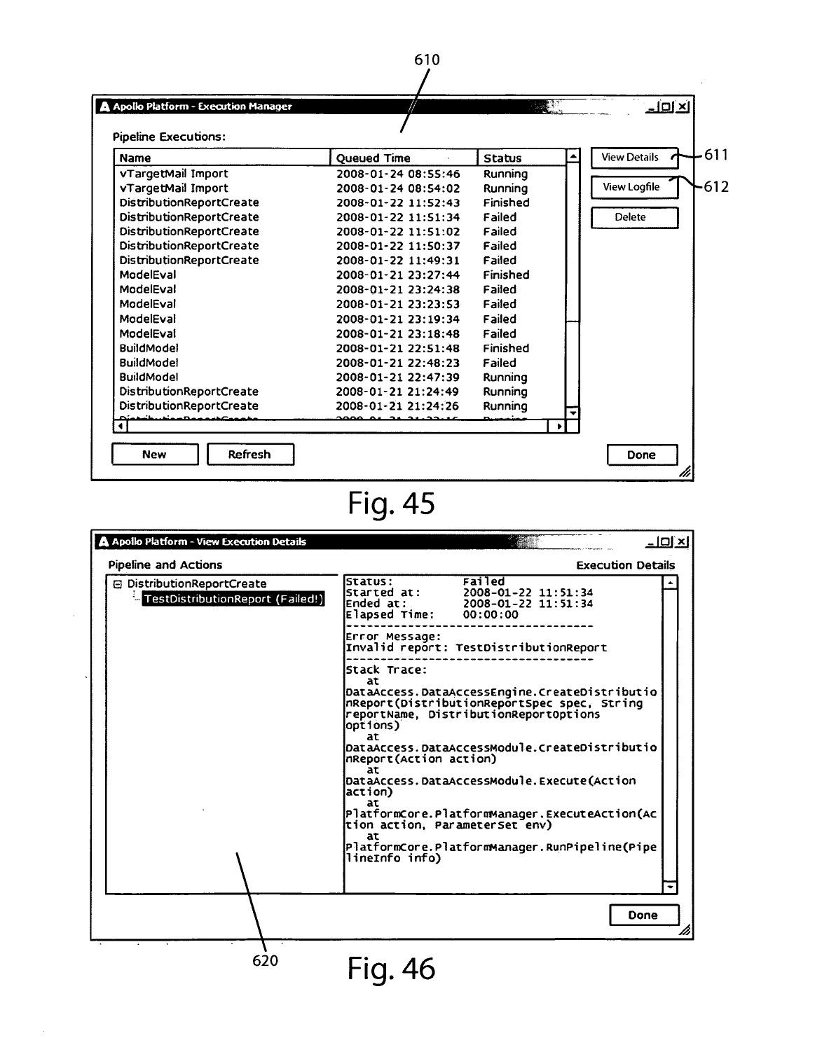

By clicking the “Execution” button in the Project Manager form (see FIG. 12), the Execution Manager form 610 is launched (see FIG. 45). This form displays the history of pipelines that have been executed or are currently executing and those pending execution for the given project.

### View Details of a Pipeline Execution

By highlighting a given pipeline and clicking the “View Details” button611 in FIG. 45, detailed information on the pipeline/action execution is presented in the form (see FIG. 46).

On the left-side of FIG. 46, the pipeline and the actions defined in the pipeline are shown in a tree-view. By selecting the pipeline (root-node in the tree) the overall pipeline status is shown on the right, along with start-time, end-time, elapsed time. By selecting individual actions, the time required to execute the action is shown. If the action has failed, the corresponding error message is displayed on the right.

### View Details of a Pipeline Execution

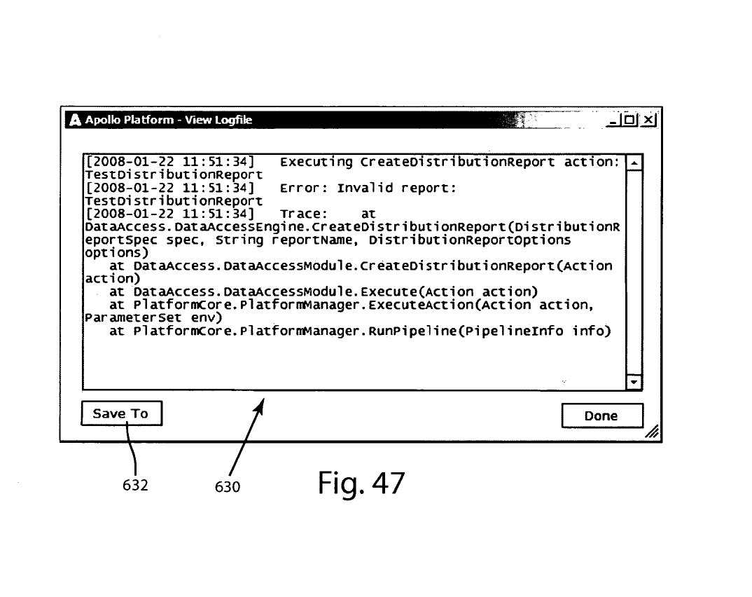

By highlighting a given pipeline and clicking the “View Logfile” button 612 in FIG. 45, the View Logfile form is launched (see FIG. 47). This form shows the content of the messages and errors that are logged during pipeline processing.

The log-file contents can be saved to a file by clicking the “Save To” button 632 in FIG. 47.

The invention has been described with a degree of particularity but it is the intent that the invention include all embodiments falling within the spirit or scope of the appended claims.

1. For use with a database system, a process for automating data mining operations comprising:
i) defining metadata elements for specifying data sources and data operations on those data sources;
ii) storing the metadata elements in a computer storage having metadata representations specifying data sources and data operations, and indexing the storage to retrieve metadata elements when needed to perform data operations;
iii) querying metadata elements describing data operations and executing these operations on data within the data sources.

2. The method of claim 1 additionally comprising providing a user interface for defining metadata elements in the computer storage.

3. The method of claim 2 wherein the user interface accesses commands for creating, deleting and editing metadata elements from the computer storage scheme.

4. The method of claim 1 wherein the metadata elements are stored as text and a data execution component parses the metadata text that describes data operations and executes the data operation instructions on data specified in the data operation instructions.

5. The method of claim 4 wherein the text is XML.

6. The process of claim 1 wherein metadata representations perform one or more data operation tasks in a pipeline, including import of source data into relational databases, aggregating source data for analysis or reporting, computation of reports, building data mining models, evaluating data mining models, and obtaining predictions from data mining models.

7. The process of claim 1 wherein metadata representations perform one or more data operation tasks in a pipeline on data stored in a relational database.

8. The process of claim 1 wherein a data execution component periodically queries the computer storage to determine if metadata representations defining one or more data operation tasks in a pipeline are pending to be processed and if so executes the pending data operation tasks.

9. The process of claim 1 wherein a data execution component connects to the computer storage and retrieves a specified metadata representation of one or more data operation tasks in a pipeline and then executes the specified tasks.

10. The process of claim 1 wherein the metadata representations defining one or more data operation tasks in a pipeline have token place-holders that are replaced with values (project properties) by the data execution component at the time of execution.

11. The process of claim 1 wherein the metadata representation of one or more data operation tasks in a pipeline is comprised of one or more metadata representations of single data operation tasks or actions.

12. The process of claim 1 wherein a data execution component creates a log file whose location is specified in a project execution component configuration file to persist and store information pertaining to the execution of data operations.

13. The process of claim 1 wherein a data execution component instantiates a processing component corresponding to a given single data operation task or action and required data operation parameters are set with values specified in the corresponding metadata representation of the given data operation tasks.

14. The process of claim 1 wherein during an execution of one or more data operation tasks in a pipeline, during the execution of a single data operation task, if the operation terminates successfully, its execution status is stored in a metadata storage component and the execution component passes control to a next subsequent data operation in said pipeline.

15. The process of claim 14 wherein during the execution of one or more data operation tasks in a pipeline, during the execution of a single data operation task, if the operation terminates unsuccessfully, an error message is logged to a log file, and if there are any subsequent data operation tasks in the pipeline, they are executed.

16. The process of claim 1 wherein the data operations are SQL operations.

17. For use in a data mining system, apparatus for automating data mining comprising:
a computer data store for storing metadata representations of data sources and data operations associated with a given project name and for each one of said project names, storing parameters specific to the given project where the data operations associated with a given project may include import of source data into relational databases, aggregating source data for analysis or reporting, computation of reports, building data mining models, evaluating data mining models, and obtaining predictions from data mining models ; and
a data execution engine that operates on the metadata representations stored in the computer data store that accesses metadata representations for a specific project name and replaces various data manipulation operation parameters with the project parameters associated with the project.

18. The apparatus of claim 17 wherein the data execution engine has access to C# classes corresponding to the metadata representations.

19. The apparatus of claim 17 wherein the computer data store includes a definitions table in a relational database and wherein the execution engine loads metadata representations of data and data operations and instantiates C# classes to perform the requested data operations with required parameter values obtained from the metadata representations.

20. The apparatus of claim 17 wherein the computer data store includes a pipeline information table in a relational database that stores information related to the state of execution of one or more data operation tasks in a pipeline that are defined for a given project, including the storage of status associated with the processing of the data operation tasks.

21. The apparatus of claim 20 wherein the data execution component queries the metadata datastore relational database, accessing the pipeline information table for a specific project at periodic intervals, and if the execution engine finds a pending entry in the pipeline information table , the execution engine access the associated name of the pipeline metadata object corresponding to the pending entry and queries the definitions table for the given project and the name of the pending pipeline entry to obtain the specific set of data operations to be performed, and then executes those operations.

22. The apparatus of claim 17 comprising multiple computers, wherein one of the computers has instructions to implement the execution component, a second of said computers contains the metadata datastore in a relational database and transmits requested metadata representations to the execution component; and a third of said computers contains source data that is represented by the metadata.

23. The apparatus of claim 22 comprising multiple computers, wherein one of the computers has instructions to implement the execution component and a second of said computers contains the relational database storing the metadata datastore and transmits requested metadata representations to the execution component; and a one or more other said computers contain the source data that is represented by the metadata.

24. The apparatus of claim 17 comprising multiple computers, wherein one of the computers has instructions to implement the execution component and contains the relational databases storing the metadata datastore; and a second of said computers contains the source data that is represented by the metadata.

25. The apparatus of claim 17 comprising multiple computers, wherein one of the computers has instructions to implement the execution component and a second of said computers contains the relational database storing the metadata datastore and the source data represented by the metadata and transmits requested metadata representations to the execution component.

26. The apparatus of claim 17 comprising multiple computers, wherein one of the computers has instructions to implement the execution component and contains the source data represented by the metadata and a second of said computers contains the relational database storing the metadata datastore and transmits requested metadata representations to the execution component.

27. For use with a database system, a computer readable medium for automating data mining operations having instructions for:
i) defining metadata elements for specifying data sources and data operations on those data sources;
ii) storing the metadata elements in a computer storage having metadata representations specifying data sources and data operations, and indexing the storage to retrieve metadata elements when needed to perform data operations;
iii) querying metadata elements describing data operations and executing these operations on data within the data sources.

28. The computer readable medium of claim 27 additionally comprising instructions for providing a user interface for use in defining metadata objects in the computer storage.

29. The computer readable medium of claim 28 wherein the user interface presents commands for creating, deleting and editing metadata objects in the metadata store.

30. The computer readable medium of claim 27 wherein the metadata elements include pipeline elements and the instructions perform multiple data execution tasks, including import of source data into relational databases, aggregating source data for analysis or reporting, computation of reports, building and evaluating data mining models.

31. The computer readable medium of claim 27 wherein the instructions implement a data execution component that periodically queries the metadata datastore to determines if metadata representations defining one or more data operation tasks in a pipeline are pending to be processed and if so executes the pending data operation tasks.

32. The computer readable medium of claim 27wherein the instructions implement a data execution engine component that connects to a metadata data store and retrieves a specified pipeline metadata element for a specified project representing one or more data operation tasks and then executes the specified tasks.

34. The computer readable medium of claim 27 wherein the instructions implement a data execution component that includes instructions to instantiate a class corresponding to a given data operation task with a number of required parameters specified for the given data operation task set are set with values specified in the corresponding data operation task metadata element within an associated pipeline element.

35. The computer readable medium of claim 27 wherein the instructions implement a data execution component that includes instructions to determine if an action terminates successfully and if so sets its execution status in a metadata status element and wherein the execution component passes control to a next subsequent action in a pipeline.

36. The computer readable medium of claim 27 wherein during the execution of one or more data operation tasks are executed in a pipeline, and wherein during the execution of a single data operation task, if the operation terminates unsuccessfully, an error message is logged to a log file, and if there are any subsequent data operation tasks in the pipeline, they are executed.

37. The computer readable medium of claim 27 wherein the data operations are SQL operations.
